(19) United States
(12) Patent Application Publication
(10) Pub. No.: US 2026/0367285 A1
(43) Pub. Date: Nov. 19, 2026

(54) GLASS-CERAMIC ARTICLES HAVING COATINGS FOR CORRECTING COLOR

(71) Applicant: CORNING INCORPORATED, CORNING, NY (US)

(72) Inventors: Jaymin Amin, Corning, NY (US); Carol Ann Click, Corning, NY (US); Qiang Fu, Painted Post, NY (US); Shandon Dee Hart, Elmira, NY (US); Carlo Anthony Kosik Williams, Painted Post, NY (US); Lin Lin, Painted Post, NY (US); Charlene Marie Smith, Corning, NY (US)

(21) Appl. No.: 19/662,214

(22) Filed: Apr. 29, 2026

Related U.S. Application Data
(60) Provisional application No. 63/805,564, filed on May 14, 2025.

(51) Int. Cl. G02B 1/115; C03C 4/10; C03C 10/00; C03C 17/30; G02B 1/14

(52) U.S. Cl. CPC G02B 1/115; C03C 4/10; C03C 10/0027; C03C 17/30; G02B 1/14

(57) ABSTRACT

An article is described herein comprising a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence; and a multilayer coating disposed on the first major surface; wherein the glass-ceramic substrate in an uncoated state exhibits a b*_{uncoated} value of less than or equal to about −0.35 in two-surface reflectance in the CIE L*,a*,b* colorimetry system under a D65 illuminant measured at normal incidence, from 0 to 10 degrees; and wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value.

### CLAIM OF PRIORITY

This application claims the benefit of priority under 35 U.S.C. § 119 of U.S. Provisional Application Ser. No. 63/805,564 filed on May 14, 2025, the content of which is relied upon and incorporated herein by reference in its entirety.

### FIELD

The present specification generally relates to articles including a glass-ceramic substrate and a coating for correcting reflected color, devices including the same, and, more particularly, to transparent glass-ceramics with improved optical and mechanical properties.

### BACKGROUND

There is a demand for high strength transparent materials that may be used in conjunction with, for example, portable electronic devices. Several materials are currently utilized on the market such as glass, zirconia, plastic, metal, and glass-ceramics.

Glass-ceramics have certain advantages over other materials. However, glass-ceramics having desirable mechanical properties may lack desired optical properties, such as discoloration of transmitted or reflected light.

Accordingly, a need exists for glass-ceramic articles having improved properties.

### SUMMARY

The subject matter of the present specification may be understood in terms of the following aspects.

In one or more embodiments, an article may comprise a glass-ceramic substrate. The glass-ceramic substrate may comprise a first major surface and a second major surface opposite the first major surface. The glass-ceramic substrate may have an average transmittance of at least about 85% over an optical wavelength regime from 450 nm to 800 nm at normal incidence, from 0 to 10 degrees. The glass-ceramic substrate in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees. The article may further comprise a multilayer coating disposed on the first major surface. The article may exhibit a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value.

In one or more embodiments, an article may comprise a glass-ceramic substrate. The glass-ceramic substrate may comprise a first major surface and a second major surface opposite the first major surface. The glass-ceramic substrate may have an average transmittance of at least about 85% over an optical wavelength regime from 450 nm to 800 nm at normal incidence, from 0 to 10 degrees. The glass-ceramic substrate in an uncoated state may exhibit a b*_{uncoated} value of less than or equal to about −0.75 in two-surface reflectance in the CIE L*,a*,b* colorimetry system under a D65 illuminant measured at normal incidence, from 0 to 10 degrees. The article may exhibit a b*_{coated} value of greater than or equal to about −0.6 in two-surface reflectance in the CIE L*,a*,b* colorimetry system under a D65 illuminant as measured at normal incidence, from 0 to 10 degrees.

In one or more embodiments, an article may comprise a glass-ceramic substrate. The glass-ceramic substrate may comprise a first major surface and a second major surface opposite the first major surface. The glass-ceramic substrate may have an average transmittance of at least about 85% over an optical wavelength regime from 450 nm to 800 nm at normal incidence, from 0 to 10 degrees. The glass-ceramic substrate in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees. The article may further comprise a multilayer coating disposed on the first major surface. The article may exhibit a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value. The glass-ceramic substrate may comprise greater than or equal to 55 wt % and less than or equal to 80 wt % SiO₂; greater than or equal to 7 wt % and less than or equal to 20 wt % Li₂O; greater than or equal to 1 wt % and less than or equal to 8 wt % P₂O₅; greater than or equal to 0.1 wt % and less than or equal to 5.0 wt % Na₂O; greater than 0.5 wt % to less than or equal to 20 wt % ZrO₂; greater than or equal to 1 wt % to less than 4 wt % CaO; and less than 1 wt % K₂O, and a ratio of Al₂O₃ (wt %) to Li₂O (wt %) in the glass-ceramic may be greater than or equal to 0 and less than 0.20. The multilayer coating may comprise an optical film structure comprising a physical thickness from about 50 nm to less than 800 nm, and a plurality of alternating high refractive index and low refractive index layers. The optical film structure may comprise a first low refractive index layer directly on the first major surface and a capping low refractive index layer, wherein each layer comprises one or more of a silicon-containing oxide, a silicon-containing nitride, and a silicon-containing oxynitride.

In one or more embodiments, an article may comprise a glass-ceramic substrate. The glass-ceramic substrate may comprise a first major surface and a second major surface opposite the first major surface. The glass-ceramic substrate may have an average transmittance of at least about 85% over an optical wavelength regime from 450 nm to 800 nm at normal incidence, from 0 to 10 degrees. The glass-ceramic substrate in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees. The article may further comprise a multilayer coating disposed on the first major surface. The article may exhibit a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value. The glass-ceramic substrate may comprise greater than or equal to 55 wt % and less than or equal to 80 wt % SiO₂; greater than or equal to 7 wt % and less than or equal to 20 wt % Li₂O; greater than or equal to 1 wt % and less than or equal to 8 wt % P₂O₅; greater than or equal to 0.1 wt % and less than or equal to 5.0 wt % Na₂O; greater than 0.5 wt % to less than or equal to 20 wt % ZrO₂; greater than or equal to 1 wt % to less than 4 wt % CaO; and less than 1 wt % K₂O, and a ratio of Al₂O₃ (wt %) to Li₂O (wt %) in the glass-ceramic may be greater than or equal to 0 and less than 0.20. The multilayer coating may comprise an optical film structure having an outer surface and a physical thickness of from about 200 nm to 5000 nm, the optical film structure disposed on the first major surface. The optical film structure may comprise a scratch-resistant layer, at least one low refractive index (RI) layer, at least one medium RI layer, and at least one high RI layer. The optical film structure may further comprise an outer structure and an inner structure, the scratch-resistant layer disposed between the outer and inner structures, the inner structure disposed on the first major surface, the outer structure comprising a plurality of alternating high and medium RI layers, and the inner structure comprises a plurality of alternating high RI layers and low RI layers. The at least one medium RI layer may have a refractive index from 1.55 to 1.80, each of the high RI layers may have a refractive index of greater than 1.80, and each of the low RI layers may have a refractive index of less than 1.55.

In one or more embodiments, an article may comprise a glass-ceramic substrate. The glass-ceramic substrate may comprise a first major surface and a second major surface opposite the first major surface. The glass-ceramic substrate may have an average transmittance of at least about 85% over an optical wavelength regime from 450 nm to 800 nm at normal incidence, from 0 to 10 degrees. The glass-ceramic substrate in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees. The article may further comprise a multilayer coating disposed on the first major surface. The article may exhibit a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value. The glass-ceramic substrate may comprise the following composition: 55-75 mol % SiO₂; 0.2-10 mol % Al₂O₃; 0.2-3 mol % P₂O₅; 0-5 mol % B₂O₃; 15-30 mol % Li₂O; 0-2 mol % Na₂O; 0-2 mol % K₂O; 0-2 mol % MgO; 0-2 mol % ZnO; 0.1-10 mol % ZrO₂; 0-4 mol % TiO₂; 0.01-1.0 mol % SnO₂; and 0-2 mol % Y₂O₃. The multilayer coating may comprise an optical film structure comprising a physical thickness from about 50 nm to less than 800 nm, and a plurality of alternating high refractive index and low refractive index layers. The optical film structure may comprise a first low refractive index layer directly on the first major surface and a capping low refractive index layer, wherein each layer comprises one or more of a silicon-containing oxide, a silicon-containing nitride, and a silicon-containing oxynitride.

In one or more embodiments, an article may comprise a glass-ceramic substrate. The glass-ceramic substrate may comprise a first major surface and a second major surface opposite the first major surface. The glass-ceramic substrate may have an average transmittance of at least about 85% over an optical wavelength regime from 450 nm to 800 nm at normal incidence, from 0 to 10 degrees. The glass-ceramic substrate in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees. The article may further comprise a multilayer coating disposed on the first major surface. The article may exhibit a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value. The glass-ceramic substrate may comprise the following composition: 55-75 mol % SiO₂; 0.2-10 mol % Al₂O₃; 0.2-3 mol % P₂O₅; 0-5 mol % B₂O₃; 15-30 mol % Li₂O; 0-2 mol % Na₂O; 0-2 mol % K₂O; 0-2 mol % MgO; 0-2 mol % ZnO; 0.1-10 mol % ZrO₂; 0-4 mol % TiO₂; 0.01-1.0 mol % SnO₂; and 0-2 mol % Y₂O₃. The multilayer coating may comprise an optical film structure having an outer surface and a physical thickness of from about 200 nm to 5000 nm, the optical film structure disposed on the first major surface. The optical film structure may comprise a scratch-resistant layer, at least one low refractive index (RI) layer, at least one medium RI layer, and at least one high RI layer. The optical film structure may further comprise an outer structure and an inner structure, the scratch-resistant layer disposed between the outer and inner structures, the inner structure disposed on the first major surface, the outer structure comprising a plurality of alternating high and medium RI layers, and the inner structure comprises a plurality of alternating high RI layers and low RI layers. The at least one medium RI layer may have a refractive index from 1.55 to 1.80, each of the high RI layers may have a refractive index of greater than 1.80, and each of the low RI layers may have a refractive index of less than 1.55.

In one or more embodiments, a consumer electronic product may comprise a housing comprising a front surface, a back surface and side surfaces, electrical components at least partially within the housing, the electrical components comprising a controller, a memory, and a display, the display at or adjacent the front surface of the housing, and a cover substrate disposed over the display, and the article disclosed herein may comprise at least one of a portion of the housing or the cover substrate.

Additional features and advantages of the articles described herein will be set forth in the detailed description which follows, and in part will be readily apparent to those skilled in the art from that description or recognized by practicing the embodiments described herein, including the detailed description which follows, the claims, as well as the appended drawings.

### BRIEF DESCRIPTION OF THE DRAWINGS

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

FIG. 1 is a cross-sectional side view of an article according to one or more embodiments of the disclosure;

FIGS. 2A and 2B are cross-sectional side views of an article according to one or more embodiments of the disclosure;

FIG. 3 is a cross-sectional side view of an article according to one or more embodiments of the disclosure;

FIG. 4 is a cross-sectional side view of an article according to one or more embodiments of the disclosure;

FIG. 5A is a plan view of an exemplary electronic device incorporating any of the articles disclosed herein;

FIG. 5B is a perspective view of the exemplary electronic device of FIG. 5A;

FIGS. 6A, 6B, 6C, and 6D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for a comparative uncoated glass-ceramic substrate;

FIGS. 7A, 7B, 7C, and 7D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIGS. 8A, 8B, 8C, and 8D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIGS. 9A, 9B, 9C, and 9D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIGS. 10A, 10B, 10C, and 10D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIGS. 11A, 111B, 11C, and 11D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIGS. 12A, 12B, 12C, and 12D are plots showing two-surface reflected color as modeled at incident angles from 0° to 75°, two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIG. 13A is a plot showing two-surface reflected color as modeled at incident angles from 0° to 75° for an uncoated and coated glass-ceramic substrate;

FIGS. 13B, 13C, and 13D are plots showing two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure;

FIG. 14A is a plot showing two-surface reflected color as modeled at incident angles from 0° to 75° for an uncoated and coated glass-ceramic substrate; and

FIGS. 14B, 14C, and 14D are plots showing two-surface transmittance modeled at an angle of incidence of 0-degrees, two-surface transmitted color modeled at all angles of incidence from 0 to 75-degrees, and two-surface reflectance modeled at 6-degrees angle of incidence, respectively, for an article according to one or more embodiments of the disclosure.

### DETAILED DESCRIPTION

Generally, the disclosure is directed to articles that employ multilayer coatings, such as optical film structures, over glass-ceramic substrates to impart color correction. Glass-ceramics are often used in various embodiments of displays, smartphones, smartwatches, camera lenses, sensors and/or light source components within or otherwise part of electronic devices, along with protection of other components (e.g., buttons, speakers, microphones, etc.) for their optical and mechanical properties. However, certain transparent glass-ceramics have residual Rayleigh scattering due to internal crystallite size, shape, or refractive index mismatch between ceramic crystallites and residual glassy matrix. This scattering can cause an undesired blue hue in two-surface reflection and/or a yellow hue in transmission. The blue hue in two-surface reflection may be quantified by a more negative b* value in the CIE L*,a*,b* colorimetry system under a D65 illuminant measured at normal incidence, from 0 to 10 degrees.

In embodiments of the present disclosure, a multilayer coating having an inverse color design with a yellow hue in reflection and, in some embodiments, a blue hue in transmission may be applied to the glass-ceramic substrate in order to compensate or correct the color induced by the internal scattering in the glass-ceramic substrate resulting in improved color neutrality. Preferential importance may be placed on the reflected light properties, as these can be particularly noticeable under bright illumination such as sunlight. Improved color neutrality can be defined as a coated article having reflected or transmitted color coordinates closer to a*=0 or closer to b*=0 or closer than a corresponding uncoated article. For example, a glass-ceramic substrate in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees, and the same glass-ceramic substrate with the color correcting multilayer coating may exhibit a b*_{coated} value in two-surface reflectance in the CIE L*,a*,b* colorimetry system under a D65 illuminant as measured at normal incidence, from 0 to 10 degrees, that may be greater than or equal to about 50% of the b*_{uncoated} value. These transparent articles having a multilayer coating may also exhibit a high toughness, hardness, and modulus, and other desirable mechanical properties, in addition to beneficial optical properties.

In one or more embodiments, an exemplary glass-ceramic substrate may have the glass-ceramic composition as set forth in Table 1 below. This glass-ceramic substrate is referred to as GC1 glass-ceramic substrate throughout the specification and Examples section and is measured prior to any ceramming step. Table 1 also provides phase assemblages of the GC1 glass-ceramic substrate.

TABLE 1
Exemplary glass-ceramic substrate GC1

| Oxide (XRF, wt %) | GC1 Substrate |
|---|---|
| SiO2 | 69.71 |
| Al2O3 | 1.86 |
| Li2O | 14.2 |
| Na2O | 0.11 |
| K2O | 0.18 |
| CaO | 1.55 |
| P2O5 | 3.47 |
| ZrO2 | 9.11 |
| SnO2 | 0.03 |
| Ceramming cycle | 595 °C for 4 hours; |
| | 720 °C for 1 hour |
| Haze | 0.21 |
| K1c by CNSB (MPa · m^{0.5}) | 1.35 |
| Phase assemblage (wt %) | GC1 Substrate |
| Glass | 30 |
| Lithium disilicate | 67 |
| LS2 grain size (nm) | 21 |
| Li3PO4 | 2.9 |

In one or more embodiments, exemplary glass-ceramic substrates may have the glass-ceramic compositions as set forth in Table 2 below. These glass-ceramic substrates are referred to as GC2, GC3, and GC4 glass-ceramic substrates throughout the specification and Examples section and are measured prior to any ceramming step. Table 2 also provides phase assemblages of the GC2, GC3, and GC4 glass-ceramic substrates.

TABLE 2
Exemplary glass-ceramic substrate compositions GC2, GC3, and GC4

| | GC2 Substrate | | GC3 Substrate | | GC4 Substrate | |
|---|---|---|---|---|---|---|
| Oxide (XRF) | Wt. % | Mol. % | Wt. % | Mol. % | Wt. % | Mol. % |
| SiO₂ | 71.97 | 69.01 | 70.68 | 67.87 | 74.46 | 70.98 |
| Al₂O₃ | 7.14 | 4.03 | 5.40 | 3.06 | 7.57 | 4.25 |
| P₂O₅ | 2.50 | 1.01 | 2.50 | 1.02 | 2.09 | 0.84 |
| Li₂O | 11.58 | 22.32 | 12.03 | 23.23 | 11.36 | 21.78 |
| Na₂O | 0.07 | 0.06 | 0.04 | 0.04 | 0.06 | 0.06 |
| K₂O | 0.12 | 0.07 | 0.02 | 0.01 | 0.12 | 0.07 |
| ZrO₂ | 5.94 | 2.78 | 8.60 | 4.03 | 4.33 | 2.01 |
| CaO | 0.69 | 0.71 | 0.73 | 0.75 | 0.00 | 0.00 |
| Ceramming cycle | 585 °C for 2 h 55 m | | 580 °C for 5 hours | | 580 °C for 2 h 45 m | |
| | then 735 °C for 55 m | | then 735 °C for 1 | | then 755 °C for 45 m | |
| | | | hour | | | |
| Haze | 0.12 | | 0.13 | | 0.11 | |
| K1c by CNSB | 1.16 | | 1.18 | | 1.15 | |
| (MPa · m^{0.5}) | | | | | | |

| Phase assemblage | | | |
|---|---|---|---|
| (wt %) | GC2 Substrate | GC3 Substrate | GC4 Substrate |
| Glass | 12 | 13 | 19 |
| Lithium disilicate | 45 | 44 | 43 |
| Petalite | 43 | 42 | 38 |
| (LiAlSi₄O₁₀) | | | |
| Other phases | <2 | <2 | <2 |

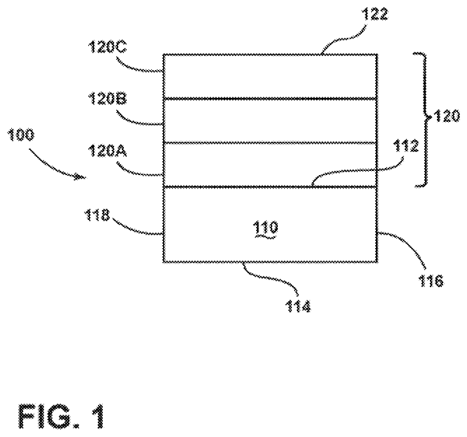

Reference will now be made in detail to embodiments of the articles described herein, examples of which are illustrated in the accompanying drawings. Whenever possible, the same reference numerals will be used throughout the drawings to refer to the same or like parts. According to embodiments, referring to FIGS. 1-4, the glass-ceramic substrate 110 comprises a first major surface 112 and a second major surface 114 opposite the first major surface, and further includes opposing minor surfaces 116, 118.

The articles 100 may be transparent and exhibit a two-sided or two-surface (i.e., through both major surfaces 112, 114 of the glass-ceramic substrate 110) photopic average transmittance, or average visible transmittance, over an optical wavelength regime from 450 to 800 nm, of about 80% or greater, about 85% or greater, about 88% or greater, about 90% or greater, about 91% or greater, about 92% or greater, about 93% or greater, or even about 94% or greater (e.g., 94.1%) at normal incidence, from 0 to 10 degrees.

The articles 100 may exhibit a two-sided or two-surface (i.e., through both major surfaces 112, 114 of the glass-ceramic substrate 110) targeted high average transmittance in one or more near infrared wavelength regimes in any selected wavelength range from within the range of 800 to 1600 nm, such as 840 to 860 nm or 930 to 950 nm, of greater than about 75%, greater than about 80%, greater than about 85%, greater than about 88%, greater than about 90%, or greater than about 91%, at normal incidence, from 0 to 10 degrees.

In some embodiments, the article 100 may exhibit a first-surface photopic average reflectance of from about 0.4% to about 10%, about 0.5% to about 8%, about 0.8% to about 6%, about 1% to about 5%, or about 1.5 to about 4.5%, over a normal incident angle range, e.g., from 0 degrees to 10 degrees.

In some embodiments, the article 100 may exhibit a two-surface photopic average reflectance of less than about 12%, less than about 10%, less than about 8%, less than about 6%, or from about 4% to about 15%, about 4.5% to about 12%, or about 5% to about 10%, over a normal incident angle range, e.g., from 0 degrees to 10 degrees.

In embodiments, the glass-ceramic substrate 110 in an uncoated state may exhibit a b*_{uncoated} value of less than or equal to about −0.35 in two-surface reflectance in the CIE L*,a*,b* colorimetry system under a D65 illuminant measured at normal incidence, from 0 to 10 degrees, such as less than or equal to about −0.4, such as less than or equal to about −0.5, such as less than or equal to about −0.75, such as less than or equal to about −0.8, such as less than or equal to about −1, such as less than or equal to about −1.1 (e.g., see comparative example 1 below), such as less than or equal to about −1.2, such as less than or equal to about −1.4, such as less than or equal to about −1.6, such as less than or equal to about −1.8, such as less than or equal to about −2. As used herein, the term “glass-ceramic substrate in an uncoated state” refers to the glass-ceramic substrate 110 prior to the multilayer coating 119 being disposed on the first major surface 112 of the glass-ceramic substrate. In embodiments, the article 100 exhibits a b*coated value in two-surface reflectance in the CIE L*,a*,b* colorimetry system under a D65 illuminant as measured at normal incidence, from 0 to 10 degrees, and the b*coated value is greater than or equal to about 50% of the b*_{uncoated} value, such as greater than or equal to about 40%, such as greater than or equal to about 30%, such as greater than or equal to about 20%, such as greater than or equal to about 10%. The reduction in the b*_{coated} value relative to the b*_{uncoated} value (i.e., the b*coated value being closer to zero than the b*_{uncoated} value) indicates that the reflected color is less blue for the coated article compared to the uncoated glass-ceramic substrate. In embodiments, the b*_{coated} value in two-surface reflectance in the CIE L*,a*,b* colorimetry system under a D65 illuminant as measured at normal incidence, from 0 to 10 degrees, may be greater than or equal to about −0.8, such as greater than or equal to −0.6, such as greater than or equal to −0.5, such as greater than or equal to −0.4, such as greater than or equal −0.3, such as greater than or equal to −0.25, such as greater than or equal −0.2, such as greater than or equal to −0.1, such as greater than or equal to 0.

In some embodiments, the article 100 may exhibit a b*_{coated} value in two-surface reflectance in the CIE L*,a*,b* colorimetry system under a D65 illuminant at normal incidence, from 0 to 10 degrees, may range from −1 to 1, such as −0.8 to 0.8, such as −0.6 to 0.6, such as −0.5 to 0.5, such as −0.4 to 0.4, such as −0.3 to 0.3, such as −0.25 to 0.25, such as −0.2 to 0.2, such as −0.1 to 0.1.

In some embodiments, the article 100 may exhibit a b*_{coated} value in two-surface reflectance in the CIE L*,a*,b* colorimetry system under a D65 illuminant for all angles of incidence from 0 to 75 degrees may range from −1 to 1, such as −0.8 to 0.8, such as −0.6 to 0.6, such as −0.5 to 0.5, such as −0.4 to 0.4, such as −0.3 to 0.3, such as −0.25 to 0.25, such as −0.2 to 0.2, such as −0.1 to 0.1.

In some embodiments, the article 100 may exhibit an a*_{coated} value in two-surface reflectance in the CIE L*,a*,b* colorimetry system under a D65 illuminant at normal incidence, from 0 to 10 degrees, may range from −1 to 1, such as −0.8 to 0.8, such as −0.6 to 0.6, such as −0.5 to 0.5, such as −0.4 to 0.4, such as −0.3 to 0.3, such as −0.25 to 0.25, such as −0.2 to 0.2, such as −0.1 to 0.1.

In some embodiments, the article 100 may exhibit an a*_{coated} value in two-surface reflectance in the CIE L*,a*,b* colorimetry system under a D65 illuminant for all angles of incidence from 0 to 75 degrees may range from −1 to 1, such as −0.8 to 0.8, such as −0.6 to 0.6, such as −0.5 to 0.5, such as −0.4 to 0.4, such as −0.3 to 0.3, such as −0.25 to 0.25, such as −0.2 to 0.2, such as −0.1 to 0.1.

In some embodiments, the article 100 may exhibit an a*_{coated} value in two-surface reflectance in the CIE L*,a*,b* colorimetry system under a D65 illuminant as measured at normal incidence, from 0 to 10 degrees, and wherein √((a*_{coated})²+(b*_{coated})²) may be about 1 or less, such as about 0.8 or less, such as about 0.6 or less, such as about 0.5 or less, such as about 0.4 or less, such as about 0.3 or less, such as about 0.25 or less, such as about 0.2 or less, such as about 0.1 or less.

In some embodiments, the article 100 may have a maximum change in two-surface transmitted color in the CIE L*,a*,b* colorimetry system under a D65 illuminant for all angles of incidence from 0 to 75 degrees calculated according to the formula √((a*_{uncoated}−a*_{coated})²+(b*_{uncoated}−b*_{coated})²) may be less than about 1, or less than about 0.5.

In embodiments, the glass-ceramic substrate may comprise a phase assemblage comprising lithium disilicate (Li₂Si₂O₅) as the primary crystalline phase and a residual amorphous glass phase.

In the embodiments described herein, the composition of the glass-ceramic may be selected such that the resultant glass-ceramic has a phase assemblage comprising a lithium silicate crystalline phase, specifically a lithium disilicate crystalline phase, wherein the lithium disilicate crystalline phase has a higher weight percentage than other crystalline phases present in the glass-ceramic (i.e., the lithium disilicate crystalline phase is the primary crystalline phase of the glass-ceramic). In embodiments, the phase assemblage of the glass-ceramics may optionally comprise one or more secondary crystalline phases such as, for example and without limitation, a lithium metasilicate crystalline phase and/or a lithium phosphate crystalline phase. The phase assemblage further includes a residual amorphous glass phase.

The lithium disilicate (Li₂Si₂O₅) of the lithium disilicate crystalline phase is an orthorhombic crystal based on corrugated sheets of {Si₂O₅}tetrahedral arrays. The crystals are typically tabular or lath-like in shape, with pronounced cleavage planes. Glass-ceramics based on lithium disilicate offer highly desirable mechanical properties, including high body strength and fracture toughness, due to their microstructure of randomly oriented interlocked crystals—a crystal structure that forces cracks to propagate through the material via tortuous paths around these crystals.

In embodiments, the weight percentage of the lithium disilicate crystalline phase (also referred to herein as “L2S”) in the glass-ceramics can be in a range from greater than or equal to 20 to less than or equal to 90 wt %, greater than or equal to 20 to less than or equal to 85 wt %, greater than or equal to 20 to less than or equal to 80 wt %, greater than or equal to 20 to less than or equal to 75 wt %, greater than or equal to 20 to less than or equal to 70 wt %, greater than or equal to 20 to less than or equal to 65 wt %, greater than or equal to 20 to less than or equal to 60 wt %, greater than or equal to 20 to less than or equal to 55 wt %, greater than or equal to 20 to less than or equal to 50 wt %, greater than or equal to 20 to less than or equal to 45 wt %, greater than or equal to 20 to less than or equal to 40 wt %, greater than or equal to 20 to less than or equal to 35 wt %, greater than or equal to 20 to less than or equal to 30 wt %, greater than or equal to 20 to less than or equal to 25 wt %, greater than or equal to 25 to less than or equal to 90 wt %, greater than or equal to 25 to less than or equal to 85 wt %, greater than or equal to 25 to less than or equal to 80 wt %, greater than or equal to 25 to less than or equal to 75 wt %, greater than or equal to 25 to less than or equal to 70 wt %, greater than or equal to 25 to less than or equal to 65 wt %, greater than or equal to 25 to less than or equal to 60 wt %, greater than or equal to 25 to less than or equal to 55 wt %, greater than or equal to 25 to less than or equal to 50 wt %, greater than or equal to 25 to less than or equal to 45 wt %, greater than or equal to 25 to less than or equal to 40 wt %, greater than or equal to 25 to less than or equal to 35 wt %, greater than or equal to 25 to less than or equal to 30 wt %, greater than or equal to 30 to less than or equal to 90 wt %, greater than or equal to 30 to less than or equal to 85 wt %, greater than or equal to 30 to less than or equal to 80 wt %, greater than or equal to 30 to less than or equal to 75 wt %, greater than or equal to 30 to less than or equal to 70 wt %, greater than or equal to 30 to less than or equal to 65 wt %, greater than or equal to 30 to less than or equal to 60 wt %, greater than or equal to 30 to less than or equal to 55 wt %, greater than or equal to 30 to less than or equal to 50 wt %, greater than or equal to 30 to less than or equal to 45 wt %, greater than or equal to 30 to less than or equal to 40 wt %, greater than or equal to 30 to less than or equal to 35 wt %, greater than or equal to 35 to less than or equal to 90 wt %, greater than or equal to 35 to less than or equal to 85 wt %, greater than or equal to 35 to less than or equal to 80 wt %, greater than or equal to 35 to less than or equal to 75 wt %, greater than or equal to 35 to less than or equal to 70 wt %, greater than or equal to 35 to less than or equal to 65 wt %, greater than or equal to 35 to less than or equal to 60 wt %, greater than or equal to 35 to less than or equal to 55 wt %, greater than or equal to 35 to less than or equal to 50 wt %, greater than or equal to 35 to less than or equal to 45 wt %, greater than or equal to 35 to less than or equal to 40 wt %, greater than or equal to 40 to less than or equal to 90 wt %, greater than or equal to 40 to less than or equal to 85 wt %, greater than or equal to 40 to less than or equal to 80 wt %, greater than or equal to 40 to less than or equal to 75 wt %, greater than or equal to 40 to less than or equal to 70 wt %, greater than or equal to 40 to less than or equal to 65 wt %, greater than or equal to 40 to less than or equal to 60 wt %, greater than or equal to 40 to less than or equal to 55 wt %, greater than or equal to 40 to less than or equal to 50 wt %, greater than or equal to 40 to less than or equal to 45 wt %, greater than or equal to 45 to less than or equal to 60 wt %, greater than or equal to 45 to less than or equal to 55 wt %, greater than or equal to 45 to less than or equal to 50 wt %, greater than or equal to 50 to less than or equal to 60 wt %, greater than or equal to 50 to less than or equal to 55 wt %, or even greater than or equal to 55 to less than or equal to 60 wt %. It should be understood that the above ranges include all subranges within the explicitly disclosed ranges. In embodiments, the glass-ceramic may comprise about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt % of the lithium disilicate crystalline phase.

Lithium metasilicate, Li₂SiO₃, has an orthorhombic symmetry with (Si₂O₆) chains running parallel to the c axis and linked together by lithium ions. Lithium metasilicate crystals can be easily dissolved from glass-ceramics in diluted hydrofluoric acid.

In embodiments, the weight percentage of the lithium metasilicate crystalline phase, when present in the glass-ceramics, can be in a range from greater than or equal to 0 to less than or equal to 10.0 wt %, greater than or equal to 0 to less than or equal to 9.5 wt %, greater than or equal to 0 to less than or equal to 9.0 wt %, greater than or equal to 0 to less than or equal to 8.5 wt %, greater than or equal to 0 to less than or equal to 8.0 wt %, greater than or equal to 0 to less than or equal to 7.5 wt %, greater than or equal to 0 to less than or equal to 7.0 wt %, greater than or equal to 0 to less than or equal to 6.5 wt %, greater than or equal to 0 to less than or equal to 6.0 wt %, greater than or equal to 0 to less than or equal to 5.5 wt %, greater than or equal to 0 to less than or equal to 5.0 wt %, greater than or equal to 0 to less than or equal to 4.5 wt %, greater than or equal to 0 to less than or equal to 4.0 wt %, greater than or equal to 0 to less than or equal to 3.5 wt %, greater than or equal to 0 to less than or equal to 3.0 wt %, greater than or equal to 0 to less than or equal to 2.5 wt %, greater than or equal to 0 to less than or equal to 2.0 wt %, greater than or equal to 0 to less than or equal to 1.5 wt %, greater than or equal to 0 to less than or equal to 1.0 wt %, greater than or equal to 0 to less than or equal to 0.5 wt %, greater than or equal to 0.5 to less than or equal to 10.0 wt %, greater than or equal to 0.5 to less than or equal to 9.5 wt %, greater than or equal to 0.5 to less than or equal to 9.0 wt %, greater than or equal to 0.5 to less than or equal to 8.5 wt %, greater than or equal to 0.5 to less than or equal to 8.0 wt %, greater than or equal to 0.5 to less than or equal to 7.5 wt %, greater than or equal to 0.5 to less than or equal to 7.0 wt %, greater than or equal to 0.5 to less than or equal to 6.5 wt %, greater than or equal to 0.5 to less than or equal to 6.0 wt %, greater than or equal to 0.5 to less than or equal to 5.5 wt %, greater than or equal to 0.5 to less than or equal to 5.0 wt %, greater than or equal to 0.5 to less than or equal to 4.5 wt %, greater than or equal to 0.5 to less than or equal to 4.0 wt %, greater than or equal to 0.5 to less than or equal to 3.5 wt %, greater than or equal to 0.5 to less than or equal to 3.0 wt %, greater than or equal to 0.5 to less than or equal to 2.5 wt %, greater than or equal to 0.5 to less than or equal to 2.0 wt %, greater than or equal to 0.5 to less than or equal to 1.5 wt %, greater than or equal to 0.5 to less than or equal to 1.0 wt %, greater than or equal to 1.0 to less than or equal to 10.0 wt %, greater than or equal to 1.0 to less than or equal to 9.5 wt %, greater than or equal to 1.0 to less than or equal to 9.0 wt %, greater than or equal to 1.0 to less than or equal to 8.5 wt %, greater than or equal to 1.0 to less than or equal to 8.0 wt %, greater than or equal to 1.0 to less than or equal to 7.5 wt %, greater than or equal to 1.0 to less than or equal to 7.0 wt %, greater than or equal to 1.0 to less than or equal to 6.5 wt %, greater than or equal to 1.0 to less than or equal to 6.0 wt %, greater than or equal to 1.0 to less than or equal to 5.5 wt %, greater than or equal to 1.0 to less than or equal to 5.0 wt %, greater than or equal to 1.0 to less than or equal to 4.5 wt %, greater than or equal to 1.0 to less than or equal to 4.0 wt %, greater than or equal to 1.0 to less than or equal to 3.5 wt %, greater than or equal to 1.0 to less than or equal to 3.0 wt %, greater than or equal to 1.0 to less than or equal to 2.5 wt %, greater than or equal to 1.0 to less than or equal to 2.0 wt %, greater than or equal to 1.0 to less than or equal to 1.5 wt %, greater than or equal to 1.5 to less than or equal to 10.0 wt %, greater than or equal to 1.5 to less than or equal to 9.5 wt %, greater than or equal to 1.5 to less than or equal to 9.0 wt %, greater than or equal to 1.5 to less than or equal to 8.5 wt %, greater than or equal to 1.5 to less than or equal to 8.0 wt %, greater than or equal to 1.5 to less than or equal to 7.5 wt %, greater than or equal to 1.5 to less than or equal to 7.0 wt %, greater than or equal to 1.5 to less than or equal to 6.5 wt %, greater than or equal to 1.5 to less than or equal to 6.0 wt %, greater than or equal to 1.5 to less than or equal to 5.5 wt %, greater than or equal to 1.5 to less than or equal to 5.0 wt %, greater than or equal to 1.5 to less than or equal to 4.5 wt %, greater than or equal to 1.5 to less than or equal to 4.0 wt %, greater than or equal to 1.5 to less than or equal to 3.5 wt %, greater than or equal to 1.5 to less than or equal to 3.0 wt %, greater than or equal to 1.5 to less than or equal to 2.5 wt %, greater than or equal to 1.5 to less than or equal to 2.0 wt %, greater than or equal to 2.0 to less than or equal to 10.0 wt %, greater than or equal to 2.0 to less than or equal to 9.5 wt %, greater than or equal to 2.0 to less than or equal to 9.0 wt %, greater than or equal to 2.0 to less than or equal to 8.5 wt %, greater than or equal to 2.0 to less than or equal to 8.0 wt %, greater than or equal to 2.0 to less than or equal to 7.5 wt %, greater than or equal to 2.0 to less than or equal to 7.0 wt %, greater than or equal to 2.0 to less than or equal to 6.5 wt %, greater than or equal to 2.0 to less than or equal to 6.0 wt %, greater than or equal to 2.0 to less than or equal to 5.5 wt %, greater than or equal to 2.0 to less than or equal to 5.0 wt %, greater than or equal to 2.0 to less than or equal to 4.5 wt %, greater than or equal to 2.0 to less than or equal to 4.0 wt %, greater than or equal to 2.0 to less than or equal to 3.5 wt %, greater than or equal to 2.0 to less than or equal to 3.0 wt %, greater than or equal to 2.0 to less than or equal to 2.5 wt %, greater than or equal to 2.5 to less than or equal to 10.0 wt %, greater than or equal to 2.5 to less than or equal to 9.5 wt %, greater than or equal to 2.5 to less than or equal to 9.0 wt %, greater than or equal to 2.5 to less than or equal to 8.5 wt %, greater than or equal to 2.5 to less than or equal to 8.0 wt %, greater than or equal to 2.5 to less than or equal to 7.5 wt %, greater than or equal to 2.5 to less than or equal to 7.0 wt %, greater than or equal to 2.5 to less than or equal to 6.5 wt %, greater than or equal to 2.5 to less than or equal to 6.0 wt %, greater than or equal to 2.5 to less than or equal to 5.5 wt %, greater than or equal to 2.5 to less than or equal to 5.0 wt %, greater than or equal to 2.5 to less than or equal to 4.5 wt %, greater than or equal to 2.5 to less than or equal to 4.0 wt %, greater than or equal to 2.5 to less than or equal to 3.5 wt %, greater than or equal to 2.5 to less than or equal to 3.0 wt %, greater than or equal to 3.0 to less than or equal to 10.0 wt %, greater than or equal to 3.0 to less than or equal to 9.5 wt %, greater than or equal to 3.0 to less than or equal to 9.0 wt %, greater than or equal to 3.0 to less than or equal to 8.5 wt %, greater than or equal to 3.0 to less than or equal to 8.0 wt %, greater than or equal to 3.0 to less than or equal to 7.5 wt %, greater than or equal to 3.0 to less than or equal to 7.0 wt %, greater than or equal to 3.0 to less than or equal to 6.5 wt %, greater than or equal to 3.0 to less than or equal to 6.0 wt %, greater than or equal to 3.0 to less than or equal to 5.5 wt %, greater than or equal to 3.0 to less than or equal to 5.0 wt %, greater than or equal to 3.0 to less than or equal to 4.5 wt %, greater than or equal to 3.0 to less than or equal to 4.0 wt %, greater than or equal to 3.0 to less than or equal to 3.5 wt %, greater than or equal to 3.5 to less than or equal to 10.0 wt %, greater than or equal to 3.5 to less than or equal to 9.5 wt %, greater than or equal to 3.5 to less than or equal to 9.0 wt %, greater than or equal to 3.5 to less than or equal to 8.5 wt %, greater than or equal to 3.5 to less than or equal to 8.0 wt %, greater than or equal to 3.5 to less than or equal to 7.5 wt %, greater than or equal to 3.5 to less than or equal to 7.0 wt %, greater than or equal to 3.5 to less than or equal to 6.5 wt %, greater than or equal to 3.5 to less than or equal to 6.0 wt %, greater than or equal to 3.5 to less than or equal to 5.5 wt %, greater than or equal to 3.5 to less than or equal to 5.0 wt %, greater than or equal to 3.5 to less than or equal to 4.5 wt %, greater than or equal to 3.5 to less than or equal to 4.0 wt %, greater than or equal to 4.0 to less than or equal to 10.0 wt %, greater than or equal to 4.0 to less than or equal to 9.5 wt %, greater than or equal to 4.0 to less than or equal to 9.0 wt %, greater than or equal to 4.0 to less than or equal to 8.5 wt %, greater than or equal to 4.0 to less than or equal to 8.0 wt %, greater than or equal to 4.0 to less than or equal to 7.5 wt %, greater than or equal to 4.0 to less than or equal to 7.0 wt %, greater than or equal to 4.0 to less than or equal to 6.5 wt %, greater than or equal to 4.0 to less than or equal to 6.0 wt %, greater than or equal to 4.0 to less than or equal to 5.5 wt %, greater than or equal to 4.0 to less than or equal to 5.0 wt %, or even greater than or equal to 4.0 to less than or equal to 4.5 wt %. It should be understood that the above ranges include all subranges within the explicitly disclosed ranges. In some embodiments, the glass-ceramic has 0, 1, 2, 3, 4, 5, 6, 7, 8, 9, or even 10 wt % of the lithium metasilicate crystalline phase. In embodiments, the glass-ceramics are free of a lithium metasilicate crystalline phase. In embodiments, the glass-ceramics are substantially free of a lithium metasilicate crystalline phase. For purposes of the present specification, the presence or absence of a crystalline phase is determined by X-ray diffraction (XRD) using the Rietveld method.

The glass-ceramics described herein may comprise a lithium phosphate (Li₃PO₄ or “lithiophosphate”) crystalline phase. Li₃PO₄ comprises a beta beryllia derived structure and crystallizes in the orthorhombic Pnma space group.

In embodiments, the weight percentage of the lithium phosphate crystalline phase, when present in the glass-ceramics, can be in a range from greater than or equal to 0 to less than or equal to 10.0 wt %, greater than or equal to 0 to less than or equal to 9.5 wt %, greater than or equal to 0 to less than or equal to 9.0 wt %, greater than or equal to 0 to less than or equal to 8.5 wt %, greater than or equal to 0 to less than or equal to 8.0 wt %, greater than or equal to 0 to less than or equal to 7.5 wt %, greater than or equal to 0 to less than or equal to 7.0 wt %, greater than or equal to 0 to less than or equal to 6.5 wt %, greater than or equal to 0 to less than or equal to 6.0 wt %, greater than or equal to 0 to less than or equal to 5.5 wt %, greater than or equal to 0 to less than or equal to 5.0 wt %, greater than or equal to 0 to less than or equal to 4.5 wt %, greater than or equal to 0 to less than or equal to 4.0 wt %, greater than or equal to 0 to less than or equal to 3.5 wt %, greater than or equal to 0 to less than or equal to 3.0 wt %, greater than or equal to 0 to less than or equal to 2.5 wt %, greater than or equal to 0 to less than or equal to 2.0 wt %, greater than or equal to 0 to less than or equal to 1.5 wt %, greater than or equal to 0 to less than or equal to 1.0 wt %, greater than or equal to 0 to less than or equal to 0.5 wt %, greater than or equal to 0.5 to less than or equal to 10.0 wt %, greater than or equal to 0.5 to less than or equal to 9.5 wt %, greater than or equal to 0.5 to less than or equal to 9.0 wt %, greater than or equal to 0.5 to less than or equal to 8.5 wt %, greater than or equal to 0.5 to less than or equal to 8.0 wt %, greater than or equal to 0.5 to less than or equal to 7.5 wt %, greater than or equal to 0.5 to less than or equal to 7.0 wt %, greater than or equal to 0.5 to less than or equal to 6.5 wt %, greater than or equal to 0.5 to less than or equal to 6.0 wt %, greater than or equal to 0.5 to less than or equal to 5.5 wt %, greater than or equal to 0.5 to less than or equal to 5.0 wt %, greater than or equal to 0.5 to less than or equal to 4.5 wt %, greater than or equal to 0.5 to less than or equal to 4.0 wt %, greater than or equal to 0.5 to less than or equal to 3.5 wt %, greater than or equal to 0.5 to less than or equal to 3.0 wt %, greater than or equal to 0.5 to less than or equal to 2.5 wt %, greater than or equal to 0.5 to less than or equal to 2.0 wt %, greater than or equal to 0.5 to less than or equal to 1.5 wt %, greater than or equal to 0.5 to less than or equal to 1.0 wt %, greater than or equal to 1.0 to less than or equal to 10.0 wt %, greater than or equal to 1.0 to less than or equal to 9.5 wt %, greater than or equal to 1.0 to less than or equal to 9.0 wt %, greater than or equal to 1.0 to less than or equal to 8.5 wt %, greater than or equal to 1.0 to less than or equal to 8.0 wt %, greater than or equal to 1.0 to less than or equal to 7.5 wt %, greater than or equal to 1.0 to less than or equal to 7.0 wt %, greater than or equal to 1.0 to less than or equal to 6.5 wt %, greater than or equal to 1.0 to less than or equal to 6.0 wt %, greater than or equal to 1.0 to less than or equal to 5.5 wt %, greater than or equal to 1.0 to less than or equal to 5.0 wt %, greater than or equal to 1.0 to less than or equal to 4.5 wt %, greater than or equal to 1.0 to less than or equal to 4.0 wt %, greater than or equal to 1.0 to less than or equal to 3.5 wt %, greater than or equal to 1.0 to less than or equal to 3.0 wt %, greater than or equal to 1.0 to less than or equal to 2.5 wt %, greater than or equal to 1.0 to less than or equal to 2.0 wt %, greater than or equal to 1.0 to less than or equal to 1.5 wt %, greater than or equal to 1.5 to less than or equal to 10.0 wt %, greater than or equal to 1.5 to less than or equal to 9.5 wt %, greater than or equal to 1.5 to less than or equal to 9.0 wt %, greater than or equal to 1.5 to less than or equal to 8.5 wt %, greater than or equal to 1.5 to less than or equal to 8.0 wt %, greater than or equal to 1.5 to less than or equal to 7.5 wt %, greater than or equal to 1.5 to less than or equal to 7.0 wt %, greater than or equal to 1.5 to less than or equal to 6.5 wt %, greater than or equal to 1.5 to less than or equal to 6.0 wt %, greater than or equal to 1.5 to less than or equal to 5.5 wt %, greater than or equal to 1.5 to less than or equal to 5.0 wt %, greater than or equal to 1.5 to less than or equal to 4.5 wt %, greater than or equal to 1.5 to less than or equal to 4.0 wt %, greater than or equal to 1.5 to less than or equal to 3.5 wt %, greater than or equal to 1.5 to less than or equal to 3.0 wt %, greater than or equal to 1.5 to less than or equal to 2.5 wt %, greater than or equal to 1.5 to less than or equal to 2.0 wt %, greater than or equal to 2.0 to less than or equal to 10.0 wt %, greater than or equal to 2.0 to less than or equal to 9.5 wt %, greater than or equal to 2.0 to less than or equal to 9.0 wt %, greater than or equal to 2.0 to less than or equal to 8.5 wt %, greater than or equal to 2.0 to less than or equal to 8.0 wt %, greater than or equal to 2.0 to less than or equal to 7.5 wt %, greater than or equal to 2.0 to less than or equal to 7.0 wt %, greater than or equal to 2.0 to less than or equal to 6.5 wt %, greater than or equal to 2.0 to less than or equal to 6.0 wt %, greater than or equal to 2.0 to less than or equal to 5.5 wt %, greater than or equal to 2.0 to less than or equal to 5.0 wt %, greater than or equal to 2.0 to less than or equal to 4.5 wt %, greater than or equal to 2.0 to less than or equal to 4.0 wt %, greater than or equal to 2.0 to less than or equal to 3.5 wt %, greater than or equal to 2.0 to less than or equal to 3.0 wt %, greater than or equal to 2.0 to less than or equal to 2.5 wt %, greater than or equal to 2.5 to less than or equal to 10.0 wt %, greater than or equal to 2.5 to less than or equal to 9.5 wt %, greater than or equal to 2.5 to less than or equal to 9.0 wt %, greater than or equal to 2.5 to less than or equal to 8.5 wt %, greater than or equal to 2.5 to less than or equal to 8.0 wt %, greater than or equal to 2.5 to less than or equal to 7.5 wt %, greater than or equal to 2.5 to less than or equal to 7.0 wt %, greater than or equal to 2.5 to less than or equal to 6.5 wt %, greater than or equal to 2.5 to less than or equal to 6.0 wt %, greater than or equal to 2.5 to less than or equal to 5.5 wt %, greater than or equal to 2.5 to less than or equal to 5.0 wt %, greater than or equal to 2.5 to less than or equal to 4.5 wt %, greater than or equal to 2.5 to less than or equal to 4.0 wt %, greater than or equal to 2.5 to less than or equal to 3.5 wt %, greater than or equal to 2.5 to less than or equal to 3.0 wt %, greater than or equal to 3.0 to less than or equal to 10.0 wt %, greater than or equal to 3.0 to less than or equal to 9.5 wt %, greater than or equal to 3.0 to less than or equal to 9.0 wt %, greater than or equal to 3.0 to less than or equal to 8.5 wt %, greater than or equal to 3.0 to less than or equal to 8.0 wt %, greater than or equal to 3.0 to less than or equal to 7.5 wt %, greater than or equal to 3.0 to less than or equal to 7.0 wt %, greater than or equal to 3.0 to less than or equal to 6.5 wt %, greater than or equal to 3.0 to less than or equal to 6.0 wt %, greater than or equal to 3.0 to less than or equal to 5.5 wt %, greater than or equal to 3.0 to less than or equal to 5.0 wt %, greater than or equal to 3.0 to less than or equal to 4.5 wt %, greater than or equal to 3.0 to less than or equal to 4.0 wt %, greater than or equal to 3.0 to less than or equal to 3.5 wt %, greater than or equal to 3.5 to less than or equal to 10.0 wt %, greater than or equal to 3.5 to less than or equal to 9.5 wt %, greater than or equal to 3.5 to less than or equal to 9.0 wt %, greater than or equal to 3.5 to less than or equal to 8.5 wt %, greater than or equal to 3.5 to less than or equal to 8.0 wt %, greater than or equal to 3.5 to less than or equal to 7.5 wt %, greater than or equal to 3.5 to less than or equal to 7.0 wt %, greater than or equal to 3.5 to less than or equal to 6.5 wt %, greater than or equal to 3.5 to less than or equal to 6.0 wt %, greater than or equal to 3.5 to less than or equal to 5.5 wt %, greater than or equal to 3.5 to less than or equal to 5.0 wt %, greater than or equal to 3.5 to less than or equal to 4.5 wt %, greater than or equal to 3.5 to less than or equal to 4.0 wt %, greater than or equal to 4.0 to less than or equal to 10.0 wt %, greater than or equal to 4.0 to less than or equal to 9.5 wt %, greater than or equal to 4.0 to less than or equal to 9.0 wt %, greater than or equal to 4.0 to less than or equal to 8.5 wt %, greater than or equal to 4.0 to less than or equal to 8.0 wt %, greater than or equal to 4.0 to less than or equal to 7.5 wt %, greater than or equal to 4.0 to less than or equal to 7.0 wt %, greater than or equal to 4.0 to less than or equal to 6.5 wt %, greater than or equal to 4.0 to less than or equal to 6.0 wt %, greater than or equal to 4.0 to less than or equal to 5.5 wt %, greater than or equal to 4.0 to less than or equal to 5.0 wt %, or even greater than or equal to 4.0 to less than or equal to 4.5 wt %.

It should be understood that the above ranges include all subranges within the explicitly disclosed ranges. In some embodiments, the glass-ceramic has 0, 1, 2, 3, 4, 5, 6, 7, 8, 9, or even 10 wt % of the lithium phosphate crystalline phase. In embodiments, the glass-ceramics are free of a lithium phosphate crystalline phase. In embodiments, the glass-ceramics are substantially free of a lithium phosphate crystalline phase. For purposes of the present specification, the presence or absence of a crystalline phase may be determined by X-ray diffraction (XRD) using the Rietveld method.

In embodiments, the content of the residual amorphous glass phase in the glass-ceramic may be greater than or equal to 5 to less than or equal to 65 wt %, greater than or equal to 6 to less than or equal to 60 wt %, greater than or equal to 5 to less than or equal to 55 wt %, greater than or equal to 5 to less than or equal to 50 wt %, greater than or equal to 5 to less than or equal to 45 wt %, greater than or equal to 5 to less than or equal to 40 wt %, greater than or equal to 5 to less than or equal to 35 wt %, greater than or equal to 5 to less than or equal to 30 wt %, greater than or equal to 5 to less than or equal to 25 wt %, greater than or equal to 5 to less than or equal to 20 wt %, greater than or equal to 5 to less than or equal to 15 wt %, greater than 5 to less than or equal to 10 wt %, greater than or equal to 10 to less than or equal to 65 wt %, greater than or equal to 6 to less than or equal to 60 wt %, greater than or equal to 10 to less than or equal to 55 wt %, greater than or equal to 10 to less than or equal to 50 wt %, greater than or equal to 10 to less than or equal to 45 wt %, greater than or equal to 10 to less than or equal to 40 wt %, greater than or equal to 10 to less than or equal to 35 wt %, greater than or equal to 10 to less than or equal to 30 wt %, greater than or equal to 10 to less than or equal to 25 wt %, greater than or equal to 10 to less than or equal to 20 wt %, greater than or equal to 10 to less than or equal to 15 wt %, greater than or equal to 15 to less than or equal to 65 wt %, greater than or equal to 5 to less than or equal to 60 wt %, greater than or equal to 15 to less than or equal to 55 wt %, greater than or equal to 15 to less than or equal to 50 wt %, greater than or equal to 15 to less than or equal to 45 wt %, greater than or equal to 15 to less than or equal to 40 wt %, greater than or equal to 15 to less than or equal to 35 wt %, greater than or equal to 15 to less than or equal to 30 wt %, greater than or equal to 15 to less than or equal to 25 wt %, greater than or equal to 15 to less than or equal to 20 wt %, greater than or equal to 20 to less than or equal to 65 wt %, greater than or equal to 20 to less than or equal to 60 wt %, greater than or equal to 20 to less than or equal to 55 wt %, greater than or equal to 20 to less than or equal to 50 wt %, greater than or equal to 20 to less than or equal to 45 wt %, greater than or equal to 20 to less than or equal to 40 wt %, greater than or equal to 20 to less than or equal to 35 wt %, greater than or equal to 20 to less than or equal to 30 wt %, greater than or equal to 20 to less than or equal to 25 wt %, greater than or equal to 25 to less than or equal to 65 wt %, greater than or equal to 25 to less than or equal to 60 wt %, greater than or equal to 25 to less than or equal to 55 wt %, greater than or equal to 25 to less than or equal to 50 wt %, greater than or equal to 25 to less than or equal to 45 wt %, greater than or equal to 25 to less than or equal to 40 wt %, greater than or equal to 25 to less than or equal to 35 wt %, greater than or equal to 25 to less than or equal to 30 wt %, greater than or equal to 30 to less than or equal to 65 wt %, greater than or equal to 30 to less than or equal to 60 wt %, greater than or equal to 30 to less than or equal to 55 wt %, greater than or equal to 30 to less than or equal to 50 wt %, greater than or equal to 30 to less than or equal to 45 wt %, greater than or equal to 30 to less than or equal to 40 wt %, greater than or equal to 30 to less than or equal to 35 wt %, greater than or equal to 35 to less than or equal to 65 wt %, greater than or equal to 35 to less than or equal to 60 wt %, greater than or equal to 35 to less than or equal to 55 wt %, greater than or equal to 35 to less than or equal to 50 wt %, greater than or equal to 35 to less than or equal to 45 wt %, greater than or equal to 35 to less than or equal to 40 wt %, greater than or equal to 40 to less than or equal to 65 wt %, greater than or equal to 40 to less than or equal to 60 wt %, greater than or equal to 40 to less than or equal to 55 wt %, greater than or equal to 40 to less than or equal to 50 wt %, greater than or equal to 40 to less than or equal to 45 wt %, greater than or equal to 45 to less than or equal to 60 wt %, greater than or equal to 45 to less than or equal to 55 wt %, greater than or equal to 45 to less than or equal to 50 wt %, greater than or equal to 50 to less than or equal to 60 wt %, greater than or equal to 50 to less than or equal to 55 wt %, or even greater than or equal to 55 to less than or equal to 60 wt %. It should be understood that the above ranges include all subranges within the explicitly disclosed ranges. In embodiments, the glass-ceramic may comprise about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, or even 65 wt % of the residual amorphous glass phase.

In the embodiments described herein, the glass-ceramics comprise a lithium disilicate crystalline phase and a residual amorphous glass phase. In some embodiments, the glass-ceramics comprise a lithium disilicate crystalline phase, a residual amorphous glass phase, a lithium metasilicate crystalline phase, and a lithium phosphate crystalline phase. In some other embodiments, the glass-ceramics comprise a lithium disilicate crystalline phase, a residual amorphous glass phase, a lithium metasilicate crystalline phase, and are free of a lithium phosphate crystalline phase. In still other embodiments, the glass-ceramics comprise a lithium disilicate crystalline phase, a residual amorphous glass phase, a lithium phosphate crystalline phase, and are free of a lithium metasilicate crystalline phase. In the embodiments described herein, the glass-ceramics comprise less than 5 wt % of a petalite crystalline phase. In the embodiments described herein, the glass-ceramics are substantially free of a petalite crystalline phase. In one or more embodiments, the glass-ceramics are free of a petalite crystalline phase. In the embodiments described herein, the glass-ceramics are free of an apatite crystalline phase. In embodiments, the glass-ceramics are free of a cristobalite crystalline phase, a wollastonite crystalline phase, a 3-quartz solid solution, and/or a fluoroapatite crystalline phase. For purposes of the present specification, the presence or absence of a crystalline phase may be determined by X-ray diffraction (XRD) using the Rietveld method.

The glass-ceramics described herein may be generally described as lithium-containing silicate glass-ceramics and comprise SiO₂, Li₂O, Na₂O, CaO, ZrO₂, and P₂O₅. In embodiments, the lithium-containing silicate glass-ceramics may further comprise Al₂O₃. In addition, the glass-ceramics embodied herein may further comprise other alkali oxides, such as K₂O, Rb₂O, or Cs₂O, as well as one or more other components as described herein. As noted herein, the major crystallite phase of the phase assemblage of the glass-ceramics described herein may be lithium disilicate. In embodiments, the glass-ceramics may comprise less than 25 wt %, such as less than 24 wt %, less than 23 wt %, less than 22 wt %, less than 21 wt %, or even less than 20 wt %, of the sum of other crystalline phases (i.e., crystalline phases other than lithium disilicate) such as, but not limited to lithium metasilicate (Li₂SiO₃) and lithium phosphate (Li₃PO₄). This phase assemblage provides a glass-ceramic that has low haze (high clarity) and improved mechanical properties.

In embodiments, the glass-ceramics may comprise greater than or equal to 55 wt % and less than or equal to 80 wt % SiO₂, greater than or equal to 55 wt % and less than or equal to 75 wt % SiO₂, greater than or equal to 55 wt % and less than or equal to 73 wt % SiO₂, greater than or equal to 55 wt % and less than or equal to 72 wt % SiO₂, greater than or equal to 60 wt % and less than or equal to 80 wt % SiO₂, greater than or equal to 60 wt % and less than or equal to 75 wt % SiO₂, greater than or equal to 60 wt % and less than or equal to 73 wt % SiO₂, greater than or equal to 60 wt % and less than or equal to 72 wt % SiO₂, greater than or equal to 65 wt % and less than or equal to 80 wt % SiO₂, greater than or equal to 65 wt % and less than or equal to 75 wt % SiO₂, greater than or equal to 65 wt % and less than or equal to 73 wt % SiO₂, greater than or equal to 65 wt % and less than or equal to 72 wt % SiO₂, greater than or equal to 68 wt % and less than or equal to 80 wt % SiO₂, greater than or equal to 68 wt % and less than or equal to 75 wt % SiO₂, greater than or equal to 68 wt % and less than or equal to 73 wt % SiO₂, or even greater than or equal to 68 wt % and less than or equal to 72 wt % SiO₂. It should be understood that the above ranges include all subranges within the explicitly disclosed ranges.

In embodiments, the glass-ceramics may comprise greater than or equal to 7 wt % and less than or equal to 20 wt % Li₂O, 8 wt % and less than or equal to 20 wt % Li₂O, greater than or equal to 9 wt % and less than or equal to 20 wt % Li₂O, greater than or equal to 10 wt % and less than or equal to 20 wt % Li₂O, greater than or equal to 11 wt % and less than or equal to 20 wt % Li₂O, greater than or equal to 12 wt % and less than or equal to 20 wt % Li₂O, greater than or equal to 13 wt % and less than or equal to 20 wt % Li₂O, greater than or equal to 14 wt % and less than or equal to 20 wt % Li₂O, greater than or equal to 15 wt % and less than or equal to 20 wt % Li₂O, greater than or equal to 16 wt % and less than or equal to 20 wt % Li₂O, greater than or equal to 17 wt % and less than or equal to 20 wt % Li₂O, greater than or equal to 18 wt % and less than or equal to 20 wt % Li₂O, greater than or equal to 7 wt % and less than or equal to 19 wt % Li₂O, 8 wt % and less than or equal to 19 wt % Li₂O, 9 wt % and less than or equal to 19 wt % Li₂O, greater than or equal to 10 wt % and less than or equal to 19 wt % Li₂O, greater than or equal to 11 wt % and less than or equal to 19 wt % Li₂O, greater than or equal to 12 wt % and less than or equal to 19 wt % Li₂O, 13 wt % and less than or equal to 19 wt % Li₂O, greater than or equal to 14 wt % and less than or equal to 19 wt % Li₂O, 15 wt % and less than or equal to 19 wt % Li₂O, greater than or equal to 16 wt % and less than or equal to 19 wt % Li₂O, greater than or equal to 17 wt % and less than or equal to 19 wt % Li₂O, greater than or equal to 7 wt % and less than or equal to 18 wt % Li₂O, 8 wt % and less than or equal to 18 wt % Li₂O, 9 wt % and less than or equal to 18 wt % Li₂O, greater than or equal to 10 wt % and less than or equal to 18 wt % Li₂O, greater than or equal to 11 wt % and less than or equal to 18 wt % Li₂O, greater than or equal to 12 wt % and less than or equal to 18 wt % Li₂O, greater than or equal to 13 wt % and less than or equal to 18 wt % Li₂O, greater than or equal to 14 wt % and less than or equal to 18 wt % Li₂O, greater than or equal to 15 wt % and less than or equal to 18 wt % Li₂O, greater than or equal to 16 wt % and less than or equal to 18 wt % Li₂O, greater than or equal to 7 wt % and less than or equal to 17 wt % Li₂O, 8 wt % and less than or equal to 17 wt % Li₂O, greater than or equal to 9 wt % and less than or equal to 17 wt % Li₂O, greater than or equal to 10 wt % and less than or equal to 17 wt % Li₂O, greater than or equal to 11 wt % and less than or equal to 17 wt % Li₂O, greater than or equal to 12 wt % and less than or equal to 17 wt % Li₂O, greater than or equal to 13 wt % and less than or equal to 17 wt % Li₂O, greater than or equal to 14 wt % and less than or equal to 17 wt % Li₂O, greater than or equal to 15 wt % and less than or equal to 17 wt % Li₂O, greater than or equal to 16 wt % and less than or equal to 17 wt % Li₂O, greater than or equal to 7 wt % and less than or equal to 16 wt % Li₂O, greater than or equal to 8 wt % and less than or equal to 16 wt % Li₂O, greater than or equal to 9 wt % and less than or equal to 16 wt % Li₂O, greater than or equal to 10 wt % and less than or equal to 16 wt % Li₂O, greater than or equal to 11 wt % and less than or equal to 16 wt % Li₂O, greater than or equal to 12 wt % and less than or equal to 16 wt % Li₂O, greater than or equal to 13 wt % and less than or equal to 16 wt % Li₂O, greater than or equal to 14 wt % and less than or equal to 16 wt % Li₂O, greater than or equal to 7 wt % and less than or equal to 15 wt % Li₂O, greater than or equal to 8 wt % and less than or equal to 15 wt % Li₂O, greater than or equal to 9 wt % and less than or equal to 15 wt % Li₂O, greater than or equal to 10 wt % and less than or equal to 15 wt % Li₂O, greater than or equal to 11 wt % and less than or equal to 15 wt % Li₂O, greater than or equal to 12 wt % and less than or equal to 15 wt % Li₂O, greater than or equal to 13 wt % and less than or equal to 15 wt % Li₂O, greater than or equal to 14 wt % and less than or equal to 15 wt % Li₂O, greater than or equal to 7 wt % and less than or equal to 14 wt % Li₂O, greater than or equal to 8 wt % and less than or equal to 14 wt % Li₂O, greater than or equal to 9 wt % and less than or equal to 14 wt % Li₂O, greater than or equal to 10 wt % and less than or equal to 14 wt % Li₂O, greater than or equal to 11 wt % and less than or equal to 14 wt % Li₂O, greater than or equal to 12 wt % and less than or equal to 14 wt % Li₂O, greater than or equal to 7 wt % and less than or equal to 13 wt % Li₂O, greater than or equal to 8 wt % and less than or equal to 13 wt % Li₂O, greater than or equal to 9 wt % and less than or equal to 13 wt % Li₂O, greater than or equal to 10 wt % and less than or equal to 13 wt % Li₂O, greater than or equal to 11 wt % and less than or equal to 13 wt % Li₂O, greater than or equal to 12 wt % and less than or equal to 13 wt % Li₂O, greater than or equal to 7 wt % and less than or equal to 12 wt % Li₂O, greater than or equal to 8 wt % and less than or equal to 12 wt % Li₂O, greater than or equal to 8 wt % and less than or equal to 12 wt % Li₂O, or even greater than or equal to 10 wt % and less than or equal to 12 wt % Li₂O. It should be understood that the above ranges include all subranges within the explicitly disclosed ranges.

In embodiments, the glass-ceramic may comprise greater than or equal to 0 wt % to less than or equal to 5 wt % R₂O, wherein R is one or more of the alkali cations Na and K. In embodiments, the glass-ceramics may comprise from greater than or equal to 0.1 wt % to less than or equal to 3 wt % R₂O, wherein R is one or more of the alkali cations Na and K. In embodiments, the glass-ceramics may comprise from greater than or equal to 0.1 wt % to less than or equal to 2.5 wt % R₂O, or even from greater than or equal to 0.1 wt % to less than or equal to 2 wt % R₂O, wherein R is one or more of the alkali cations Na and K.

In embodiments, the glass-ceramic may comprise greater than or equal to 0 wt % and less than or equal to 5 wt % Na₂O, greater than or equal to 0 wt % and less than or equal to 4.5 wt % Na₂O, greater than or equal to 0 wt % and less than or equal to 4 wt % Na₂O, greater than or equal to 0 wt % and less than or equal to 3.5 wt % Na₂O, greater than or equal to 0 wt % and less than or equal to 3 wt % Na₂O, greater than or equal to 0 wt % and less than or equal to 2.5 wt % Na₂O, greater than or equal to 0 wt % and less than or equal to 2 wt % Na₂O, greater than or equal to 0 wt % and less than or equal to 1.5 wt % Na₂O, greater than or equal to 0 wt % and less than or equal to 1 wt % Na₂O, greater than or equal to 0 wt % and less than or equal to 0.5 wt % Na₂O, greater than or equal to 0.1 wt % and less than or equal to 5 wt % Na₂O, greater than or equal to 0.1 wt % and less than or equal to 4.5 wt % Na₂O, greater than or equal to 0.1 wt % and less than or equal to 4 wt % Na₂O, greater than or equal to 0.1 wt % and less than or equal to 3.5 wt % Na₂O, greater than or equal to 0.1 wt % and less than or equal to 3 wt % Na₂O, greater than or equal to 0.1 wt % and less than or equal to 2.5 wt % Na₂O, greater than or equal to 0.1 wt % and less than or equal to 2 wt % Na₂O, greater than or equal to 0.1 wt % and less than or equal to 1.5 wt % Na₂O, greater than or equal to 0.1 wt % and less than or equal to 1 wt % Na₂O, greater than or equal to 0.1 wt % and less than or equal to 0.5 wt % Na₂O, greater than or equal to 0.5 wt % and less than or equal to 5 wt % Na₂O, greater than or equal to 0.5 wt % and less than or equal to 4.5 wt % Na₂O, greater than or equal to 0.5 wt % and less than or equal to 4 wt % Na₂O, greater than or equal to 0.5 wt % and less than or equal to 3.5 wt % Na₂O, greater than or equal to 0.5 wt % and less than or equal to 3 wt % Na₂O, greater than or equal to 0.5 wt % and less than or equal to 2.5 wt % Na₂O, greater than or equal to 0.5 wt % and less than or equal to 2 wt % Na₂O, greater than or equal to 0.5 wt % and less than or equal to 1.5 wt % Na₂O, or even greater than or equal to 0.5 wt % and less than or equal to 1 wt % Na₂O. It should be understood that the above ranges include all subranges within the explicitly disclosed ranges. In some embodiments, the glass-ceramic does not contain Na₂O. In some embodiments, the glass-ceramic may be substantially free of Na₂O.

In embodiments, the glass-ceramic may comprise greater than or equal to 0 wt % and less than or equal to 5 wt % K₂O, greater than or equal to 0 wt % and less than or equal to 4.5 wt % K₂O, greater than or equal to 0 wt % and less than or equal to 4 wt % K₂O, greater than or equal to 0 wt % and less than or equal to 3.5 wt % K₂O, greater than or equal to 0 wt % and less than or equal to 3 wt % K₂O, greater than or equal to 0 wt % and less than or equal to 2.5 wt % K₂O, greater than or equal to 0 wt % and less than or equal to 2 wt % K₂O, greater than or equal to 0 wt % and less than or equal to 1.5 wt % K₂O, greater than or equal to 0 wt % and less than or equal to 1 wt % K₂O, greater than or equal to 0 wt % and less than or equal to 0.5 wt % K₂O, greater than or equal to 0.1 wt % and less than or equal to 5 wt % K₂O, greater than or equal to 0.1 wt % and less than or equal to 4.5 wt % K₂O, greater than or equal to 0.1 wt % and less than or equal to 4 wt % K₂O, greater than or equal to 0.1 wt % and less than or equal to 3.5 wt % K₂O, greater than or equal to 0.1 wt % and less than or equal to 3 wt % K₂O, greater than or equal to 0.1 wt % and less than or equal to 2.5 wt % K₂O, greater than or equal to 0.1 wt % and less than or equal to 2 wt % K₂O, greater than or equal to 0.1 wt % and less than or equal to 1.5 wt % K₂O, greater than or equal to 0.1 wt % and less than or equal to 1 wt % K₂O, greater than or equal to 0.1 wt % and less than or equal to 0.5 wt % K₂O, greater than or equal to 0.5 wt % and less than or equal to 5 wt % K₂O, greater than or equal to 0.5 wt % and less than or equal to 4.5 wt % K₂O, greater than or equal to 0.5 wt % and less than or equal to 4 wt % K₂O, greater than or equal to 0.5 wt % and less than or equal to 3.5 wt % K₂O, greater than or equal to 0.5 wt % and less than or equal to 3 wt % K₂O, greater than or equal to 0.5 wt % and less than or equal to 2.5 wt % K₂O, greater than or equal to 0.5 wt % and less than or equal to 2 wt % K₂O, greater than or equal to 0.5 wt % and less than or equal to 1.5 wt % K₂O, or even greater than or equal to 0.5 wt % and less than or equal to 1 wt % K₂O. It should be understood that the above ranges include all subranges within the explicitly disclosed ranges. In some embodiments, the glass-ceramic does not contain K₂O. In some embodiments, the glass-ceramics may be substantially free of K₂O.

In embodiments, the ratio of Li₂O (wt %) to the sum of Li₂O (wt %), Na₂O (wt %) and K₂O (wt %) (i.e., Li₂O:(Li₂O+Na₂O+K₂O)) may be greater than or equal to 0.5 and less than 1.0, greater than or equal to 0.6 and less than 1.0, greater than or equal to 0.7 and less than 1.0, greater than or equal to 0.8 and less than 1.0, or even greater than or equal to 0.9 and less than 1.0.

In some embodiments, the glass-ceramics may comprise greater than or equal to 0 wt % and less than or equal to 6.0 wt % Al₂O₃, greater than or equal to 0.1 wt % and less than or equal to 6.0 wt % Al₂O₃, greater than or equal to 0.5 wt % and less than or equal to 6.0 wt % Al₂O₃, greater than or equal to 1.0 wt % and less than or equal to 6.0 wt % Al₂O₃, greater than or equal to 1.5 wt % and less than or equal to 6.0 wt % Al₂O₃, greater than or equal to 2.0 wt % and less than or equal to 6.0 wt % Al₂O₃, greater than or equal to 2.5 wt % and less than or equal to 6.0 wt % Al₂O₃, greater than or equal to 3.0 wt % and less than or equal to 6.0 wt % Al₂O₃, greater than or equal to 3.5 wt % and less than or equal to 6.0 wt % Al₂O₃, greater than or equal to 4.0 wt % and less than or equal to 6.0 wt % Al₂O₃, greater than or equal to 4.5 wt % and less than or equal to 6.0 wt % Al₂O₃, greater than or equal to 5.0 wt % and less than or equal to 6.0 wt % Al₂O₃, greater than or equal to 5.5 wt % and less than or equal to 6.0 wt % Al₂O₃, greater than or equal to 0 wt % and less than or equal to 5.0 wt % Al₂O₃, greater than or equal to 0 wt % and less than or equal to 5.0 wt % Al₂O₃, greater than or equal to 0.1 wt % and less than or equal to 5.0 wt % Al₂O₃, greater than or equal to 0.5 wt % and less than or equal to 5.0 wt % Al₂O₃, greater than or equal to 1.0 wt % and less than or equal to 5.0 wt % Al₂O₃, greater than or equal to 1.5 wt % and less than or equal to 5.0 wt % Al₂O₃, greater than or equal to 2.0 wt % and less than or equal to 5.0 wt % Al₂O₃, greater than or equal to 2.5 wt % and less than or equal to 5.0 wt % Al₂O₃, greater than or equal to 3.0 wt % and less than or equal to 5.0 wt % Al₂O₃, greater than or equal to 3.5 wt % and less than or equal to 5.0 wt % Al₂O₃, greater than or equal to 4.0 wt % and less than or equal to 5.0 wt % Al₂O₃, greater than or equal to 4.5 wt % and less than or equal to 5.0 wt % Al₂O₃, greater than or equal to 0 wt % and less than or equal to 4.5 wt % Al₂O₃, greater than or equal to 0.1 wt % and less than or equal to 4.5 wt % Al₂O₃, greater than or equal to 0.5 wt % and less than or equal to 4.5 wt % Al₂O₃, greater than or equal to 1.0 wt % and less than or equal to 4.5 wt % Al₂O₃, greater than or equal to 1.5 wt % and less than or equal to 4.5 wt % Al₂O₃, greater than or equal to 2.0 wt % and less than or equal to 4.5 wt % Al₂O₃, greater than or equal to 2.5 wt % and less than or equal to 4.5 wt % Al₂O₃, greater than or equal to 3.0 wt % and less than or equal to 4.5 wt % Al₂O₃, greater than or equal to 3.5 wt % and less than or equal to 4.5 wt % Al₂O₃, greater than or equal to 4.0 wt % and less than or equal to 4.5 wt % Al₂O₃, greater than or equal to 0 wt % and less than or equal to 4.0 wt % Al₂O₃, greater than or equal to 0.1 wt % and less than or equal to 4.0 wt % Al₂O₃, greater than or equal to 0.5 wt % and less than or equal to 4.0 wt % Al₂O₃, greater than or equal to 1.0 wt % and less than or equal to 4.0 wt % Al₂O₃, greater than or equal to 1.5 wt % and less than or equal to 4.0 wt % Al₂O₃, greater than or equal to 2.0 wt % and less than or equal to 4.0 wt % Al₂O₃, greater than or equal to 2.5 wt % and less than or equal to 4.0 wt % Al₂O₃, greater than or equal to 3.0 wt % and less than or equal to 4.0 wt % Al₂O₃, greater than or equal to 3.5 wt % and less than or equal to 4.0 wt % Al₂O₃, greater than or equal to 0 wt % and less than or equal to 3.5 wt % Al₂O₃, greater than or equal to 0.1 wt % and less than or equal to 3.5 wt % Al₂O₃, greater than or equal to 0.5 wt % and less than or equal to 3.5 wt % Al₂O₃, greater than or equal to 1.0 wt % and less than or equal to 3.5 wt % Al₂O₃, greater than or equal to 1.5 wt % and less than or equal to 3.5 wt % Al₂O₃, greater than or equal to 2.0 wt % and less than or equal to 3.5 wt % Al₂O₃, greater than or equal to 2.5 wt % and less than or equal to 3.5 wt % Al₂O₃, greater than or equal to 3.0 wt % and less than or equal to 3.5 wt % Al₂O₃, greater than or equal to 0 wt % and less than or equal to 3.0 wt % Al₂O₃, greater than or equal to 0.1 wt % and less than or equal to 3.0 wt % Al₂O₃, greater than or equal to 0.5 wt % and less than or equal to 3.0 wt % Al₂O₃, greater than or equal to 1.0 wt % and less than or equal to 3.0 wt % Al₂O₃, greater than or equal to 1.5 wt % and less than or equal to 3.0 wt % Al₂O₃, greater than or equal to 2.0 wt % and less than or equal to 3.0 wt % Al₂O₃, greater than or equal to 2.5 wt % and less than or equal to 3.0 wt % Al₂O₃, greater than or equal to 0 wt % and less than or equal to 2.5 wt % Al₂O₃, greater than or equal to 0.1 wt % and less than or equal to 2.5 wt % Al₂O₃, greater than or equal to 0.5 wt % and less than or equal to 2.5 wt % Al₂O₃, greater than or equal to 1.0 wt % and less than or equal to 2.5 wt % Al₂O₃, greater than or equal to 1.5 wt % and less than or equal to 2.5 wt % Al₂O₃, greater than or equal to 2.0 wt % and less than or equal to 2.5 wt % Al₂O₃, greater than or equal to 0 wt % and less than or equal to 2.0 wt % Al₂O₃, greater than or equal to 0.1 wt % and less than or equal to 2.0 wt % Al₂O₃, greater than or equal to 0.5 wt % and less than or equal to 2.0 wt % Al₂O₃, greater than or equal to 1.0 wt % and less than or equal to 2.0 wt % Al₂O₃, greater than or equal to 1.5 wt % and less than or equal to 2.0 wt % Al₂O₃, greater than or equal to 0 wt % and less than or equal to 1.5 wt % Al₂O₃, greater than or equal to 0.1 wt % and less than or equal to 1.5 wt % Al₂O₃, greater than or equal to 0.5 wt % and less than or equal to 1.5 wt % Al₂O₃, greater than or equal to 1.0 wt % and less than or equal to 1.5 wt % Al₂O₃, greater than or equal to 0 wt % and less than or equal to 1.0 wt % Al₂O₃, greater than or equal to 0.1 wt % and less than or equal to 1.0 wt % Al₂O₃, greater than or equal to 0.5 wt % and less than or equal to 1.0 wt % Al₂O₃, or greater than or equal to 0.1 wt % and less than or equal to 0.5 wt % Al₂O₃. In some embodiments, the glass ceramics does not include Al₂O₃. In some embodiments, the glass ceramic may be substantially free of Al₂O₃. It should be understood that the above ranges include all subranges within the explicitly disclosed ranges.

The ratio of Al₂O₃ (wt %) to Li₂O (wt %) (Al₂O₃:Li₂O) may be minimized to reduce formation of a petalite crystalline phase and encourage the formation of the lithium disilicate crystalline phase during ceramming which, in turn, may increase the Young's modulus and/or fracture toughness of the resulting glass-ceramics. In embodiments, the ratio of Al₂O₃ (wt %) to Li₂O (wt %) may be greater than or equal to 0 and less than 0.50, greater than or equal to 0 and less than or equal to 0.45, greater than or equal to 0 and less than or equal to 0.40, greater than or equal to 0 and less than or equal to 0.35, greater than or equal to 0 and less than or equal to 0.30, greater than or equal to 0 and less than or equal to 0.25, greater than or equal to 0 and less than or equal to 0.20, greater than or equal to 0 and less than or equal to 0.15, or even greater than or equal to 0 and less than or equal to 0.1. In embodiments, the ratio of Al₂O₃ (wt %) to Li₂O (wt %) may be 0, such as when the glass ceramics is free of Al₂O₃.

In embodiments, the glass-ceramic may comprise greater than or equal to 0.1 wt % and less than or equal to 10.0 wt % CaO, greater than or equal to 0.5 wt % and less than or equal to 10.0 wt % CaO, greater than or equal to 1.0 wt % and less than or equal to 10.0 wt % CaO, greater than or equal to 1.5 wt % and less than or equal to 10.0 wt % CaO, greater than or equal to 2.0 wt % and less than or equal to 10.0 wt % CaO, greater than or equal to 2.5 wt % and less than or equal to 10.0 wt % CaO, greater than or equal to 3.0 wt % and less than or equal to 10.0 wt % CaO, greater than or equal to 3.5 wt % and less than or equal to 10.0 wt % CaO, greater than or equal to 4.0 wt % and less than or equal to 10.0 wt % CaO, greater than or equal to 4.5 wt % and less than or equal to 10.0 wt % CaO, greater than or equal to 5.0 wt % and less than or equal to 10.0 wt % CaO, greater than or equal to 5.5 wt % and less than or equal to 10.0 wt % CaO, greater than or equal to 6.0 wt % and less than or equal to 10.0 wt % CaO, greater than or equal to 6.5 wt % and less than or equal to 10.0 wt % CaO, greater than or equal to 7.0 wt % and less than or equal to 10.0 wt % CaO, greater than or equal to 7.5 wt % and less than or equal to 10.0 wt % CaO, greater than or equal to 8.0 wt % and less than or equal to 10.0 wt % CaO, greater than or equal to 8.5 wt % and less than or equal to 10.0 wt % CaO, greater than or equal to 9.0 wt % and less than or equal to 10.0 wt % CaO, greater than or equal to 0.1 wt % and less than or equal to 9.0 wt % CaO, greater than or equal to 0.5 wt % and less than or equal to 9.0 wt % CaO, greater than or equal to 1.0 wt % and less than or equal to 9.0 wt % CaO, greater than or equal to 1.5 wt % and less than or equal to 9.0 wt % CaO, greater than or equal to 2.0 wt % and less than or equal to 9.0 wt % CaO, greater than or equal to 2.5 wt % and less than or equal to 9.0 wt % CaO, greater than or equal to 3.0 wt % and less than or equal to 9.0 wt % CaO, greater than or equal to 3.5 wt % and less than or equal to 9.0 wt % CaO, greater than or equal to 4.0 wt % and less than or equal to 9.0 wt % CaO, greater than or equal to 4.5 wt % and less than or equal to 9.0 wt % CaO, greater than or equal to 5.0 wt % and less than or equal to 9.0 wt % CaO, greater than or equal to 5.5 wt % and less than or equal to 9.0 wt % CaO, greater than or equal to 6.0 wt % and less than or equal to 9.0 wt % CaO, greater than or equal to 6.5 wt % and less than or equal to 9.0 wt % CaO, greater than or equal to 7.0 wt % and less than or equal to 9.0 wt % CaO, greater than or equal to 7.5 wt % and less than or equal to 9.0 wt % CaO, greater than or equal to 8.0 wt % and less than or equal to 9.0 wt % CaO, greater than or equal to 0.1 wt % and less than or equal to 8.0 wt % CaO, greater than or equal to 0.5 wt % and less than or equal to 8.0 wt % CaO, greater than or equal to 1.0 wt % and less than or equal to 8.0 wt % CaO, greater than or equal to 1.5 wt % and less than or equal to 8.0 wt % CaO, greater than or equal to 2.0 wt % and less than or equal to 8.0 wt % CaO, greater than or equal to 2.5 wt % and less than or equal to 8.0 wt % CaO, greater than or equal to 3.0 wt % and less than or equal to 8.0 wt % CaO, greater than or equal to 3.5 wt % and less than or equal to 8.0 wt % CaO, greater than or equal to 4.0 wt % and less than or equal to 8.0 wt % CaO, greater than or equal to 4.5 wt % and less than or equal to 8.0 wt % CaO, greater than or equal to 5.0 wt % and less than or equal to 8.0 wt % CaO, greater than or equal to 5.5 wt % and less than or equal to 8.0 wt % CaO, greater than or equal to 6.0 wt % and less than or equal to 8.0 wt % CaO, greater than or equal to 6.5 wt % and less than or equal to 8.0 wt % CaO, greater than or equal to 7.0 wt % and less than or equal to 8.0 wt % CaO, greater than or equal to 0.1 wt % and less than or equal to 6.0 wt % CaO, greater than or equal to 0.5 wt % and less than or equal to 6.0 wt % CaO, greater than or equal to 1.0 wt % and less than or equal to 6.0 wt % CaO, greater than or equal to 1.5 wt % and less than or equal to 6.0 wt % CaO, greater than or equal to 2.0 wt % and less than or equal to 6.0 wt % CaO, greater than or equal to 2.5 wt % and less than or equal to 6.0 wt % CaO, greater than or equal to 3.0 wt % and less than or equal to 6.0 wt % CaO, greater than or equal to 3.5 wt % and less than or equal to 6.0 wt % CaO, greater than or equal to 4.0 wt % and less than or equal to 6.0 wt % CaO, greater than or equal to 4.5 wt % and less than or equal to 6.0 wt % CaO, greater than or equal to 5.0 wt % and less than or equal to 6.0 wt % CaO, greater than or equal to 0.1 wt % and less than or equal to 5.0 wt % CaO, greater than or equal to 0.5 wt % and less than or equal to 5.0 wt % CaO, greater than or equal to 1.0 wt % and less than or equal to 5.0 wt % CaO, greater than or equal to 1.5 wt % and less than or equal to 5.0 wt % CaO, greater than or equal to 2.0 wt % and less than or equal to 5.0 wt % CaO, greater than or equal to 2.5 wt % and less than or equal to 5.0 wt % CaO, greater than or equal to 3.0 wt % and less than or equal to 5.0 wt % CaO, greater than or equal to 3.5 wt % and less than or equal to 5.0 wt % CaO, greater than or equal to 4.0 wt % and less than or equal to 5.0 wt % CaO, greater than or equal to 0.1 wt % and less than or equal to 4.0 wt % CaO, greater than or equal to 0.5 wt % and less than or equal to 4.0 wt % CaO, greater than or equal to 1.0 wt % and less than or equal to 4.0 wt % CaO, greater than or equal to 1.5 wt % and less than or equal to 4.0 wt % CaO, greater than or equal to 2.0 wt % and less than or equal to 4.0 wt % CaO, greater than or equal to 2.5 wt % and less than or equal to 4.0 wt % CaO, greater than or equal to 3.0 wt % and less than or equal to 4.0 wt % CaO, greater than or equal to 3.5 wt % and less than or equal to 4.0 wt % CaO, greater than or equal to 0.05 wt % and less than or equal to 3.5 wt % CaO, greater than or equal to 0.1 wt % and less than or equal to 3.5 wt % CaO, greater than or equal to 0.5 wt % and less than or equal to 3.5 wt % CaO, greater than or equal to 1.0 wt % and less than or equal to 3.5 wt % CaO, greater than or equal to 1.5 wt % and less than or equal to 3.5 wt % CaO, greater than or equal to 2.0 wt % and less than or equal to 3.5 wt % CaO, greater than or equal to 2.5 wt % and less than or equal to 3.5 wt % CaO, greater than or equal to 3.0 wt % and less than or equal to 3.5 wt % CaO, greater than or equal to 0.1 wt % and less than or equal to 3.0 wt % CaO, greater than or equal to 0.5 wt % and less than or equal to 3.0 wt % CaO, greater than or equal to 1.0 wt % and less than or equal to 3.0 wt % CaO, greater than or equal to 1.5 wt % and less than or equal to 3.0 wt % CaO, greater than or equal to 2.0 wt % and less than or equal to 3.0 wt % CaO, greater than or equal to 2.5 wt % and less than or equal to 3.0 wt % CaO, greater than or equal to 0.05 wt % and less than or equal to 2.5 wt % CaO, greater than or equal to 0.1 wt % and less than or equal to 2.5 wt % CaO, greater than or equal to 0.5 wt % and less than or equal to 2.5 wt % CaO, greater than or equal to 1.0 wt % and less than or equal to 2.5 wt % CaO, greater than or equal to 1.5 wt % and less than or equal to 2.5 wt % CaO, greater than or equal to 2.0 wt % and less than or equal to 2.5 wt % CaO, greater than or equal to 0.1 wt % and less than or equal to 2.0 wt % CaO, greater than or equal to 0.5 wt % and less than or equal to 2.0 wt % CaO, greater than or equal to 1.0 wt % and less than or equal to 2.0 wt % CaO, greater than or equal to 1.5 wt % and less than or equal to 2.0 wt % CaO, greater than or equal to 0.1 wt % and less than or equal to 1.5 wt % CaO, greater than or equal to 0.5 wt % and less than or equal to 1.5 wt % CaO, greater than or equal to 1.0 wt % and less than or equal to 1.5 wt % CaO, greater than or equal to 0.1 wt % and less than or equal to 1.0 wt % CaO, greater than or equal to 0.5 wt % and less than or equal to 1.0 wt % CaO, or even greater than or equal to 0.1 wt % and less than or equal to 0.5 wt % CaO. It should be understood that the above ranges include all subranges within the explicitly disclosed ranges.

In embodiments, the glass-ceramic may comprise greater than or equal to 0.5 wt % and less than or equal to 20 wt % ZrO₂, greater than or equal to 1.0 wt % and less than or equal to 20 wt % ZrO₂, greater than or equal to 1.5 wt % and less than or equal to 20 wt % ZrO₂, greater than or equal to 2.0 wt % and less than or equal to 20 wt % ZrO₂, greater than or equal to 2.5 wt % and less than or equal to 20 wt % ZrO₂, greater than or equal to 3.0 wt % and less than or equal to 20 wt % ZrO₂, greater than or equal to 3.5 wt % and less than or equal to 20 wt % ZrO₂, greater than or equal to 4.0 wt % and less than or equal to 20 wt % ZrO₂, greater than or equal to 0.5 wt % and less than or equal to 19 wt % ZrO₂, greater than or equal to 1.0 wt % and less than or equal to 19 wt % ZrO₂, greater than or equal to 1.5 wt % and less than or equal to 19 wt % ZrO₂, greater than or equal to 2.0 wt % and less than or equal to 19 wt % ZrO₂, greater than or equal to 2.5 wt % and less than or equal to 19 wt % ZrO₂, greater than or equal to 3.0 wt % and less than or equal to 19 wt % ZrO₂, greater than or equal to 3.5 wt % and less than or equal to 19 wt % ZrO₂, greater than or equal to 4.0 wt % and less than or equal to 19 wt % ZrO₂, greater than or equal to 0.5 wt % and less than or equal to 18 wt % ZrO₂, greater than or equal to 1.0 wt % and less than or equal to 18 wt % ZrO₂, greater than or equal to 1.5 wt % and less than or equal to 18 wt % ZrO₂, greater than or equal to 2.0 wt % and less than or equal to 18 wt % ZrO₂, greater than or equal to 2.5 wt % and less than or equal to 18 wt % ZrO₂, greater than or equal to 3.0 wt % and less than or equal to 18 wt % ZrO₂, greater than or equal to 3.5 wt % and less than or equal to 18 wt % ZrO₂, greater than or equal to 4.0 wt % and less than or equal to 18 wt % ZrO₂, greater than or equal to 0.5 wt % and less than or equal to 17 wt % ZrO₂, greater than or equal to 1.0 wt % and less than or equal to 17 wt % ZrO₂, greater than or equal to 1.5 wt % and less than or equal to 17 wt % ZrO₂, greater than or equal to 2.0 wt % and less than or equal to 17 wt % ZrO₂, greater than or equal to 2.5 wt % and less than or equal to 17 wt % ZrO₂, greater than or equal to 3.0 wt % and less than or equal to 17 wt % ZrO₂, greater than or equal to 3.5 wt % and less than or equal to 17 wt % ZrO₂, greater than or equal to 4.0 wt % and less than or equal to 17 wt % ZrO₂, greater than or equal to 0.5 wt % and less than or equal to 16 wt % ZrO₂, greater than or equal to 1.0 wt % and less than or equal to 16 wt % ZrO₂, greater than or equal to 1.5 wt % and less than or equal to 16 wt % ZrO₂, greater than or equal to 2.0 wt % and less than or equal to 16 wt % ZrO₂, greater than or equal to 2.5 wt % and less than or equal to 16 wt % ZrO₂, greater than or equal to 3.0 wt % and less than or equal to 16 wt % ZrO₂, greater than or equal to 3.5 wt % and less than or equal to 16 wt % ZrO₂, greater than or equal to 4.0 wt % and less than or equal to 16 wt % ZrO₂, greater than or equal to 0.5 wt % and less than or equal to 15 wt % ZrO₂, greater than or equal to 1.0 wt % and less than or equal to 15 wt % ZrO₂, greater than or equal to 1.5 wt % and less than or equal to 15 wt % ZrO₂, greater than or equal to 2.0 wt % and less than or equal to 15 wt % ZrO₂, greater than or equal to 2.5 wt % and less than or equal to 15 wt % ZrO₂, greater than or equal to 3.0 wt % and less than or equal to 15 wt % ZrO₂, greater than or equal to 3.5 wt % and less than or equal to 15 wt % ZrO₂, greater than or equal to 4 wt % and less than or equal to 15 wt % ZrO₂, greater than or equal to 5 wt % and less than or equal to 15 wt % ZrO₂, greater than or equal to 6 wt % and less than or equal to 15 wt % ZrO₂, greater than or equal to 7 wt % and less than or equal to 15 wt % ZrO₂, greater than or equal to 8 wt % and less than or equal to 15 wt % ZrO₂, greater than or equal to 9 wt % and less than or equal to 15 wt % ZrO₂, greater than or equal to 10 wt % and less than or equal to 15 wt % ZrO₂, greater than or equal to 11 wt % and less than or equal to 15 wt % ZrO₂, greater than or equal to 12 wt % and less than or equal to 15 wt % ZrO₂, greater than or equal to 13 wt % and less than or equal to 15 wt % ZrO₂, greater than or equal to 14 wt % and less than or equal to 15 wt % ZrO₂, greater than or equal to 4 wt % and less than or equal to 14 wt % ZrO₂, greater than or equal to 5 wt % and less than or equal to 14 wt % ZrO₂, greater than or equal to 6 wt % and less than or equal to 14 wt % ZrO₂, greater than or equal to 7 wt % and less than or equal to 14 wt % ZrO₂, greater than or equal to 8 wt % and less than or equal to 14 wt % ZrO₂, greater than or equal to 9 wt % and less than or equal to 14 wt % ZrO₂, greater than or equal to 10 wt % and less than or equal to 14 wt % ZrO₂, greater than or equal to 11 wt % and less than or equal to 14 wt % ZrO₂, greater than or equal to 12 wt % and less than or equal to 14 wt % ZrO₂, greater than or equal to 4 wt % and less than or equal to 12 wt % ZrO₂, greater than or equal to 5 wt % and less than or equal to 12 wt % ZrO₂, greater than or equal to 6 wt % and less than or equal to 12 wt % ZrO₂, greater than or equal to 7 wt % and less than or equal to 12 wt % ZrO₂, greater than or equal to 8 wt % and less than or equal to 12 wt % ZrO₂, greater than or equal to 9 wt % and less than or equal to 12 wt % ZrO₂, greater than or equal to 10 wt % and less than or equal to 12 wt % ZrO₂, greater than or equal to 4 wt % and less than or equal to 10 wt % ZrO₂, greater than or equal to 5 wt % and less than or equal to 10 wt % ZrO₂, greater than or equal to 6 wt % and less than or equal to 10 wt % ZrO₂, greater than or equal to 7 wt % and less than or equal to 10 wt % ZrO₂, greater than or equal to 8 wt % and less than or equal to 10 wt % ZrO₂, greater than or equal to 4 wt % and less than or equal to 9 wt % ZrO₂, greater than or equal to 5 wt % and less than or equal to 9 wt % ZrO₂, greater than or equal to 6 wt % and less than or equal to 9 wt % ZrO₂, or greater than or equal to 7 wt % and less than or equal to 9 wt % ZrO₂. It should be understood that the above ranges include all subranges within the explicitly disclosed ranges.

In some embodiments, the ratio of Li₂O to ZrO₂ in the glass-ceramic may be greater than or equal to 1.10 to less than or equal to 5.0, greater than or equal to 1.10 to less than or equal to 4.5, greater than or equal to 1.10 to less than or equal to 4.0, greater than or equal to 1.10 to less than or equal to 3.5, greater than or equal to 1.10 to less than or equal to 3.0, greater than or equal to 1.10 to less than or equal to 2.5, or even greater than or equal to 1.10 to less than or equal to 2.0. In some embodiments, the ratio of Li₂O to ZrO₂ in the glass-ceramic may be greater than or equal to 1.10 to less than or equal to 1.90, greater than or equal to 1.15 to less than or equal to 1.90, greater than or equal to 1.20 to less than or equal to 1.90, greater than or equal to 1.25 to less than or equal to 1.90, greater than or equal to 1.30 to less than or equal to 1.90, greater than or equal to 1.35 to less than or equal to 1.90, greater than or equal to 1.40 to less than or equal to 1.90, greater than or equal to 1.45 to less than or equal to 1.90, greater than or equal to 1.50 to less than or equal to 1.90, greater than or equal to 1.55 to less than or equal to 1.90, greater than or equal to 1.60 to less than or equal to 1.90, greater than or equal to 1.65 to less than or equal to 1.90, greater than or equal to 1.70 to less than or equal to 1.90, greater than or equal to 1.75 to less than or equal to 1.90, greater than or equal to 1.80 to less than or equal to 1.90, greater than or equal to 1.10 to less than or equal to 1.85, greater than or equal to 1.15 to less than or equal to 1.85, greater than or equal to 1.20 to less than or equal to 1.85, greater than or equal to 1.25 to less than or equal to 1.85, greater than or equal to 1.30 to less than or equal to 1.85, greater than or equal to 1.35 to less than or equal to 1.85, greater than or equal to 1.40 to less than or equal to 1.85, greater than or equal to 1.45 to less than or equal to 1.85, greater than or equal to 1.50 to less than or equal to 1.85, greater than or equal to 1.55 to less than or equal to 1.85, greater than or equal to 1.60 to less than or equal to 1.85, greater than or equal to 1.65 to less than or equal to 1.85, greater than or equal to 1.70 to less than or equal to 1.85, greater than or equal to 1.75 to less than or equal to 1.85, greater than or equal to 1.10 to less than or equal to 1.80, greater than or equal to 1.15 to less than or equal to 1.80, greater than or equal to 1.20 to less than or equal to 1.80, greater than or equal to 1.25 to less than or equal to 1.80, greater than or equal to 1.30 to less than or equal to 1.80, greater than or equal to 1.35 to less than or equal to 1.80, greater than or equal to 1.40 to less than or equal to 1.80, greater than or equal to 1.45 to less than or equal to 1.80, greater than or equal to 1.50 to less than or equal to 1.80, greater than or equal to 1.55 to less than or equal to 1.80, greater than or equal to 1.60 to less than or equal to 1.80, greater than or equal to 1.65 to less than or equal to 1.80, greater than or equal to 1.70 to less than or equal to 1.80, greater than or equal to 1.10 to less than or equal to 1.75, greater than or equal to 1.15 to less than or equal to 1.75, greater than or equal to 1.20 to less than or equal to 1.75, greater than or equal to 1.25 to less than or equal to 1.75, greater than or equal to 1.30 to less than or equal to 1.75, greater than or equal to 1.35 to less than or equal to 1.75, greater than or equal to 1.40 to less than or equal to 1.75, greater than or equal to 1.45 to less than or equal to 1.75, greater than or equal to 1.50 to less than or equal to 1.75, greater than or equal to 1.55 to less than or equal to 1.75, greater than or equal to 1.60 to less than or equal to 1.75, greater than or equal to 1.65 to less than or equal to 1.75, greater than or equal to 1.10 to less than or equal to 1.70, greater than or equal to 1.15 to less than or equal to 1.70, greater than or equal to 1.20 to less than or equal to 1.70, greater than or equal to 1.25 to less than or equal to 1.70, greater than or equal to 1.30 to less than or equal to 1.70, greater than or equal to 1.35 to less than or equal to 1.70, greater than or equal to 1.40 to less than or equal to 1.70, greater than or equal to 1.45 to less than or equal to 1.70, greater than or equal to 1.50 to less than or equal to 1.70, greater than or equal to 1.55 to less than or equal to 1.70, greater than or equal to 1.60 to less than or equal to 1.70, greater than or equal to 1.10 to less than or equal to 1.65, greater than or equal to 1.15 to less than or equal to 1.65, greater than or equal to 1.20 to less than or equal to 1.65, greater than or equal to 1.25 to less than or equal to 1.65, greater than or equal to 1.30 to less than or equal to 1.65, greater than or equal to 1.35 to less than or equal to 1.65, greater than or equal to 1.40 to less than or equal to 1.65, greater than or equal to 1.45 to less than or equal to 1.65, greater than or equal to 1.50 to less than or equal to 1.65, greater than or equal to 1.55 to less than or equal to 1.65, greater than or equal to 1.10 to less than or equal to 1.60, greater than or equal to 1.15 to less than or equal to 1.60, greater than or equal to 1.20 to less than or equal to 1.60, greater than or equal to 1.25 to less than or equal to 1.60, greater than or equal to 1.30 to less than or equal to 1.60, greater than or equal to 1.35 to less than or equal to 1.60, greater than or equal to 1.40 to less than or equal to 1.60, greater than or equal to 1.45 to less than or equal to 1.60, greater than or equal to 1.50 to less than or equal to 1.60, greater than or equal to 1.55 to less than or equal to 1.60, greater than or equal to 1.10 to less than or equal to 1.55, greater than or equal to 1.15 to less than or equal to 1.55, greater than or equal to 1.20 to less than or equal to 1.55, greater than or equal to 1.25 to less than or equal to 1.55, greater than or equal to 1.30 to less than or equal to 1.55, greater than or equal to 1.35 to less than or equal to 1.55, greater than or equal to 1.40 to less than or equal to 1.55, greater than or equal to 1.45 to less than or equal to 1.55, or even greater than or equal to 1.50 to less than or equal to 1.55. It should be understood that the above ranges include all subranges within the explicitly disclosed ranges.

In embodiments, the glass-ceramic may comprise greater than or equal to 1.0 wt % and less than or equal to 8.0 wt % P₂O₅, greater than or equal to 1.5 wt % and less than or equal to 8.0 wt % P₂O₅, greater than or equal to 2.0 wt % and less than or equal to 8.0 wt % P₂O₅, greater than or equal to 2.5 wt % and less than or equal to 8.0 wt % P₂O₅, greater than or equal to 3.0 wt % and less than or equal to 8.0 wt % P₂O₅, greater than or equal to 1.0 wt % and less than or equal to 7.5 wt % P₂O₅, greater than or equal to 1.5 wt % and less than or equal to 7.5 wt % P₂O₅, greater than or equal to 2.0 wt % and less than or equal to 7.5 wt % P₂O₅, greater than or equal to 2.5 wt % and less than or equal to 7.5 wt % P₂O₅, greater than or equal to 3.0 wt % and less than or equal to 7.5 wt % P₂O₅, greater than or equal to 1.0 wt % and less than or equal to 7.0 wt % P₂O₅, greater than or equal to 1.5 wt % and less than or equal to 7.0 wt % P₂O₅, greater than or equal to 2.0 wt % and less than or equal to 7.0 wt % P₂O₅, greater than or equal to 2.5 wt % and less than or equal to 7.0 wt % P₂O₅, greater than or equal to 3.0 wt % and less than or equal to 7.0 wt % P₂O₅, greater than or equal to 1.0 wt % and less than or equal to 6.5 wt % P₂O₅, greater than or equal to 1.5 wt % and less than or equal to 6.5 wt % P₂O₅, greater than or equal to 2.0 wt % and less than or equal to 6.5 wt % P₂O₅, greater than or equal to 2.5 wt % and less than or equal to 6.5 wt % P₂O₅, greater than or equal to 3.0 wt % and less than or equal to 6.5 wt % P₂O₅, greater than or equal to 1.0 wt % and less than or equal to 6.0 wt % P₂O₅, greater than or equal to 1.5 wt % and less than or equal to 6.0 wt % P₂O₅, greater than or equal to 2.0 wt % and less than or equal to 6.0 wt % P₂O₅, greater than or equal to 2.5 wt % and less than or equal to 6.0 wt % P₂O₅, greater than or equal to 3.0 wt % and less than or equal to 6.0 wt % P₂O₅, greater than or equal to 1.0 wt % and less than or equal to 5.5 wt % P₂O₅, greater than or equal to 1.5 wt % and less than or equal to 5.5 wt % P₂O₅, greater than or equal to 2.0 wt % and less than or equal to 5.5 wt % P₂O₅, greater than or equal to 2.5 wt % and less than or equal to 5.5 wt % P₂O₅, greater than or equal to 3.0 wt % and less than or equal to 5.5 wt % P₂O₅, greater than or equal to 1.0 wt % and less than or equal to 5.0 wt % P₂O₅, greater than or equal to 1.5 wt % and less than or equal to 5.0 wt % P₂O₅, greater than or equal to 2.0 wt % and less than or equal to 5.0 wt % P₂O₅, greater than or equal to 2.5 wt % and less than or equal to 5.0 wt % P₂O₅, greater than or equal to 3.0 wt % and less than or equal to 5.0 wt % P₂O₅, greater than or equal to 1.0 wt % and less than or equal to 4.5 wt % P₂O₅, greater than or equal to 1.5 wt % and less than or equal to 4.5 wt % P₂O₅, greater than or equal to 2.0 wt % and less than or equal to 4.5 wt % P₂O₅, greater than or equal to 2.25 wt % and less than or equal to 4.5 wt % P₂O₅, greater than or equal to 2.5 wt % and less than or equal to 4.5 wt % P₂O₅, greater than or equal to 3.0 wt % and less than or equal to 4.5 wt % P₂O₅, greater than or equal to 1.0 wt % and less than or equal to 4.0 wt % P₂O₅, greater than or equal to 1.5 wt % and less than or equal to 4.0 wt % P₂O₅, greater than or equal to 2.0 wt % and less than or equal to 4.0 wt % P₂O₅, greater than or equal to 2.5 wt % and less than or equal to 4.0 wt % P₂O₅, greater than or equal to 3.0 wt % and less than or equal to 4.0 wt % P₂O₅, greater than or equal to 1.0 wt % and less than or equal to 3.5 wt % P₂O₅, greater than or equal to 1.5 wt % and less than or equal to 3.5 wt % P₂O₅, greater than or equal to 2.0 wt % and less than or equal to 3.5 wt % P₂O₅, greater than or equal to 2.25 wt % and less than or equal to 3.5 wt % P₂O₅, greater than or equal to 2.5 wt % and less than or equal to 3.5 wt % P₂O₅, or even greater than or equal to 3.0 wt % and less than or equal to 3.5 wt % P₂O₅. It should be understood that the above ranges include all subranges within the explicitly disclosed ranges.

In embodiments, the glass-ceramic may comprise greater than or equal to 0 wt % and less than or equal to 5.0 wt % MgO, greater than or equal to 0 wt % and less than or equal to 4.5 wt % MgO, greater than or equal to 0 wt % and less than or equal to 4.0 wt % MgO, greater than or equal to 0 wt % and less than or equal to 3.5 wt % MgO, greater than or equal to 0 wt % and less than or equal to 3.0 wt % MgO, greater than or equal to 0 wt % and less than or equal to 2.5 wt % MgO, greater than or equal to 0 wt % and less than or equal to 2.0 wt % MgO, greater than or equal to 0 wt % and less than or equal to 1.5 wt % MgO, greater than or equal to 0 wt % and less than or equal to 1.0 wt % MgO, greater than or equal to 0 wt % and less than or equal to 0.5 wt % MgO, greater than or equal to 0.1 wt % and less than or equal to 5.0 wt % MgO, greater than or equal to 0.1 wt % and less than or equal to 4.5 wt % MgO, greater than or equal to 0.1 wt % and less than or equal to 4.0 wt % MgO, greater than or equal to 0.1 wt % and less than or equal to 3.5 wt % MgO, greater than or equal to 0.1 wt % and less than or equal to 3.0 wt % MgO, greater than or equal to 0.1 wt % and less than or equal to 2.5 wt % MgO, greater than or equal to 0.1 wt % and less than or equal to 2.0 wt % MgO, greater than or equal to 0.1 wt % and less than or equal to 1.5 wt % MgO, greater than or equal to 0.1 wt % and less than or equal to 1.0 wt % MgO, greater than or equal to 0.1 wt % and less than or equal to 0.5 wt % MgO. In embodiments, the glass-ceramic does not include MgO. In embodiments, the glass-ceramic may be substantially free of MgO. It should be understood that the above ranges include all subranges within the explicitly disclosed ranges.

In embodiments, the glass-ceramic may comprise greater than or equal to 0 wt % and less than or equal to 10.0 wt % SrO, greater than or equal to 0 wt % and less than or equal to 9.5 wt % SrO, greater than or equal to 0 wt % and less than or equal to 9.0 wt % SrO, greater than or equal to 0 wt % and less than or equal to 8.5 wt % SrO, greater than or equal to 0 wt % and less than or equal to 8.0 wt % SrO, greater than or equal to 0 wt % and less than or equal to 7.5 wt % SrO, greater than or equal to 0 wt % and less than or equal to 7.0 wt % SrO, greater than or equal to 0 wt % and less than or equal to 6.5 wt % SrO, greater than or equal to 0 wt % and less than or equal to 6.0 wt % SrO, greater than or equal to 0 wt % and less than or equal to 5.5 wt % SrO, greater than or equal to 0 wt % and less than or equal to 5.0 wt % SrO, greater than or equal to 0 wt % and less than or equal to 4.5 wt % SrO, greater than or equal to 0 wt % and less than or equal to 4.0 wt % SrO, greater than or equal to 0 wt % and less than or equal to 3.5 wt % SrO, greater than or equal to 0 wt % and less than or equal to 3.0 wt % SrO, greater than or equal to 0 wt % and less than or equal to 2.5 wt % SrO, greater than or equal to 0 wt % and less than or equal to 2.0 wt % SrO, greater than or equal to 0 wt % and less than or equal to 1.5 wt % SrO, greater than or equal to 0 wt % and less than or equal to 1.0 wt % SrO, greater than or equal to 0 wt % and less than or equal to 0.5 wt % SrO, greater than or equal to 0.1 wt % and less than or equal to 10.0 wt % SrO, greater than or equal to 0.1 wt % and less than or equal to 9.5 wt % SrO, greater than or equal to 0.1 wt % and less than or equal to 9.0 wt % SrO, greater than or equal to 0.1 wt % and less than or equal to 8.5 wt % SrO, greater than or equal to 0.1 wt % and less than or equal to 8.0 wt % SrO, greater than or equal to 0.1 wt % and less than or equal to 7.5 wt % SrO, greater than or equal to 0.1 wt % and less than or equal to 7.0 wt % SrO, greater than or equal to 0.1 wt % and less than or equal to 6.5 wt % SrO, greater than or equal to 0.1 wt % and less than or equal to 6.0 wt % SrO, greater than or equal to 0.1 wt % and less than or equal to 5.5 wt % SrO, greater than or equal to 0.1 wt % and less than or equal to 5.0 wt % SrO, greater than or equal to 0.1 wt % and less than or equal to 4.5 wt % SrO, greater than or equal to 0.1 wt % and less than or equal to 4.0 wt % SrO, greater than or equal to 0.1 wt % and less than or equal to 3.5 wt % SrO, greater than or equal to 0.1 wt % and less than or equal to 3.0 wt % SrO, greater than or equal to 0.1 wt % and less than or equal to 2.5 wt % SrO, greater than or equal to 0.1 wt % and less than or equal to 2.0 wt % SrO, greater than or equal to 0.1 wt % and less than or equal to 1.5 wt % SrO, greater than or equal to 0.1 wt % and less than or equal to 1.0 wt % SrO, greater than or equal to 0.1 wt % and less than or equal to 0.5 wt % SrO.

In embodiments, the glass-ceramic does not include SrO. In embodiments, the glass-ceramic may be substantially free of SrO. It should be understood that the above ranges include all subranges within the explicitly disclosed ranges.

In embodiments, the glass-ceramic may comprise greater than or equal to 0 wt % and less than or equal to 10.0 wt % BaO, greater than or equal to 0 wt % and less than or equal to 9.5 wt % BaO, greater than or equal to 0 wt % and less than or equal to 9.0 wt % BaO, greater than or equal to 0 wt % and less than or equal to 8.5 wt % BaO, greater than or equal to 0 wt % and less than or equal to 8.0 wt % BaO, greater than or equal to 0 wt % and less than or equal to 7.5 wt % BaO, greater than or equal to 0 wt % and less than or equal to 7.0 wt % BaO, greater than or equal to 0 wt % and less than or equal to 6.5 wt % BaO, greater than or equal to 0 wt % and less than or equal to 6.0 wt % BaO, greater than or equal to 0 wt % and less than or equal to 5.5 wt % BaO, greater than or equal to 0 wt % and less than or equal to 5.0 wt % BaO, greater than or equal to 0 wt % and less than or equal to 4.5 wt % BaO, greater than or equal to 0 wt % and less than or equal to 4.0 wt % BaO, greater than or equal to 0 wt % and less than or equal to 3.5 wt % BaO, greater than or equal to 0 wt % and less than or equal to 3.0 wt % BaO, greater than or equal to 0 wt % and less than or equal to 2.5 wt % BaO, greater than or equal to 0 wt % and less than or equal to 2.0 wt % BaO, greater than or equal to 0 wt % and less than or equal to 1.5 wt % BaO, greater than or equal to 0 wt % and less than or equal to 1.0 wt % BaO, greater than or equal to 0 wt % and less than or equal to 0.5 wt % BaO, greater than or equal to 0.1 wt % and less than or equal to 10.0 wt % BaO, greater than or equal to 0.1 wt % and less than or equal to 9.5 wt % BaO, greater than or equal to 0.1 wt % and less than or equal to 9.0 wt % BaO, greater than or equal to 0.1 wt % and less than or equal to 8.5 wt % BaO, greater than or equal to 0.1 wt % and less than or equal to 8.0 wt % BaO, greater than or equal to 0.1 wt % and less than or equal to 7.5 wt % BaO, greater than or equal to 0.1 wt % and less than or equal to 7.0 wt % BaO, greater than or equal to 0.1 wt % and less than or equal to 6.5 wt % BaO, greater than or equal to 0.1 wt % and less than or equal to 6.0 wt % BaO, greater than or equal to 0.1 wt % and less than or equal to 5.5 wt % BaO, greater than or equal to 0.1 wt % and less than or equal to 5.0 wt % BaO, greater than or equal to 0.1 wt % and less than or equal to 4.5 wt % BaO, greater than or equal to 0.1 wt % and less than or equal to 4.0 wt % BaO, greater than or equal to 0.1 wt % and less than or equal to 3.5 wt % BaO, greater than or equal to 0.1 wt % and less than or equal to 3.0 wt % BaO, greater than or equal to 0.1 wt % and less than or equal to 2.5 wt % BaO, greater than or equal to 0.1 wt % and less than or equal to 2.0 wt % BaO, greater than or equal to 0.1 wt % and less than or equal to 1.5 wt % BaO, greater than or equal to 0.1 wt % and less than or equal to 1.0 wt % BaO, greater than or equal to 0.1 wt % and less than or equal to 0.5 wt % BaO. In embodiments, the glass-ceramic does not include BaO. In embodiments, the glass-ceramic may be substantially free of BaO. It should be understood that the above ranges include all subranges within the explicitly disclosed ranges.

In embodiments, the glass-ceramic may comprise greater than or equal to 0 wt % and less than or equal to 10.0 wt % ZnO, greater than or equal to 0 wt % and less than or equal to 9.5 wt % ZnO, greater than or equal to 0 wt % and less than or equal to 9.0 wt % ZnO, greater than or equal to 0 wt % and less than or equal to 8.5 wt % ZnO, greater than or equal to 0 wt % and less than or equal to 8.0 wt % ZnO, greater than or equal to 0 wt % and less than or equal to 7.5 wt % ZnO, greater than or equal to 0 wt % and less than or equal to 7.0 wt % ZnO, greater than or equal to 0 wt % and less than or equal to 6.5 wt % ZnO, greater than or equal to 0 wt % and less than or equal to 6.0 wt % ZnO, greater than or equal to 0 wt % and less than or equal to 5.5 wt % ZnO, greater than or equal to 0 wt % and less than or equal to 5.0 wt % ZnO, greater than or equal to 0 wt % and less than or equal to 4.5 wt % ZnO, greater than or equal to 0 wt % and less than or equal to 4.0 wt % ZnO, greater than or equal to 0 wt % and less than or equal to 3.5 wt % ZnO, greater than or equal to 0 wt % and less than or equal to 3.0 wt % ZnO, greater than or equal to 0 wt % and less than or equal to 2.5 wt % ZnO, greater than or equal to 0 wt % and less than or equal to 2.0 wt % ZnO, greater than or equal to 0 wt % and less than or equal to 1.5 wt % ZnO, greater than or equal to 0 wt % and less than or equal to 1.0 wt % ZnO, greater than or equal to 0 wt % and less than or equal to 0.5 wt % ZnO, greater than or equal to 0.1 wt % and less than or equal to 10.0 wt % ZnO, greater than or equal to 0.1 wt % and less than or equal to 9.5 wt % ZnO, greater than or equal to 0.1 wt % and less than or equal to 9.0 wt % ZnO, greater than or equal to 0.1 wt % and less than or equal to 8.5 wt % ZnO, greater than or equal to 0.1 wt % and less than or equal to 8.0 wt % ZnO, greater than or equal to 0.1 wt % and less than or equal to 7.5 wt % ZnO, greater than or equal to 0.1 wt % and less than or equal to 7.0 wt % ZnO, greater than or equal to 0.1 wt % and less than or equal to 6.5 wt % ZnO, greater than or equal to 0.1 wt % and less than or equal to 6.0 wt % ZnO, greater than or equal to 0.1 wt % and less than or equal to 5.5 wt % ZnO, greater than or equal to 0.1 wt % and less than or equal to 5.0 wt % ZnO, greater than or equal to 0.1 wt % and less than or equal to 4.5 wt % ZnO, greater than or equal to 0.1 wt % and less than or equal to 4.0 wt % ZnO, greater than or equal to 0.1 wt % and less than or equal to 3.5 wt % ZnO, greater than or equal to 0.1 wt % and less than or equal to 3.0 wt % ZnO, greater than or equal to 0.1 wt % and less than or equal to 2.5 wt % ZnO, greater than or equal to 0.1 wt % and less than or equal to 2.0 wt % ZnO, greater than or equal to 0.1 wt % and less than or equal to 1.5 wt % ZnO, greater than or equal to 0.1 wt % and less than or equal to 1.0 wt % ZnO, greater than or equal to 0.1 wt % and less than or equal to 0.5 wt % ZnO. In embodiments, the glass-ceramic does not include ZnO. In embodiments, the glass-ceramic may be substantially free of ZnO. It should be understood that the above ranges include all subranges within the explicitly disclosed ranges.

In embodiments, the glass-ceramic may comprise greater than or equal to 0 wt % and less than or equal to 2.0 wt % B₂O₃, greater than or equal to 0 wt % and less than or equal to 1.5 wt % B₂O₃, greater than or equal to 0 wt % and less than or equal to 1.0 wt % B₂O₃, greater than or equal to 0 wt % and less than or equal to 0.5 wt % B₂O₃, greater than or equal to 0.1 wt % and less than or equal to 2.0 wt % B₂O₃, greater than or equal to 0.1 wt % and less than or equal to 1.5 wt % B₂O₃, greater than or equal to 0.1 wt % and less than or equal to 1.0 wt % B₂O₃, or even greater than or equal to 0.1 wt % and less than or equal to 0.5 wt % B₂O₃. In embodiments, the glass-ceramic does not include B₂O₃. In embodiments, the glass-ceramic may be substantially free of B₂O₃. It should be understood that the above ranges include all subranges within the explicitly disclosed ranges.

In some embodiments, the glass-ceramic does not comprise Fe₂O₃. In some embodiments, the glass-ceramic may be substantially free of Fe₂O₃. In some embodiments, the glass-ceramic may comprise greater than 0.0 wt % and less than or equal to 1.0 wt % Fe₂O₃, greater than or equal to 0 wt % and less than or equal to 0.5 wt % Fe₂O₃, greater than 0.0 wt % and less than or equal to 0.3 wt % Fe₂O₃, greater than or equal to 0.0 wt % and less than or equal to 0.2 wt % Fe₂O₃, or greater than 0.0 wt % and less than or equal to 0.1 wt % Fe₂O₃. It should be understood that the above ranges include all subranges within the explicitly disclosed ranges.

In embodiments, the glass-ceramic may comprise greater than or equal to 0 wt % and less than or equal to 10.0 wt % La₂O₃, greater than or equal to 0 wt % and less than or equal to 9.5 wt % La₂O₃, greater than or equal to 0 wt % and less than or equal to 9.0 wt % La₂O₃, greater than or equal to 0 wt % and less than or equal to 8.5 wt % La₂O₃, greater than or equal to 0 wt % and less than or equal to 8.0 wt % La₂O₃, greater than or equal to 0 wt % and less than or equal to 7.5 wt % La₂O₃, greater than or equal to 0 wt % and less than or equal to 7.0 wt % La₂O₃, greater than or equal to 0 wt % and less than or equal to 6.5 wt % La₂O₃, greater than or equal to 0 wt % and less than or equal to 6.0 wt % La₂O₃, greater than or equal to 0 wt % and less than or equal to 5.5 wt % La₂O₃, greater than or equal to 0 wt % and less than or equal to 5.0 wt % La₂O₃, greater than or equal to 0 wt % and less than or equal to 4.5 wt % La₂O₃, greater than or equal to 0 wt % and less than or equal to 4.0 wt % La₂O₃, greater than or equal to 0 wt % and less than or equal to 3.5 wt % La₂O₃, greater than or equal to 0 wt % and less than or equal to 3.0 wt % La₂O₃, greater than or equal to 0 wt % and less than or equal to 2.5 wt % La₂O₃, greater than or equal to 0 wt % and less than or equal to 2.0 wt % La₂O₃, greater than or equal to 0 wt % and less than or equal to 1.5 wt % La₂O₃, greater than or equal to 0 wt % and less than or equal to 1.0 wt % La₂O₃, greater than or equal to 0 wt % and less than or equal to 0.5 wt % La₂O₃, greater than or equal to 0.1 wt % and less than or equal to 10.0 wt % La₂O₃, greater than or equal to 0.1 wt % and less than or equal to 9.5 wt % La₂O₃, greater than or equal to 0.1 wt % and less than or equal to 9.0 wt % La₂O₃, greater than or equal to 0.1 wt % and less than or equal to 8.5 wt % La₂O₃, greater than or equal to 0.1 wt % and less than or equal to 8.0 wt % La₂O₃, greater than or equal to 0.1 wt % and less than or equal to 7.5 wt % La₂O₃, greater than or equal to 0.1 wt % and less than or equal to 7.0 wt % La₂O₃, greater than or equal to 0.1 wt % and less than or equal to 6.5 wt % La₂O₃, greater than or equal to 0.1 wt % and less than or equal to 6.0 wt % La₂O₃, greater than or equal to 0.1 wt % and less than or equal to 5.5 wt % La₂O₃, greater than or equal to 0.1 wt % and less than or equal to 5.0 wt % La₂O₃, greater than or equal to 0.1 wt % and less than or equal to 4.5 wt % La₂O₃, greater than or equal to 0.1 wt % and less than or equal to 4.0 wt % La₂O₃, greater than or equal to 0.1 wt % and less than or equal to 3.5 wt % La₂O₃, greater than or equal to 0.1 wt % and less than or equal to 3.0 wt % La₂O₃, greater than or equal to 0.1 wt % and less than or equal to 2.5 wt % La₂O₃, greater than or equal to 0.1 wt % and less than or equal to 2.0 wt % La₂O₃, greater than or equal to 0.1 wt % and less than or equal to 1.5 wt % La₂O₃, greater than or equal to 0.1 wt % and less than or equal to 1.0 wt % La₂O₃, greater than or equal to 0.1 wt % and less than or equal to 0.5 wt % La₂O₃. In embodiments, the glass-ceramic does not include La₂O₃. In embodiments, the glass-ceramic may be substantially free of La₂O₃. It should be understood that the above ranges include all subranges within the explicitly disclosed ranges.

In embodiments, the glass-ceramic may comprise greater than or equal to 0 wt % and less than or equal to 3.0 wt % HfO₂, greater than or equal to 0 wt % and less than or equal to 2.5 wt % HfO₂, greater than or equal to 0 wt % and less than or equal to 2.0 wt % HfO₂, greater than or equal to 0 wt % and less than or equal to 1.5 wt % HfO₂, greater than or equal to 0 wt % and less than or equal to 1.0 wt % HfO₂, greater than or equal to 0 wt % and less than or equal to 0.5 wt % HfO₂, greater than or equal to 0.1 to less than or equal to 3 wt % HfO₂, greater than or equal to 0.1 wt % and less than or equal to 2.5 wt % HfO₂, greater than or equal to 0.1 wt % and less than or equal to 2.0 wt % HfO₂, greater than or equal to 0.1 wt % and less than or equal to 1.5 wt % HfO₂, greater than or equal to 0.1 wt % and less than or equal to 1.0 wt % HfO₂, or even greater than or equal to 0.1 wt % and less than or equal to 0.5 wt % HfO₂. In embodiments, the glass-ceramic does not include HfO₂. In embodiments, the glass-ceramic may be substantially free of HfO₂. It should be understood that the above ranges include all subranges within the explicitly disclosed ranges.

In embodiments, the glass-ceramic may comprise greater than or equal to 0 wt % and less than or equal to 2.0 wt % Y₂O₃, greater than or equal to 0 wt % and less than or equal to 1.5 wt % Y₂O₃, greater than or equal to 0 wt % and less than or equal to 1.0 wt % Y₂O₃, greater than or equal to 0 wt % and less than or equal to 0.5 wt % Y₂O₃, greater than or equal to 0.1 wt % and less than or equal to 2.0 wt % Y₂O₃, greater than or equal to 0.1 wt % and less than or equal to 1.5 wt % Y₂O₃, greater than or equal to 0.1 wt % and less than or equal to 1.0 wt % Y₂O₃, or even greater than or equal to 0.1 wt % and less than or equal to 0.5 wt % Y₂O₃. In some embodiments, the glass-ceramic does not include Y₂O₃. In some embodiments, the glass-ceramic may be substantially free of Y₂O₃. It should be understood that the above ranges include all subranges within the explicitly disclosed ranges.

In embodiments, the glass-ceramic may comprise greater than or equal to 0 wt % and less than or equal to 2.0 wt % Ta₂O₅, greater than or equal to 0 wt % and less than or equal to 1.5 wt % Ta₂O₅, greater than or equal to 0 wt % and less than or equal to 1.0 wt % Ta₂O₅, greater than or equal to 0 wt % and less than or equal to 0.5 wt % Ta₂O₅, greater than or equal to 0.1 wt % and less than or equal to 2.0 wt % Ta₂O₅, greater than or equal to 0.1 wt % and less than or equal to 1.5 wt % Ta₂O₅, greater than or equal to 0.1 wt % and less than or equal to 1.0 wt % Ta₂O₅, or even greater than or equal to 0.1 wt % and less than or equal to 0.5 wt % Ta₂O₅. In some embodiments, the glass-ceramic does not include Ta₂O₅. In some embodiments, the glass-ceramic may be substantially free of Ta₂O₅. It should be understood that the above ranges include all subranges within the explicitly disclosed ranges.

In embodiments, the glass-ceramic may comprise greater than or equal to 0 wt % and less than or equal to 5.0 wt % GeO₂, greater than or equal to 0 wt % and less than or equal to 4.5 wt % GeO₂, greater than or equal to 0 wt % and less than or equal to 4.0 wt % GeO₂, greater than or equal to 0 wt % and less than or equal to 3.5 wt % GeO₂, greater than or equal to 0 wt % and less than or equal to 3.0 wt % GeO₂, greater than or equal to 0 wt % and less than or equal to 2.5 wt % GeO₂, greater than or equal to 0 wt % and less than or equal to 2.0 wt % GeO₂, greater than or equal to 0 wt % and less than or equal to 1.5 wt % GeO₂, greater than or equal to 0 wt % and less than or equal to 1.0 wt % GeO₂, greater than or equal to 0 wt % and less than or equal to 0.5 wt % GeO₂, greater than or equal to 0.1 wt % and less than or equal to 5.0 wt % GeO₂, greater than or equal to 0.1 wt % and less than or equal to 4.5 wt % GeO₂, greater than or equal to 0.1 wt % and less than or equal to 4.0 wt % GeO₂, greater than or equal to 0.1 wt % and less than or equal to 3.5 wt % GeO₂, greater than or equal to 0.1 wt % and less than or equal to 3.0 wt % GeO₂, greater than or equal to 0.1 wt % and less than or equal to 2.5 wt % GeO₂, greater than or equal to 0.1 wt % and less than or equal to 2.0 wt % GeO₂, greater than or equal to 0.1 wt % and less than or equal to 1.5 wt % GeO₂, greater than or equal to 0.1 wt % and less than or equal to 1.0 wt % GeO₂, or even greater than or equal to 0.1 wt % and less than or equal to 0.5 wt % GeO₂. In some embodiments, the glass-ceramic does not include GeO₂. In some embodiments, the glass-ceramic may be substantially free of GeO₂. It should be understood that the above ranges include all subranges within the explicitly disclosed ranges.

In embodiments, the glass-ceramic may comprise greater than or equal to 0 wt % and less than or equal to 2.0 wt % TiO₂, greater than or equal to 0 wt % and less than or equal to 1.5 wt % TiO₂, greater than or equal to 0 wt % and less than or equal to 1.0 wt % TiO₂, greater than or equal to 0 wt % and less than or equal to 0.5 wt % TiO₂, greater than or equal to 0.1 wt % and less than or equal to 2.0 wt % TiO₂, greater than or equal to 0.1 wt % and less than or equal to 1.5 wt % TiO₂, greater than or equal to 0.1 wt % and less than or equal to 1.0 wt % TiO₂, or even greater than or equal to 0.1 wt % and less than or equal to 0.5 wt % TiO₂. In some embodiments, the glass-ceramic does not include TiO₂. In some embodiments, the glass-ceramic may be substantially free of TiO₂. It should be understood that the above ranges include all subranges within the explicitly disclosed ranges.

In embodiments, the glass-ceramic may further include F⁻. In embodiments, the glass-ceramic may comprise greater than or equal to 0 wt % and less than or equal to 1.5 wt % F⁻, greater than or equal to 0 wt % and less than or equal to 1.0 wt % F⁻, greater than or equal to 0 wt % and less than or equal to 0.5 wt % F⁻, greater than or equal to 0.1 wt % and less than or equal to 2.0 wt % F⁻, greater than or equal to 0.1 wt % and less than or equal to 1.5 wt % F⁻, greater than or equal to 0.1 wt % and less than or equal to 1.0 wt % F⁻, or even greater than or equal to 0.1 wt % and less than or equal to 0.5 wt % F. In some embodiments, the glass-ceramic does not include F⁻. In some embodiments, the glass-ceramic may be substantially free of F. It should be understood that the above ranges include all subranges within the explicitly disclosed ranges.

In embodiments, the glass-ceramic may further include a chemical fining agent. Such fining agents include, but are not limited to, SnO₂, As₂O₃, Sb₂O₃, SO₃ F, Cl and Br. In embodiments, the concentrations of the chemical fining agents are kept at a level of 3, 2, 1, or 0.5, >0 wt %. In embodiments, the chemical fining agent may be SnO₂ and the glass-ceramic may comprise greater than or equal to 0 to less than or equal to 3 wt % SnO₂. In embodiments, the glass-ceramic may comprise greater than or equal to 0 wt % and less than or equal to 2.5 wt % SnO₂, greater than or equal to 0 wt % and less than or equal to 2.0 wt % SnO₂, greater than or equal to 0 wt % and less than or equal to 1.5 wt % SnO₂, greater than or equal to 0 wt % and less than or equal to 1.0 wt % SnO₂, greater than or equal to 0 wt % and less than or equal to 0.5 wt % SnO₂, greater than 0.01 wt % to less than or equal to 3 wt % SnO₂, greater than 0.01 wt % and less than or equal to 2.5 wt % SnO₂, greater than 0.01 wt % and less than or equal to 2.0 wt % SnO₂, greater than 0.01 wt % and less than or equal to 1.5 wt % SnO₂, greater than 0.01 wt % and less than or equal to 1.0 wt % SnO₂, or even greater than 0.01 wt % and less than or equal to 0.5 wt % SnO₂. In some embodiments, the glass-ceramic does not include a chemical fining agent.

In some embodiments, the glass-ceramic may be substantially free of Sb₂O₃, As₂O₃, or combinations thereof. For example, the glass-ceramic may comprise 0.05 weight percent or less of Sb₂O₃ or As₂O₃ or a combination thereof, the glass-ceramic may comprise 0 wt % of Sb₂O₃ or As₂O₃ or a combination thereof, or the glass-ceramic may be, for example, free of any intentionally added Sb₂O₃, As₂O₃, or combinations thereof.

The glass-ceramic substrate 110 of the article 100 may be formed from man-made materials and/or naturally occurring materials (e.g., quartz). In some specific embodiments, the glass-ceramic substrate 110 may specifically exclude polymeric, plastic and/or metal substrates. The glass-ceramic substrate 110 may be characterized as an alkali-including substrate (i.e., the substrate includes one or more alkalis).

In some embodiments, the glass-ceramic substrate may comprise greater than or equal to 55 wt % and less than or equal to 80 wt % SiO₂; greater than or equal to 7 wt % and less than or equal to 20 wt % Li₂O; greater than or equal to 1 wt % and less than or equal to 8 wt % P₂O₅; greater than or equal to 0.1 wt % and less than or equal to 5.0 wt % Na₂O; greater than 0.5 wt % to less than or equal to 20 wt % ZrO₂; greater than or equal to 1 wt % to less than 4 wt % CaO; and less than 1 wt % K₂O, wherein a ratio of Al₂O₃ (wt %) to Li₂O (wt %) in the glass-ceramic is greater than or equal to 0 and less than 0.20.

According to an embodiment, the glass-ceramic substrate 110 may comprise or consist essentially of the following composition: 55-80 wt % SiO₂; 0-6 wt % Al₂O₃; 1-8 wt % P₂O₅; 0-5 wt % B₂O₃; 7-20 wt % Li₂O; 0-5 wt % Na₂O; 0-5 wt % K₂O; 0.5-20 wt % ZrO₂; 0.01-0.5 wt % SnO₂; 0-3 wt % HfO₂; and 0-0.5 wt % Fe₂O₃. An exemplary composition used and referred to as GC1 in the Examples section is provided in Table 1 above, as measured prior to any ceramming step.

According to one or more embodiments, the glass-ceramic substrate 110 may comprise or consist essentially of the following composition: 68-72 mol % SiO₂; 3-5 mol % Al₂O₃; 0.6-1.2 mol % P₂O₅; 0-5 mol % B₂O₃; 17-25 mol % Li₂O; 0.01-1.7 mol % Na₂O; 0.01-0.5 mol % K₂O; 1.5-3 mol % ZrO₂; 0.01-0.1 mol % SnO₂; 0.01-0.1 mol % HfO₂; and 0.01-0.5 mol % Fe₂O₃. Three exemplary glass-ceramic compositions referred to as GC2, GC3, and GC4 are provided in Table 2 above, as measured prior to any ceramming step, with exemplary glass-ceramic compositions GC2 and GC3 also used in the Examples section.

In one or more embodiments, the glass-ceramic substrate 110 may include one or more glass-ceramic materials. In one or more embodiments, the glass-ceramic substrate 110 as a glass-ceramic material may comprise one or more crystalline phases such as lithium disilicate (Li₂Si₂O₅), lithium metasilicate, petalite (LiAlSi₄O₁₀), beta quartz solid solutions, and/or beta spodumene solid solutions, as potentially combined with residual glass in the structure. In an embodiment, the glass-ceramic substrate 110 may comprise a disilicate phase. In another implementation, the glass-ceramic substrate 110 may comprise a disilicate phase and a petalite phase. According to an embodiment, the glass-ceramic substrate 110 may have a crystallinity of at least about 40% by weight. In some implementations, the glass-ceramic substrate 110 at the thickness midpoint (i.e., in the bulk of the body) may have a crystallinity of at least about 40%, 45%, 50%, 55%, 60%, 65%, 70%, 75%, 80%, 85%, or greater (by weight), with the residual as a glass phase. Further, according to some embodiments, each of the crystalline phases of the glass-ceramic substrate 110 may have an average crystallite size of less than 100 nm, less than 75 nm, less than 50 nm, less than 40 nm, less than 30 nm, and all crystallite sizes within or less than these levels. According to one exemplary embodiment, the glass-ceramic substrate 110 may comprise lithium disilicate and petalite phases with 40-50 wt. % lithium disilicate (Li₂Si₂O₅), 35-45 wt. % petalite (LiAlSi₄O₁₀), <2 wt. % of other phases, and the remainder as residual glass (e.g., 10-21 wt. % glass) (exemplary phase assemblages for GC2, GC3, and GC4 are listed above in Table 2). Unless otherwise noted, all phase assemblage amounts and values are measured through X-ray diffraction (XRD) using a Rietveld analysis.

In embodiments, the glass-ceramics and glass-ceramic articles are capable of being chemically tempered (also referred to as chemically strengthened) using one or more ion exchange techniques. In these embodiments, ion exchange can occur by subjecting one or more surfaces of such glass-ceramic or glass-ceramic article to one or more ion exchange mediums (for example molten salt baths), having a specific composition and temperature, for a specified time period to impart to the one or more surfaces with compressive stress layer(s). In embodiments, the ion exchange medium may be a molten salt bath containing an ion (for example an alkali metal ion) that is larger than an ion (for example an alkali metal ion) present in the glass-ceramic or glass-ceramic article wherein the larger ion from the molten bath is exchanged with the smaller ion in the glass-ceramic article to impart a compressive stress in the glass-ceramic or glass-ceramic article, and thereby increases the strength of the glass-ceramic or glass-ceramic article.

In embodiments, a one-step ion exchange process can be used. In other embodiments, a multi-step ion exchange process (such as a two-step ion exchange process) can be used. In embodiments, for both one-step and multi-step ion exchange processes, the ion exchange mediums (for example, molten baths) can include potassium nitrate (KNO₃) and sodium nitrate (NaNO₃) as primary components. The ion exchange mediums can, in embodiments, further comprise lithium nitrate (LiNO₃), sodium nitrite (NaNO₂), and silicic acid.

After an ion exchange process is performed, it should be understood that a composition at the surface of the glass-ceramic may be different from the composition of the as-formed glass-ceramic (i.e., the glass-ceramic before it undergoes an ion exchange process). This results from one type of alkali metal ion in the as-formed glass-ceramic, such as, for example Li⁺ or Na⁺, being replaced with larger alkali metal ions, such as, for example Na⁺ or K⁺, respectively. However, the composition of the glass-ceramic at or near the center of the depth of the glass-ceramic may, in some embodiments, have the composition of the as-formed glass-ceramic. As utilized herein, the center of the glass-ceramic article refers to any location in the glass-ceramic article that is a distance of at least 0.5t from every surface thereof, where t is the thickness of the glass-ceramic or glass-ceramic article.

According to one or more embodiments, the glass-ceramic substrate 110 according to one or more embodiments may have a total thickness from the first major surface 112 to the second major surface 114 ranging from about 100 μm to about 5 mm. Example glass-ceramic substrate 110 total thicknesses range from 100 microns to 150 microns, from 150 microns to 200 microns, from 200 microns to 250 microns, from 250 microns to 300 microns, from 300 microns to 350 microns, from 350 microns to 400 microns, from 400 microns to 450 microns, from 450 microns to 500 microns, from 500 microns to 550 microns, from 550 microns to 600 microns, from 600 microns to 650 microns, from 650 microns to 700 microns, from 700 microns to 750 microns, from 750 microns to 800 microns, from 800 microns to 850 microns, from 850 microns to 900 microns, from 900 microns to 950 microns, from 950 microns to 1000 microns (1 mm), or any combination of one or more of these ranges. In additional embodiments, glass-ceramic substrate 110 total thicknesses may range from 1.0 mm to 1.25 mm, from 1.25 mm to 1.5 mm, from 1.5 mm to 1.75 mm, from 1.75 mm to 2.0 mm, from 2.0 mm to 2.25 mm, from 2.25 mm to 2.5 mm, from 2.5 mm to 2.75 mm, from 2.75 mm to 3.0 mm, from 3.0 mm to 3.25 mm, from 3.25 mm to 3.5 mm, from 3.5 mm to 3.75 mm, from 3.75 mm to 4.0 mm, from 4.0 mm to 4.25 mm, from 4.25 mm to 4.5 mm, from 4.5 mm to 4.75 mm, from 4.75 mm to 5.0 mm, or any combination of one or more of these ranges.

In embodiments, the article 100 further comprises a multilayer coating 119 disposed on the first major surface 112 of the glass-ceramic substrate 110. The multilayer coating may include high and low refractive index materials to form an interference layer structure.

In some embodiments, the multilayer coating may comprise an optical film structure 120 comprising a physical thickness from about 50 nm to less than about 800 nm and a plurality of alternating high refractive index and low refractive index layers. The optical film structure 120 may be an anti-reflective coating.

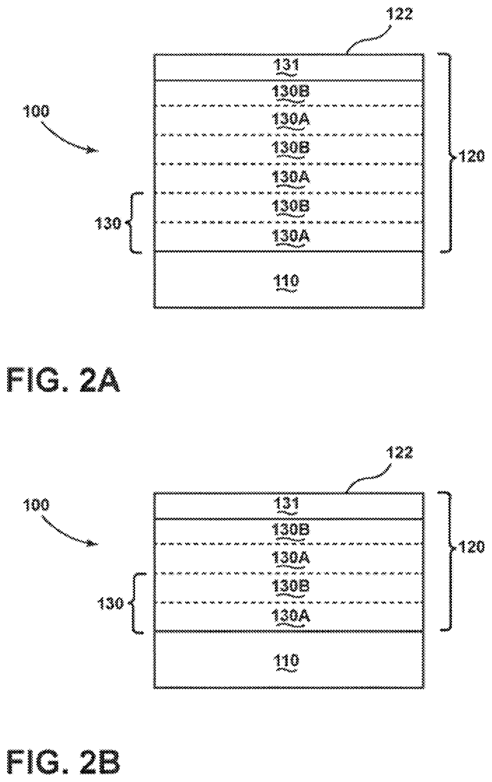

As shown in FIG. 1, the optical film structure 120 of the article 100 may include a plurality of layers 120A, 120B, 120C. In some embodiments, one or more layers may be disposed on the opposite side of the substrate 110 from the optical film structure 120 (i.e., on major surface 114) (not shown). The substrate 110 includes opposing major surfaces 112 (first major surface), 114 (second major surface) and opposing minor surfaces 116, 118. In some embodiments of the article 100, layer 120C, as shown in FIG. 1, can serve as a capping layer (e.g., capping layer 131 as shown in FIGS. 2A and 2B and described in the sections below).

The physical thickness of the optical film structure 120 may be in the range from about 50 nm to less than about 800 nm. In some instances, the physical thickness of the optical film structure 120 may be in the range from about 10 nm to less than 500 nm, from about 50 nm to less than 500 nm, from about 75 nm to less than 500 nm, from about 100 nm to less than 500 nm, from about 125 nm to less than 500 nm, from about 150 nm to less than 500 nm, from about 175 nm to less than 500 nm, from about 200 nm to less than 500 nm, from about 225 nm to less than 500 nm, from about 250 nm to less than 500 nm, from about 300 nm to less than 500 nm, from about 350 nm to less than 500 nm, from about 400 nm to less than 500 nm, from about 450 nm to less than 500 nm, from about 200 nm to about 450 nm, and all ranges and sub-ranges therebetween. For example, the physical thickness of the optical film structure 120 may be from 10 nm to 490 nm, or from 10 nm to 480 nm, or from 10 nm to 475 nm, or from 10 nm to 460 nm, or from 10 nm to 450 nm, or from 10 nm to 430 nm, or from 10 nm to 425 nm, or from 10 nm to 420 nm, or from 10 nm to 410 nm, or from 10 nm to 400 nm, or from 10 nm to 350 nm, or from 10 nm to 300 nm, or from 10 nm to 250 nm, or from 10 nm to 225 nm, or from 10 nm to 200 nm, or from 15 nm to 490 nm, or from 20 nm to 490 nm, or from 25 nm to 490 nm, or from 30 nm to 490 nm, or from 35 nm to 490 nm, or from 40 nm to 490 nm, or from 45 nm to 490 nm, or from 50 nm to 490 nm, or from 55 nm to 490 nm, or from 60 nm to 490 nm, or from 65 nm to 490 nm, or from 70 nm to 490 nm, or from 75 nm to 490 nm, or from 80 nm to 490 nm, or from 85 nm to 490 nm, or from 90 nm to 490 nm, or from 95 nm to 490 nm, or from 100 nm to 490 nm, or from 10 nm to 485 nm, or from 15 nm to 480 nm, or from 20 nm to 475 nm, or from 25 nm to 460 nm, or from 30 nm to 450 nm, or from 35 nm to 440 nm, or from 40 nm to 430 nm, or from 50 nm to 425 nm, or from 55 nm to 420 nm, or from 60 nm to 410 nm, or from 70 nm to 400 nm, or from 75 nm to 400 nm, or from 80 nm to 390 nm, or from 90 nm to 380 nm, or from 100 nm to 375 nm, or from 110 nm to 370 nm, or from 120 nm to 360 nm, or from 125 nm to 350 nm, or from 130 nm to 325 nm, or from 140 nm to 320 nm, or from 150 nm to 310 nm, or from 160 nm to 300 nm, or from 170 nm to 300 nm, or from 175 nm to 300 nm, or from 180 nm to 290 nm, or from 190 nm to 280 nm, or from 200 nm to 275 nm.

In one or more embodiments, as shown in FIGS. 2A and 2B, the optical film structure 120 of the article 100 may include a period 130 comprising two or more layers. In one or more embodiments, the two or more layers may be characterized as having different refractive indices from each another. In some embodiments, the period 130 includes a first low RI layer 130A and a second high RI layer 130B. The difference in the refractive index of the first low RI layer 130A and the second high RI layer 130B may be about 0.01 or greater, 0.05 or greater, 0.1 or greater or even 0.2 or greater. In some implementations, the refractive index of the low RI layer(s) 130A is within the refractive index of the substrate 110 such that the refractive index of the low RI layer(s) 130A is less than about 1.8, and the high RI layer(s) 130B have a refractive index that is greater than 1.8.

As shown in FIG. 2A, the optical film structure 120 may include a plurality of periods (130). A single period includes a first low RI layer 130A and a second high RI layer 130B, such that when a plurality of periods are provided, the first low RI layer 130A (designated for illustration as “L”) and the second high RI layer 130B (designated for illustration as “H”) alternate in the following sequence of layers: L/H/L/H or H/L/H/L, such that the first low RI layer and the second high RI layer appear to alternate along the physical thickness of the optical film structure 120. In the example in FIG. 2A, the optical film structure 120 includes three periods 130 such that there are three pairs of low RI and high RI layers 130A and 130B, respectively. In the example in FIG. 2B, the optical film structure 120 includes two periods 130 such that there are two pairs of low RI and high RI layers 130A and 130B, respectively. In some embodiments, the optical film structure 120 may include up to 25 periods. For example, the optical film structure 120 may include from about 2 to about 20 periods, from about 2 to about 15 periods, from about 2 to about 10 periods, from about 2 to about 12 periods, from about 3 to about 8 periods, from about 3 to about 6 periods.

In the embodiments of the article 100 shown in FIGS. 2A and 2B, the optical film structure 120 may include an additional capping layer 131, which may include a lower refractive index material than the second high RI layer 130B. In some implementations, the refractive index of the capping layer 131 may be the same or substantially the same as the refractive index of the low RI layers 130A.

As used herein, the terms “low RI” and “high RI” refer to the relative values for the RI of each layer relative to the RI of another layer within the optical film structure 120 (e.g., low RI<high RI) and may differ from the low RI and high RI terms used in connection with the thicker optical film structure described herein below. In one or more embodiments, the term “low RI” when used with the first low RI layer 130A or with the capping layer 131, includes a range from about 1.3 to about 1.7. In one or more embodiments, the term “high RI” when used with the high RI layer 130B, includes a range from about 1.6 to about 2.5. In some instances, the ranges for low RI and high RI may overlap; however, in most instances, the layers of the optical film structure 120 have the general relationship regarding RI of: low RI<high RI.

Exemplary materials suitable for use in the optical film structure 120 include: SiO₂, Al₂O₃, GeO₂, SiO, AlOₓN_{y}, AlN, oxygen-doped SiNₓ, SiNₓ, SiOₓN_{y}, SiᵤAlᵥOₓN_{y}, TiO₂, ZrO₂, TiN, MgO, HfO₂, Y₂O₃, diamond-like carbon, and MgAl₂O₄.

Some examples of suitable materials for use in the low RI layer(s) 130A include SiO₂, Al₂O₃, GeO₂, SiO, AlOₓN_{y}, SiOₓN_{y}, SiᵤAlᵥOₓN_{y}, MgO, and MgAl₂O₄. The nitrogen content of the materials for use in the first low RI layer 130A (i.e., the layer 130A in contact with the substrate 110) may be minimized (e.g., in materials, for example, Al₂O₃ and MgAl₂O₄). In some embodiments, the low RI layer(s) 130A and a capping layer 131, if present, in the optical film structure 120 can comprise one or more of a silicon-containing oxide (e.g., silicon dioxide), a silicon-containing nitride (e.g., an oxide-doped silicon nitride, silicon nitride, etc.), and a silicon-containing oxynitride (e.g., silicon oxynitride). In some embodiments of the article 100, the low RI layer(s) 130A and the capping layer 131 comprise a silicon-containing oxide, e.g., SiO₂.

Some examples of suitable materials for use in the high RI layer(s) 130B include SiᵤAlᵥOₓN_{y}, AlN, oxygen-doped SiNₓ, SiNₓ, Si₃N₄, AlOₓN_{y}, SiOₓN_{y}, HfO₂, TiO₂, ZrO₂, Y₂O₃, Al₂O₃, and diamond-like carbon. The oxygen content of the materials for the high RI layer(s) 130B may be minimized, especially in SiNₓ or AlNₓ materials. The foregoing materials may be hydrogenated up to about 30% by weight. In some embodiments, the high RI layer(s) 130B in the optical film structure 120 can comprise one or more of a silicon-containing oxide (e.g., silicon dioxide), a silicon-containing nitride (e.g., an oxide-doped silicon nitride, silicon nitride, etc.), and a silicon-containing oxynitride (e.g., silicon oxynitride). In some embodiments of the article 100, the high RI layer(s) 130B comprise a silicon-containing nitride, e.g., Si₃N₄. Where a material having a medium refractive index is desired between a high RI and a low RI, some embodiments may utilize AlN, SiOₓN_{y}, AlOₓN_{y}, and/or SiAlOₓN_{y}. The hardness of the high RI layer may be characterized specifically. In some embodiments, the maximum hardness of the high RI layer(s) 130B, as measured by the Berkovich Indenter Hardness Test over an indentation depth from about 100 nm to about 500 nm (i.e., as on a hardness test stack with a 2 micron thick layer of the material of the layer 130B disposed on a substrate 110), may be about 18 GPa or greater, about 20 GPa or greater, about 22 GPa or greater, about 24 GPa or greater, about 26 GPa or greater, and all values therebetween.

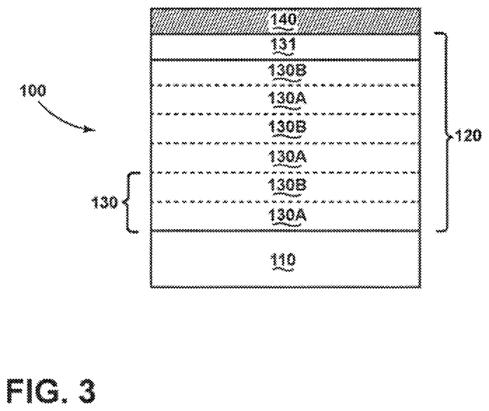

In one or more embodiments at least one of the layers of the optical film structure 120 of the article 100 may include a specific optical thickness range. As used herein, the term “optical thickness” is determined by (n*d), where “n” refers to the RI of the sub-layer and “d” refers to the physical thickness of the layer. In one or more embodiments, at least one of the layers of the optical film structure 120 may include an optical thickness in the range from about 2 nm to about 200 nm, from about 10 nm to about 100 nm, or from about 15 nm to about 100 nm. In some embodiments, all of the layers in the optical film structure 120 may each have an optical thickness in the range from about 2 nm to about 200 nm, from about 10 nm to about 100 nm, or from about 15 nm to about 100 nm. In some cases, at least one layer of the optical film structure 120 has an optical thickness of about 50 nm or greater. In some cases, each of the low RI layers 130A have an optical thickness in the range from about 2 nm to about 200 nm, from about 10 nm to about 100 nm, or from about 15 nm to about 100 nm. In other cases, each of the high RI layers 130B have an optical thickness in the range from about 2 nm to about 200 nm, from about 10 nm to about 100 nm, or from about 15 nm to about 100 nm. In some embodiments, each of the high RI layers 130B have an optical thickness in the range from about 2 nm to about 500 nm, or from about 10 nm to about 490 nm, or from about 15 nm to about 480 nm, or from about 25 nm to about 475 nm, or from about 25 nm to about 470 nm, or from about 30 nm to about 465 nm, or from about 35 nm to about 460 nm, or from about 40 nm to about 455 nm, or from about 45 nm to about 450 nm, and any and all sub-ranges between these values. In some embodiments, the capping layer 131 (see FIGS. 2A, 2B and 3), or the outermost low RI layer 130A for configurations without a capping layer 131, has a physical thickness of less than about 100 nm, less than about 90 nm, less than about 85 nm, or less than 80 nm.

As noted earlier, embodiments of the article 100 are configured such that the physical thickness of one or more of the layers of the optical film structure 120 are minimized. In one or more embodiments, the physical thickness of the high RI layer(s) 130B and/or the low RI layer(s) 130A are minimized such that they total less than 500 nm. In one or more embodiments, the combined physical thickness of the high RI layer(s) 130B, the low RI layer(s) 130A and any capping layer 131 is less than 500 nm, less than 490 nm, less than 480 nm, less than 475 nm, less than 470 nm, less than 460 nm, less than about 450 nm, less than 440 nm, less than 430 nm, less than 425 nm, less than 420 nm, less than 410 nm, less than about 400 nm, less than about 350 nm, less than about 300 nm, less than about 250 nm, or less than about 200 nm, and all total thickness values below 500 nm and above 10 nm. For example, the combined physical thickness of the high RI layer(s) 130B, the low RI layer(s) 130A and any capping layer 131 may be from 10 nm to 490 nm, or from 10 nm to 480 nm, or from 10 nm to 475 nm, or from 10 nm to 460 nm, or from 10 nm to 450 nm, or from 10 nm to 450 nm, or from 10 nm to 430 nm, or from 10 nm to 425 nm, or from 10 nm to 420 nm, or from 10 nm to 410 nm, or from 10 nm to 400 nm, or from 10 nm to 350 nm, or from 10 nm to 300 nm, or from 10 nm to 250 nm, or from 10 nm to 225 nm, or from 10 nm to 200 nm, or from 15 nm to 490 nm, or from 20 nm to 490 nm, or from 25 nm to 490 nm, or from 30 nm to 490 nm, or from 35 nm to 490 nm, or from 40 nm to 490 nm, or from 45 nm to 490 nm, or from 50 nm to 490 nm, or from 55 nm to 490 nm, or from 60 nm to 490 nm, or from 65 nm to 490 nm, or from 70 nm to 490 nm, or from 75 nm to 490 nm, or from 80 nm to 490 nm, or from 85 nm to 490 nm, or from 90 nm to 490 nm, or from 95 nm to 490 nm, or from 100 nm to 490 nm, or from 10 nm to 485 nm, or from 15 nm to 480 nm, or from 20 nm to 475 nm, or from 25 nm to 460 nm, or from 30 nm to 450 nm, or from 35 nm to 440 nm, or from 40 nm to 430 nm, or from 50 nm to 425 nm, or from 55 nm to 420 nm, or from 60 nm to 410 nm, or from 70 nm to 400 nm, or from 75 nm to 400 nm, or from 80 nm to 390 nm, or from 90 nm to 380 nm, or from 100 nm to 375 nm, or from 110 nm to 370 nm, or from 120 nm to 360 nm, or from 125 nm to 350 nm, or from 130 nm to 325 nm, or from 140 nm to 320 nm, or from 150 nm to 310 nm, or from 160 nm to 300 nm, or from 170 nm to 300 nm, or from 175 nm to 300 nm, or from 180 nm to 290 nm, or from 190 nm to 280 nm, or from 200 nm to 275 nm.

In one or more embodiments, the combined physical thickness of the high RI layer(s) 130B may be characterized. For example, in some embodiments, the combined physical thickness of the high RI layer(s) 130B may be about 90 nm or greater, about 100 nm or greater, about 150 nm or greater, about 200 nm or greater, about 250 nm or greater, or about 300 nm or greater, but less than 500 nm. The combined physical thickness is the calculated combination of the physical thicknesses of the individual high RI layer(s) 130B in the optical film structure 120, even when there are intervening low RI layer(s) 130A or other layer(s). In some embodiments, the combined physical thickness of the high RI layer(s) 130B, which may also comprise a high-hardness material (e.g., a nitride or an oxynitride), may be greater than 30% of the total physical thickness of the optical film structure 120 (or, alternatively referred to in the context of volume). For example, the combined physical thickness (or volume) of the high RI layer(s) 130B may be about 30% or greater, about 35% or greater, about 40% or greater, about 45% or greater, about 50% or greater, about 55% or greater, or even about 60% or greater, of the total physical thickness (or volume) of the optical film structure 120.

The article 100 may include one or more additional coatings 140 disposed on the optical film structure 120, as shown in FIG. 3. In one or more embodiments, the additional coating may include an easy-to-clean coating. An example of a suitable easy-to-clean coating is described in U.S. patent application Ser. No. 13/690,904, entitled “PROCESS FOR MAKING OF GLASS ARTICLES WITH OPTICAL AND EASY-TO-CLEAN COATINGS,” filed on Nov. 30, 2012, which is incorporated herein in its entirety by reference. The easy-to-clean coating may have a physical thickness in the range from about 5 nm to about 50 nm and may include known materials, for example, fluorinated silanes. In some embodiments, the easy-to-clean coating may have a physical thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm or from about 7 nm to about 10 nm, and all ranges and sub-ranges therebetween.

The additional coating 140 may comprise a scratch resistant coating. Exemplary materials used in the scratch resistant coating may include an inorganic carbide, nitride, oxide, diamond-like material, or combination of these. Examples of suitable materials for the scratch resistant coating include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch resistant coating may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y} and combinations thereof.

In some embodiments, the additional coating 140 includes a combination of easy-to-clean material and scratch resistant material. In one example, the combination includes an easy-to-clean material and diamond-like carbon. Such additional coatings 140 may have a physical thickness in the range from about 5 nm to about 20 nm. The constituents of the additional coating 140 may be provided in separate layers. For example, the diamond-like carbon material may be disposed as a first layer and the easy-to-clean material can be disposed as a second layer on the first layer of diamond-like carbon. The physical thicknesses of the first layer and the second layer may be in the ranges provided above for the additional coating. For example, the first layer of diamond-like carbon may have a physical thickness of about 1 nm to about 20 nm or from about 4 nm to about 15 nm (or more specifically about 10 nm) and the second layer of the easy-to-clean material may have a physical thickness of about 1 nm to about 10 nm (or more specifically about 6 nm). The diamond-like coating may include tetrahedral amorphous carbon (Ta—C), Ta—C:H, and/or Ta—C—H.

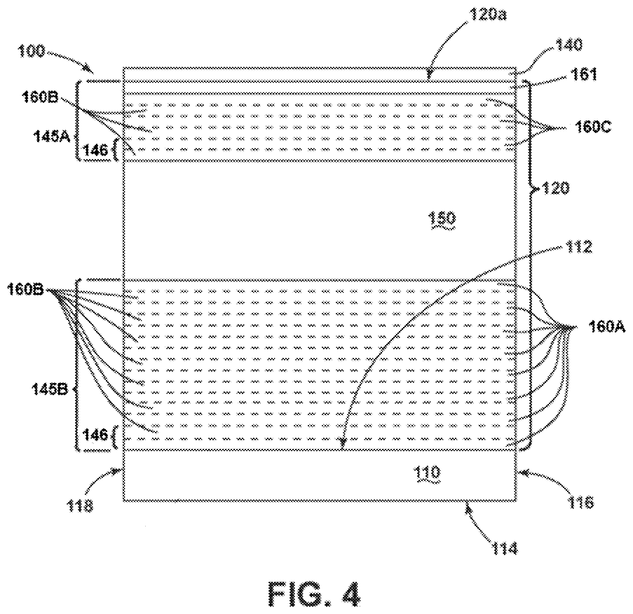

In some embodiments, the multilayer coating may comprise an optical film structure having an outer surface and a physical thickness of from about 200 nm to 5000 nm, the optical film structure disposed on the first major surface. In some embodiments, as depicted for example in FIG. 4, the optical film structure 120 is divided into an outer structure 145A and an inner structure 145B, with a scratch-resistant layer 150 (as detailed further below) disposed between the structures 145A and 145B. In these embodiments, the outer and inner optical film structures 145A and 145B may have the same thicknesses or different thicknesses, and each comprises one or more layers.

Referring again to the transparent article 100 depicted in FIG. 4, the optical film structure 120 includes one or more scratch-resistant layer(s) 150. For example, the transparent article 100 depicted in FIG. 4 includes an optical film structure 120 with a scratch-resistant layer 150 disposed over a primary surface 112 of the glass-ceramic substrate 110. According to one embodiment, the scratch-resistant layer 150 may comprise one or more materials chosen from SiᵤAlᵥOₓN_{y}, Ta₂O₅, Nb₂O₅, AlN, AlNₓ, SiAlₓN_{y}, AlNₓ/SiAlₓN_{y}, Si₃N₄, AlOₓN_{y}, SiOₓN_{y}, SiN_{y}, SiNₓ:H_{y}, HfO₂, TiO₂, ZrO₂, Y₂O₃, Al₂O₃, MoO₃, diamond-like carbon, or combinations thereof. Exemplary materials used in the scratch-resistant layer 150 may include an inorganic carbide, nitride, oxide, diamond-like material, or combinations thereof. Examples of suitable materials for the scratch-resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 150 may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y}, and combinations thereof. In some implementations, the scratch-resistant layer 150 may include Si₃N₄, SiN_{y}, SiOₓN_{y}, and combinations thereof. In some embodiments, each of the scratch-resistant layers 150 employed in the transparent article 100 may exhibit an effective fracture toughness value greater than about 1 MPa m and simultaneously exhibits a hardness value greater than about 10 GPa, as measured by a Berkovich Hardness Test.

Each of the scratch-resistant layers 150, as shown in exemplary form in the transparent article 100 depicted in FIG. 4, can be comprised of any of the foregoing materials such that it exhibits a refractive index (RI) of greater than 1.70, or greater than 1.80. In some implementations, the RI of the scratch-resistant layer 150 is greater than 1.55, 1.60, 1.65, 1.70, 1.75, 1.80, 1.85, or 1.90. For example, the RI of the scratch-resistant layer 150 can be 1.55, 1.60, 1.65, 1.70, 1.75, 1.80, 1.85, 1.9, 1.95, 2.0, 2.05, 2.10, 2.15, 2.20, 2.25, 2.3, 2.35, 2.4, 2.45, 2.5, and all RI values between the foregoing values.

Each of the scratch-resistant layers 150, as shown in exemplary form in the transparent article 100 depicted in FIG. 4, may be relatively thick as compared with other layers (e.g., low RI layers 160A, high RI layers 160B, medium RI layers 160C, capping layer 161, etc.) such as greater than or equal to about 50 nm, 75 nm, 100 nm, 150 nm, 200 nm, 250 nm, 300 nm, 325 nm, 350 nm, 375 nm, 400 nm, 425 nm, 450 nm, 475 nm, 500 nm, 525 nm, 550 nm, 575 nm, 600 nm, 700 nm, 800 nm, 900 nm, 1 micron, 1.5 microns, or even 2 microns. For example, a scratch-resistant layer 150 may have a thickness from about 50 nm to about 3 microns, from about 100 nm to about 2.5 microns, from about 150 nm to about 2 microns, from about 500 nm to 2500 nm, from about 500 nm to about 2000 nm, from about 500 nm to about 1500 nm, and all thickness levels and ranges between the foregoing ranges. In other implementations, the scratch-resistant layer 150 may have a thickness from about 100 nm to about 2,000 nm, from about 500 nm to about 1500 nm, or from about 750 nm to about 1250 nm.

As shown in FIG. 4, and outlined above, the transparent articles 100 of the disclosure include an optical film structure 120 with one or more of an outer structure 145A and inner structure 145B. The optical film structure 120 includes a scratch-resistant layer 150, at least one low RI layer 160A, at least one medium RI layer 160C, and at least one high RI layer 160B. In embodiments, the optical film structure 120 includes a plurality of alternating low RI and high RI layers, 160A and 160B, respectively. The outer structure 145A of the optical film structure 120 includes a plurality of alternating medium RI and high RI layers, 160C and 160B. In some embodiments, the inner structure 145B includes a plurality of alternating low RI and high RI layers, 160A and 160B, respectively. In other embodiments, the inner structure 145B includes one or more layers having a graduated or gradient in refractive index, e.g., with refractive index values that span between the refractive index ranges of low RI and high RI layers 160A, 160B, respectively, or between the refractive index values of the glass-ceramic substrate 110 and the scratch resistant layer 150. In some preferred implementations, the outer structure 145A includes at least one medium RI layer 160C in contact with one of the high RI layers 160B and the scratch-resistant layer 150. In some preferred implementations, the outer structure 145A is inclusive of at least one outermost capping layer 161 (e.g., with a refractive index within the range of those specified for low RI layers 160A), as depicted in exemplary form in FIG. 4.

According to embodiments, each of the outer and inner structures 145A and 145B includes a period 146 of two or more layers, such as the low RI layer 160A and high RI layer 160B; or a low RI layer 160A, high RI layer 160B and a low RI layer 160A; or a high RI layer 160B and a medium RI layer 160C. Further, each of the outer and inner structures 145A and 145B of the optical film structure 120 may include a plurality of periods 146, such as 1 to 30 periods, 1 to 25 periods, 1 to 20 periods, and all periods within the foregoing ranges. In addition, the number of periods 146, the number of layers of the outer and inner structures 145A and 145B, and/or the number of layers within a given period 146 can differ or they may be the same. Further, in some implementations, the total amount of the plurality of alternating low RI and high RI layers 160A and 160B and/or medium RI layers 160C and high RI layers 160B, along with the scratch-resistant layer 150, may range from 6 to 50 layers, 6 to 40 layers, 6 to 30 layers, 6 to 28 layers, 6 to 26 layers, 6 to 24 layers, 6 to 22 layer, 6 to 20 layers, 6 to 18 layers, 6 to 16 layers, and 6 to 14 layers, and all ranges of layers and amounts of layers between the foregoing values. In a preferred implementation, the total amount of the plurality of alternating low RI and high RI layers 160A and 160B and/or medium RI layers 160C and high RI layers 160B, along with the scratch-resistant layer 150, may range from 15 to 23 layers (e.g., 19 layers).

As an example, in FIG. 4, each of the periods 146 of the inner and outer structures 145A, 145B, respectively, includes a low RI layer 160A and a high RI layer 160B or a medium RI layer 160C and a high RI layer 160B. When a plurality of periods is included in either or both of the outer and inner structures 145A and 145B, the low RI layers 160A (designated as “L”), the medium RI layers 160C (designated “M”), and the high RI layers 160B (designated as “H”) can alternate in the following sequence of layers: L/H/L/H . . . , H/L/H/L . . . , M/H/M/H . . . , H/M/H/M . . . , such that the low RI layers 160A and the high RI layers 160B, or the medium RI layers 160C and the high RI layers 160B, alternate along the physical thickness of the outer and inner structures 145A, 145B of the optical film structure 120. In preferred implementations, as shown in FIG. 4, the periods 146 in the outer structures 145A are configured as M/H/M/H . . . above the scratch-resistant layer 150; and the periods 146 in the inner structures 145B are configured as L/H/L/H . . . above the glass-ceramic substrate 110 and beneath the scratch-resistant layer 150.

In an implementation of the transparent article 100, as shown in FIG. 4, the number of periods 146 of the outer and inner structures 145A and 145B can be configured such that the outer structure 145A includes a total of eight (8) alternating layers (e.g., alternating medium and high RI layers 160C and 160B); and the inner structure 145B includes at least nine (9) layers (e.g., alternating low RI and high RI layers 160A, 160B, respectively). Further, in this implementation, the outer structure 145A of the optical film structure 120 includes a capping layer 161 (similar in structure and thickness to a low RI layer 160A) over the outer structure 145A; and the optical film structure 120 includes a scratch-resistant layer 150 disposed between the outer and inner structures 145A and 145B. Accordingly, in the implementation depicted in exemplary form in FIG. 4, the optical structure 120 includes a total of 19 layers.

According to some implementations of the transparent articles 100 of the disclosure, each of the outer and inner structures 145A and 145B of the optical film structure 120 has a total of at least 7, 8, 9, 10, 11, 12, 13, 14, or even 15 layers. According to some embodiments of the transparent articles 100 of the disclosure, the optical film structure 120 has a total of at least 15, 16, 17, 18, 19, 20, 25, or even 30 layers. In one preferred implementation of the transparent article 100, as depicted in FIG. 4, the outer structure 145A includes at least four (4) medium RI layers 160C, at least four (4) high RI layers 160B, and one of the high RI layers 160B is in contact with an outermost capping layer 161 (e.g., a low RI layer 160A).

According to some embodiments of the transparent article 100 depicted in FIG. 4, the outermost capping layer 161 of the optical film structure 120 and outer structure 145A may not be exposed but instead have a top coating 140 disposed thereon. In some implementations of the transparent article 100, each high RI layer 160B of the optical film structure 120, along with the outer and inner structures 145A, 145B, comprises a nitride, a silicon-containing nitride (e.g., SiN_{y}, Si₃N₄), an oxynitride, or a silicon-containing oxynitride (e.g., SiAlₓO_{y}N_{z} or SiOₓN_{y}). Further, according to some embodiments, each low RI layer 160A of the optical film structure 120, along with the outer and inner structures 145A, 145B, comprises an oxide, a silicon-containing oxide (e.g., SiO₂, SiOₓ or SiO₂ as doped with Zr, Al, N or F), or a silicon-containing oxynitride (e.g., SiOₓN_{y}). In addition, according to some embodiments, the scratch-resistant layer 150 and each medium RI layer 160C of the optical film structure 120 comprises an oxynitride or a silicon-containing oxynitride (e.g., SiAlₓO_{y}N_{z} or SiOₓN_{y}). In a preferred implementation of the transparent article 100 depicted in FIG. 4, the outer structure 145A comprises a plurality of alternating high RI layers 160B of SiNₓ and medium RI layers 160C of SiOₓN_{y} (along with an optional capping layer 161 of SiO₂ or SiOₓN_{y}); and the inner structure 145B comprises a plurality of alternating high RI layers 160B of SiOₓN_{y} and low RI layers 160A of SiO₂.

In one or more embodiments of the transparent article 100 depicted in FIG. 4, the term “low RI”, when used with the low RI layers 160A and/or capping layer 161, includes a refractive index range of less than about 1.7, less than about 1.55, or from about 1.3 to about 1.55, from about 1.35 to about 1.55, from about 1.35 to about 1.7, from about 1.4 to about 1.5, from about 1.45 to about 1.5, and all indices within these ranges. In one or more embodiments, the term “medium RI”, when used with the medium RI layers 160C and/or scratch-resistant layer 150, includes a refractive index range from 1.5 to 1.9, from 1.5 to 1.85, 1.55 to 1.9, 1.55 to 1.80, 1.55 to 1.65, 1.56 to 1.80, 1.6 to 1.75, and all indices within these ranges. In one or more embodiments, the term “high RI”, when used with the high RI layers 160B and/or scratch-resistant layer 150, includes a refractive index range of greater than 1.80, greater than 1.90, from about 1.8 to about 2.5, from about 1.8 to about 2.3, from about 1.85 to about 2.1, from about 1.9 to about 2.1, or from about 1.90 to about 2.5, and all indices between these ranges. Further, in a specific implementation, the medium RI layer(s) of the transparent articles 100 of the disclosure (see, e.g., FIG. 4), may include a refractive index range from about 1.55 to 1.90, 1.55 to 1.85, 1.55 to 1.80, 1.55 to 1.75, 1.55 to 1.65, and all values between these ranges. In one or more embodiments, the difference in the refractive index of each of the low RI layers 160A (and/or capping layer 161), the medium RI layers 160C (and/or scratch-resistant layer 150), and/or the high RI layers 160B (and/or scratch-resistant layer 150) may be about 0.01 or greater, about 0.05 or greater, about 0.1 or greater, or even about 0.2 or greater. In general, for a given embodiment, the definition of which layers in the optical film structure 120 are high RI, medium RI, and low RI will be defined by their relative values, that is, the RI value of the high RI layers 160B is greater than the RI value of the medium RI layers 160C, and the RI value of the medium RI layers 160C is greater than the RI value of the low RI layers 160A.

Example materials suitable for use in the outer and inner structures 145A and 145B of the optical film structure 120 of the transparent article 100 depicted in FIG. 4 include, without limitation, SiO₂, SiOₓ, Al₂O₃, SiAlₓO_{y}, GeO₂, SiO, AlOₓN_{y}, AlN, AlNₓ, SiAlₓN_{y}, SiN_{y}, SiOₓN_{y}, SiAlₓO_{y}N_{z}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, diamond-like carbon and combinations thereof. Some examples of suitable materials for use in a low RI layer 160A and the outermost capping layer 161 include, without limitation, SiO₂, SiOₓ, Al₂O₃, SiAlₓO_{y}, GeO₂, SiO, AlOₓN_{y}, SiOₓN_{y}, SiAlₓO_{y}N, MgO, MgAlₓO_{y}, MgF₂, BaF₂, CaF₂, DyF₃, YbF₃, YF₃, and CeF₃. In some implementations of the transparent article 100, each of its low RI layers 160A includes a silicon-containing oxide (e.g., SiO₂ or SiOₓ) or a silicon-containing oxynitride (e.g., SiOₓN_{y}). The nitrogen content of the materials for use in a low RI layer 160A may be minimized (e.g., in materials such as SiOₓN_{y}, Al₂O₃ and MgAlₓO_{y}). Some examples of suitable materials for use in a high RI layer 160B include, without limitation, SiAlₓO_{y}N_{z}, Ta₂O₅, Nb₂O₅, AlN, AlNₓ, SiAlₓN_{y}, AlNₓ/SiAlₓN_{y}, Si₃N₄, AlOₓN_{y}, SiOₓN_{y}, SiN_{y}, SiNₓ:H_{y}, HfO₂, TiO₂, ZrO₂, Y₂O₃, Al₂O₃, MoO₃, and diamond-like carbon. Some examples of suitable materials for use in a medium RI layer 160C include, without limitation, SiAlₓO_{y}N_{z}, AlOₓN_{y}, SiOₓN_{y}, HfO₂, Y₂O₃, and Al₂O₃. According to some implementations, each high RI layer 160B of the outer and inner structures 145A, 145B includes a silicon-containing nitride or a silicon-containing oxynitride (e.g., Si₃N₄, SiN_{y}, or SiOₓN_{y}). In one or more embodiments, each of the high RI layers 160B may have high hardness (e.g., hardness of greater than 8 GPa), and the high RI materials listed above may comprise high hardness and/or scratch resistance.

The oxygen content of the materials for the high RI layer 160B may be minimized, especially in SiN_{y} materials. Further, exemplary SiOₓN_{y} high RI materials may comprise from about 0 atom % to about 20 atom % oxygen, or from about 5 atom % to about 15 atom % oxygen, while including 30 atom % to about 50 atom % nitrogen. The foregoing materials may be hydrogenated up to about 30% by weight. Where a material having a medium refractive index is desired as a medium RI layer 160C, some embodiments may utilize SiOₓN_{y}, e.g., with a relatively low level of nitrogen (e.g., less than 10%, less than 5%, or less than 3%). It should be understood that a scratch-resistant layer 150 of the transparent articles 100 may comprise any of the materials disclosed as suitable for use in a high RI layer 160B or a medium RI layer 160C.

In one or more embodiments of the transparent article 100, the optical film structure 120 includes a scratch-resistant layer 150 that can be integrated as a medium RI layer 160C, and one or more low RI layers 160A, high RI layers 160B, medium RI layers 160C, and/or a capping layer 161 may be positioned over the scratch-resistant layer 150. Also, with regard to the scratch-resistant layer 150, as shown in FIG. 4, an optional top coating 140 may also be positioned over the layer 150. The scratch-resistant layer 150 may be alternately defined as the thickest medium RI layer 160C in the overall optical film structure 120 and/or in the outer and the inner structures 145A, 145B.

Without being bound by theory, it is believed that the transparent article 100 depicted in FIG. 4 may exhibit increased hardness at low indentation depths (e.g., 100-125 nm) when one or more medium RI layers 160C (e.g., as comprising SiOₓN_{y}) is placed in direct contact with one or more high RI layers 160B (e.g., SiOₓN_{y}, SiN_{y}) in the outer structure 145A; the outer structure 145A is comprised of alternating layers of high RI layers 160B and medium RI layers 160C (which replaces alternating high RI layers 160B and low RI layers 160A in known optical film structures); the sum of the physical thicknesses of the low RI layers 160A and/or the capping layer 161 in the outer structure 145A is minimized; and the total thickness of the layers in the outer structure 145A is minimized. In some implementations, an additional, repeating medium RI layer 160C can be deployed in the outer structure 145A in contact with another medium RI layer 160C or scratch-resistant layer 150 to also increase hardness at shallow depths within the optical film structure 120. According to some implementations, the sum of the physical thicknesses of the low RI layers 160A and/or the capping layer 161 in the outer structure 145A is configured to be less than about 275 nm, less than about 250 nm, less than about 225 nm, less than about 200 nm, less than about 175 nm, less than about 150 nm, less than about 125 nm, less than 110 nm, less than 100 nm, less than 90 nm, less than 75 nm, or even less than 65 nm, which can also increase hardness at shallow depths within the optical film structure 120. For example, the sum of the physical thicknesses of the low RI layers 160A and/or the capping layer 161 in the outer structure 145A can be 250 nm, 225 nm, 200 nm, 175 nm, 150 nm, 125 nm, 120 nm, 110 nm, 100 nm, 90 nm, 80 nm, 70 nm, and all total thickness values between the foregoing values. Further, in some implementations, the total physical thickness of the layers in the outer structure 145A of the transparent articles 100 depicted in FIG. 4 can be configured to be less than 1000 nm, less than 900 nm, or less than 800 nm, and greater than 400 nm, 450 nm, or even 500 nm, and all total thickness values in the foregoing ranges.

Referring generally to the transparent article 100 depicted in FIG. 4, the optical film structures 120 of these articles may exhibit high hardness at shallow depths. Further, these optical film structures 120 may employ one or more medium RI layers 160C (e.g., n=1.55 to 1.9, SiOₓN_{y} material), sometimes in combination with one or more high RI layers 160B (e.g., n=1.8 or greater, SiNₓ), in the outer structure 145A. This strategy tends to enable a minimized use of lower-index materials (e.g., low RI layers 160A) in the optical film structure 120 and the outer structure 145A, which is an important factor in boosting the maximum hardness of the overall optical film structure 120, as well as the hardness measured at shallow indentation depths (as measured from the air-side surface 120a) such as 20 nm, 40 nm, 100 nm, and 125 nm.

Further, in some embodiments of the transparent article 100 depicted in FIG. 4, the inner structure 145B can comprise a refractive index gradient (not shown in FIG. 4) rather than, for example, a plurality of low and high RI layers 160A, 160B. Thus, in these embodiments, the transparent article 100 may comprise in order: 1) a glass-ceramic substrate 110; 2) a refractive index gradient structure as the inner structure 145B; 3) a scratch resistant layer 150; and 4) an outer structure 145A enabling high shallow hardness. The refractive index gradient may be formed by a compositional gradient. In such embodiments, the composition at or adjacent to the primary surface 112 of the substrate 110 may be tuned to have a refractive index within about 0.05 refractive index units of the refractive index of the substrate 110 itself (e.g., from about 1.45 to 1.55), while the composition at or adjacent to the scratch resistant layer 150 may be tuned to have a refractive index within about 0.1 refractive index units of the refractive index of the scratch resistant layer 150 (e.g., from about 1.65 to 1.95). The thickness of the refractive index gradient region (i.e., as the inner structure 145B) may preferably be in the range from about 100 nm to 500 nm.

In some embodiments of the transparent article 100 depicted in FIG. 4 with an inner structure 145B comprising a refractive index gradient (gradient not shown in FIG. 4), the gradient is derived from a compositional gradient formed from materials such as Si, Al, N, O, C, and/or combinations thereof. In one or more specific embodiments, the composition gradient is formed from Si, N and/or O. In one example, the refractive index gradient may include an oxygen-content gradient in which the oxygen content decreases or remains constant along the thickness of the refractive index gradient in the direction from the substrate surface to the scratch resistant layer. In yet another example, the refractive index gradient may include a nitrogen-content gradient in which the nitrogen content increases or remains constant along the thickness of the refractive index gradient in the direction from the substrate surface to the scratch resistant layer. In one or more alternative embodiments, the optical film structure 120 may include a density gradient and/or an elastic modulus gradient, in addition to or instead of the refractive index gradient otherwise described herein. In embodiments, an elastic modulus gradient can be utilized to further improve certain mechanical performance aspects of the transparent article 100, such as maintaining or improving retained strength, reducing warp, or reducing delamination.

The optical film structure 120 may have a physical thickness of from about 100 nm to about 5000 nm. For example, the optical film structure 120 may have a thickness greater than or equal to about 200 nm, 300 nm, 325 nm, 350 nm, 375 nm, 400 nm, 500 nm, 600 nm, 700 nm, 800 nm, 900 nm, 1 micron, 2 microns, 3 microns, 4 microns, and less than or equal to about 5 microns. In some implementations of the transparent articles 100 depicted in FIG. 4, the optical film structure 120 has a physical thickness from 200 nm to 5000 nm, 500 nm to 2000 nm, or 1500 nm to 2000 nm, and all sub-ranges and thickness values between the foregoing ranges.

In some embodiments, the various layers of the multilayer coating on the glass-ceramic substrate may be combined in various combinations and sequences without any particular limitation to the number or sequence of the layers. For example, the article may comprise in sequence glass-ceramic substrate (GCS)/gradient layer(s) (GRAD)/scratch resistant layer (also referred to as a hardcoat (HC))/interference layer(s)/capping layer/surface modifying layer (e.g., ETC). These elements may also be combined in different sequences or may be repeated more than once in a particular coating design. As another example, these coating structural elements may be combined in the following sequences: 1) GCS/GRAD/HC; 2) GCS/GRAD/HC/GRAD; 3) GCS/INT/HC; 4) GCS/INT/HC/INT; 5) GCS/GRAD/HC/INT; 6) GCS/INT/HC/GRAD; 7) GCS/GRAD/HC/INT/HC; 8) GCS/INT/HC/INT/HC/INT. Various other sequences may be used. For example. glass-ceramic substrate (GCS)/gradient layer(s) (GRAD)/scratch resistant layer (also referred to as a hardcoat (HC))/interference layer(s)/a second scratch resistant layer (HC)/surface modifying layer (e.g., ETC). As shown in FIG. 4, the article may optionally further comprise any of the additional coating layer(s) 140 discussed above and below, such as, for example, one or more of a surface modifying layer, planarization layer, an easy-to-clean coating, a diamond-like coating, and a scratch resistant coating, disposed on the optical film structure.

The optical film structure may comprise a scratch-resistant layer, at least one low refractive index (RI) layer, at least one medium RI layer, and at least one high RI layer. The optical film structure may further comprise an outer structure and an inner structure, the scratch-resistant layer disposed between the outer and inner structures, the inner structure disposed on the first primary surface, the outer structure comprising a plurality of alternating high and medium RI layers, and the inner structure comprises a plurality of alternating high RI layers and low RI layers.

In some embodiments, the at least one medium RI layer may comprise a refractive index from 1.55 to 1.80, each of the high RI layers may comprise a refractive index of greater than 1.80, and each of the low RI layers may comprise a refractive index of less than 1.55.

In some embodiments, the outer structure may comprise at least one medium RI layer in contact with one or both of: the scratch-resistant layer and one of the high RI layers.

In some embodiments, a sum of the physical thicknesses of all of the low RI layers in the outer structure is less than about 200 nm.

According to embodiments of the transparent article 100 depicted in FIG. 4, each of the low RI layers 160A and high RI layers 160B of the outer and inner structures 145A, 145B of the optical film structure 120 can have a physical thickness that ranges from about 5 nm to 1000 nm, 5 nm to 500 nm, about 5 nm to 250 nm, about 5 nm to 200 nm, and all thicknesses and ranges of thickness between these values. For example, each of these low RI layers 160A and high RI layers 160B can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels. Further, according to embodiments of the transparent article 100 depicted in FIG. 4, each of the scratch-resistant layer 150 and medium RI layers 160C of the outer and inner structures 145A, 145B of the optical film structure 120 can have a physical thickness that ranges from about 5 nm to 2500 nm, 5 nm to 2000 nm, about 5 nm to 1500 nm, about 5 nm to 1000 nm, and all thicknesses and ranges of thickness between these values. For example, each of the medium RI layers 160C (as not employed as a scratch-resistant layer 150) can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels. Further, according to some implementations, each of the low RI layers 160A (e.g., a capping layer 161), medium RI layers 160C and high RI layers 160B of the outer structure 145A can have a physical thickness that ranges from about 5 nm to 250 nm, about 5 nm to 200 nm, about 5 nm to 175 nm, and all thicknesses and ranges of thickness between these values. As an example, each of these layers 160A-160C can have a physical thickness of 5 nm, 10 nm, 20 nm, 30 nm, 40 nm, 50 nm, 60 nm, 70 nm, 80 nm, 90 nm, 100 nm, 125 nm, 150 nm, 175 nm, 200 nm, 225 nm, 250 nm, and all thickness values between these levels.

In one or more embodiments, a single layer or multiple layers of the optical film structure 120 may be deposited onto a glass-ceramic substrate 110 by a vacuum deposition technique such as, for example, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used such as spraying, dipping, spin coating, or slot coating (e.g., using sol-gel materials). Generally, vapor deposition techniques may include a variety of vacuum deposition methods which can be used to produce thin films. For example, physical vapor deposition uses a physical process (such as heating or sputtering) to produce a vapor of material, which is then deposited on the object which is coated. Preferred methods of fabricating the optical film structure 120 can include reactive sputtering, metal-mode reactive sputtering and PECVD processes.

In embodiments, the glass-ceramic article has a haze of less or equal to 1.0, 0.95, 0.90, 0.85, 0.80, 0.75, 0.70, 0.65, 0.60, 0.55, 0.50, 0.45, 0.40, 0.35, 0.30, 0.25, 0.20, 0.15, 0.14, 0.13, 0.12, 0.11, 0.10, 0.09, 0.08, 0.07, 0.06, or 0.05. In one or more embodiments the glass-ceramic article exhibiting such haze has a thickness of less than or equal to 0.6 mm, such as less than or equal to 0.5 mm, less than or equal to 0.4 mm, less than or equal to 0.3 mm, less than or equal to 0.2 mm, or even less than or equal to 0.1 mm. In embodiments, the haze is greater than or equal to 0.05 and less than or equal to 0.40, greater than or equal to 0.05 and less than or equal to 0.35, greater than or equal to 0.05 and less than or equal to 0.30, greater than or equal to 0.05 and less than or equal to 0.25, greater than or equal to 0.05 and less than or equal to 0.20, greater than or equal to 0.05 and less than or equal to 0.15, or even greater than or equal to 0.05 and less than or equal to 0.10. In one or more embodiments, the glass-ceramic article exhibiting such haze has a thickness of less than or equal to 0.6 mm, such as less than or equal to 0.5 mm, less than or equal to 0.4 mm, less than or equal to 0.3 mm, less than or equal to 0.2 mm, or even less than or equal to 0.1 mm. It should be understood that the above ranges include all subranges within the explicitly disclosed ranges.

In some embodiments, the article may exhibit a hardness of 8 GPa or greater, or 9 GPa or greater, or 10 GPa or greater, measured at an indentation depth of 100 nm, the hardness measured by a Berkovich Indenter Hardness Test.

In some embodiments, the article may exhibit a maximum hardness of 9 GPa or greater, 10 GPa or greater, 12 GPa or greater, 14 GPa or greater, or 15 GPa or greater, measured over an indentation depth range from 0 nm to 1000 nm, the maximum hardness measured by a Berkovich Indenter Hardness Test.

In some embodiments, the article may exhibit a maximum hardness of 9 GPa or greater, 10 GPa or greater, 12 GPa or greater, 14 GPa or greater, or 15 GPa or greater, measured over an indentation depth range from 100 nm to 500 nm, the maximum hardness measured by a Berkovich Indenter Hardness Test.

In embodiments, the glass-ceramic substrate of the article may have a surface compressive stress (CS) of greater than or equal to 200 MPa and less than or equal to 650 MPa, such as greater than or equal to 225 MPa and less than or equal to 650 MPa, greater than or equal to 250 MPa and less than or equal to 650 MPa, greater than or equal to 275 MPa and less than or equal to 650 MPa, greater than or equal to 300 MPa and less than or equal to 650 MPa, greater than or equal to 325 MPa and less than or equal to 650 MPa, greater than or equal to 350 MPa and less than or equal to 650 MPa, greater than or equal to 375 MPa and less than or equal to 650 MPa, greater than or equal to 400 MPa and less than or equal to 650 MPa, greater than or equal to 425 MPa and less than or equal to 650 MPa, greater than or equal to 450 MPa and less than or equal to 650 MPa, greater than or equal to 475 MPa and less than or equal to 650 MPa, greater than or equal to 500 MPa and less than or equal to 650 MPa, greater than or equal to 525 MPa and less than or equal to 650 MPa, greater than or equal to 550 MPa and less than or equal to 650 MPa, greater than or equal to 575 MPa and less than or equal to 650 MPa, greater than or equal to 600 MPa and less than or equal to 650 MPa, greater than or equal to 625 MPa and less than or equal to 650 MPa, greater than or equal to 200 MPa and less than or equal to 600 MPa, such as greater than or equal to 225 MPa and less than or equal to 600 MPa, greater than or equal to 250 MPa and less than or equal to 600 MPa, greater than or equal to 275 MPa and less than or equal to 600 MPa, greater than or equal to 300 MPa and less than or equal to 600 MPa, greater than or equal to 325 MPa and less than or equal to 600 MPa, greater than or equal to 350 MPa and less than or equal to 600 MPa, greater than or equal to 375 MPa and less than or equal to 600 MPa, greater than or equal to 400 MPa and less than or equal to 600 MPa, greater than or equal to 425 MPa and less than or equal to 600 MPa, greater than or equal to 450 MPa and less than or equal to 600 MPa, greater than or equal to 475 MPa and less than or equal to 600 MPa, greater than or equal to 500 MPa and less than or equal to 600 MPa, greater than or equal to 525 MPa and less than or equal to 600 MPa, greater than or equal to 550 MPa and less than or equal to 600 MPa, greater than or equal to 575 MPa and less than or equal to 600 MPa, greater than or equal to 200 MPa and less than or equal to 550 MPa, such as greater than or equal to 225 MPa and less than or equal to 550 MPa, greater than or equal to 250 MPa and less than or equal to 550 MPa, greater than or equal to 275 MPa and less than or equal to 550 MPa, greater than or equal to 300 MPa and less than or equal to 550 MPa, greater than or equal to 325 MPa and less than or equal to 550 MPa, greater than or equal to 350 MPa and less than or equal to 550 MPa, greater than or equal to 375 MPa and less than or equal to 550 MPa, greater than or equal to 400 MPa and less than or equal to 550 MPa, greater than or equal to 425 MPa and less than or equal to 550 MPa, greater than or equal to 450 MPa and less than or equal to 550 MPa, greater than or equal to 475 MPa and less than or equal to 550 MPa, greater than or equal to 500 MPa and less than or equal to 550 MPa, greater than or equal to 525 MPa and less than or equal to 550 MPa, greater than or equal to 200 MPa and less than or equal to 500 MPa, such as greater than or equal to 225 MPa and less than or equal to 500 MPa, greater than or equal to 250 MPa and less than or equal to 500 MPa, greater than or equal to 275 MPa and less than or equal to 500 MPa, greater than or equal to 300 MPa and less than or equal to 500 MPa, greater than or equal to 325 MPa and less than or equal to 500 MPa, greater than or equal to 350 MPa and less than or equal to 500 MPa, greater than or equal to 375 MPa and less than or equal to 500 MPa, greater than or equal to 400 MPa and less than or equal to 500 MPa, greater than or equal to 425 MPa and less than or equal to 500 MPa, greater than or equal to 450 MPa and less than or equal to 500 MPa, greater than or equal to 475 MPa and less than or equal to 500 MPa, greater than or equal to 200 MPa and less than or equal to 475 MPa, such as greater than or equal to 225 MPa and less than or equal to 475 MPa, greater than or equal to 250 MPa and less than or equal to 475 MPa, greater than or equal to 275 MPa and less than or equal to 475 MPa, greater than or equal to 300 MPa and less than or equal to 475 MPa, greater than or equal to 325 MPa and less than or equal to 475 MPa, greater than or equal to 350 MPa and less than or equal to 475 MPa, greater than or equal to 375 MPa and less than or equal to 475 MPa, greater than or equal to 400 MPa and less than or equal to 475 MPa, greater than or equal to 425 MPa and less than or equal to 475 MPa, greater than or equal to 450 MPa and less than or equal to 475 MPa, greater than or equal to 200 MPa and less than or equal to 450 MPa, such as greater than or equal to 225 MPa and less than or equal to 450 MPa, greater than or equal to 250 MPa and less than or equal to 450 MPa, greater than or equal to 275 MPa and less than or equal to 450 MPa, greater than or equal to 300 MPa and less than or equal to 450 MPa, greater than or equal to 325 MPa and less than or equal to 450 MPa, greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 200 MPa and less than or equal to 425 MPa, such as greater than or equal to 225 MPa and less than or equal to 425 MPa, greater than or equal to 250 MPa and less than or equal to 425 MPa, greater than or equal to 275 MPa and less than or equal to 425 MPa, greater than or equal to 300 MPa and less than or equal to 425 MPa, greater than or equal to 325 MPa and less than or equal to 425 MPa, greater than or equal to 350 MPa and less than or equal to 425 MPa, greater than or equal to 375 MPa and less than or equal to 425 MPa, greater than or equal to 400 MPa and less than or equal to 425 MPa, greater than or equal to 200 MPa and less than or equal to 400 MPa, such as greater than or equal to 225 MPa and less than or equal to 400 MPa, greater than or equal to 250 MPa and less than or equal to 400 MPa, greater than or equal to 275 MPa and less than or equal to 400 MPa, greater than or equal to 300 MPa and less than or equal to 400 MPa, greater than or equal to 325 MPa and less than or equal to 400 MPa, greater than or equal to 350 MPa and less than or equal to 400 MPa, greater than or equal to 375 MPa and less than or equal to 400 MPa, greater than or equal to 200 MPa and less than or equal to 375 MPa, greater than or equal to 225 MPa and less than or equal to 375 MPa, greater than or equal to 250 MPa and less than or equal to 375 MPa, greater than or equal to 275 MPa and less than or equal to 375 MPa, greater than or equal to 300 MPa and less than or equal to 375 MPa, greater than or equal to 325 MPa and less than or equal to 375 MPa, greater than or equal to 350 MPa and less than or equal to 375 MPa, greater than or equal to 200 MPa and less than or equal to 350 MPa, greater than or equal to 225 MPa and less than or equal to 350 MPa, greater than or equal to 250 MPa and less than or equal to 350 MPa, greater than or equal to 275 MPa and less than or equal to 350 MPa, greater than or equal to 300 MPa and less than or equal to 350 MPa, greater than or equal to 325 MPa and less than or equal to 350 MPa, greater than or equal to 200 MPa and less than or equal to 325 MPa, greater than or equal to 225 MPa and less than or equal to 325 MPa, greater than or equal to 250 MPa and less than or equal to 325 MPa, greater than or equal to 275 MPa and less than or equal to 325 MPa, greater than or equal to 300 MPa and less than or equal to 325 MPa, greater than or equal to 200 MPa and less than or equal to 300 MPa, greater than or equal to 225 MPa and less than or equal to 300 MPa, greater than or equal to 250 MPa and less than or equal to 300 MPa, greater than or equal to 275 MPa and less than or equal to 300 MPa, greater than or equal to 200 MPa and less than or equal to 275 MPa, greater than or equal to 225 MPa and less than or equal to 275 MPa, greater than or equal to 250 MPa and less than or equal to 275 MPa, greater than or equal to 200 MPa and less than or equal to 250 MPa, greater than or equal to 225 MPa and less than or equal to 250 MPa, or greater than or equal to 200 MPa and less than or equal to 225 MPa. It should be understood that the above ranges include all subranges within the explicitly disclosed ranges.

In embodiments, the multilayer coating of the article may have a coating compressive stress (CS) of greater than or equal to 200 MPa, greater than or equal to 400 MPa, greater than or equal to 600 MPa, or greater than or equal to 800 MPa. It should be understood that the above ranges include all subranges within the explicitly disclosed ranges.

In embodiments, the article may have an average flexural strength of greater than 600 MPa, or greater than 800 MPa.

In embodiments, the article may exhibit an average strain-to-failure at a surface on one or more opposing major surfaces 112, 114 that is 0.5% or greater, or 0.75% or greater, as measured using an ROR Test using at least 5, at least 10, at least 15, or at least 20 samples to determine the average strain-to-failure value.

In embodiments, the fracture toughness of the non-chemically strengthened glass-ceramic article may be greater than 0.8 MPa m, greater than 1.0 MPa m, greater than 1.2 MPa m, greater than or equal to 1.0 MPa m and less than or equal to 2.0 MPa m, greater than or equal to 1.0 MPa m and less than or equal to 2.0 MPa m, greater than or equal to 1.2 MPa m and less than or equal to 1.8 MPa m, greater than or equal to 1.0 MPa m and less than or equal to 1.8 MPa m, greater than or equal to 1.0 MPa m and less than or equal to 1.6 MPa m, greater than or equal to 1.2 MPa m and less than or equal to 1.6 MPa m, greater than or equal to 1.0 MPa m and less than or equal to 1.5 MPa m, greater than or equal to 1.2 MPa m and less than or equal to 1.5 MPa m, greater than or equal to 1.0 MPa m and less than or equal to 1.4 MPa m, greater than or equal to 1.2 MPa m and less than or equal to 1.4 MPa m, greater than or equal to 1.0 MPa m and less than or equal to 1.3 MPa m, or even greater than or equal to 1.2 MPa m and less than or equal to 1.3 MPa m. It should be understood that the above ranges include all subranges within the explicitly disclosed ranges.

In embodiments, the Young's modulus (also referred to as elastic modulus) of the non-chemically strengthened glass-ceramic article may be greater than 80 GPa, greater than 85 GPa, greater than 90 GPa, or greater than 100 GPa, such as greater than or equal to 80 GPa and less than or equal to 130 GPa, greater than or equal to 90 GPa and less than or equal to 130 GPa, greater than or equal to 100 GPa and less than or equal to 120 GPa. It should be understood that the above ranges include all subranges within the explicitly disclosed ranges.

In embodiments, the Young's modulus (also referred to as elastic modulus) of the multilayer coating of the article may be greater than or equal to about 80 GPa, greater than or equal to about 90 GPa, or greater than or equal to about 100 GPa, such as greater than or equal to or equal to about 80 GPa and less than or equal to or equal to about 130 GPa, greater than or equal to or equal to about 90 GPa and less than or equal to or equal to about 130 GPa, greater than or equal to or equal to about 100 GPa and less than or equal to or equal to about 120 GPa.

It should be understood that the above ranges include all subranges within the explicitly disclosed ranges.

According to embodiments, the glass-ceramic substrate may have a refractive index (measured at wavelengths of 550 nm) that may be greater than or equal to 1.500 and less than or equal to 1.600, greater than or equal to 1.520 and less than or equal to 1.600, greater than or equal to 1.540 and less than or equal to 1.600, greater than or equal to 1.550 and less than or equal to 1.600, greater than or equal to 1.560 and less than or equal to 1.600, greater than or equal to 1.500 and less than or equal to 1.580, greater than or equal to 1.520 and less than or equal to 1.580, greater than or equal to 1.540 and less than or equal to 1.580, greater than or equal to 1.550 and less than or equal to 1.580. It should be understood that the above ranges include all subranges within the explicitly disclosed ranges.

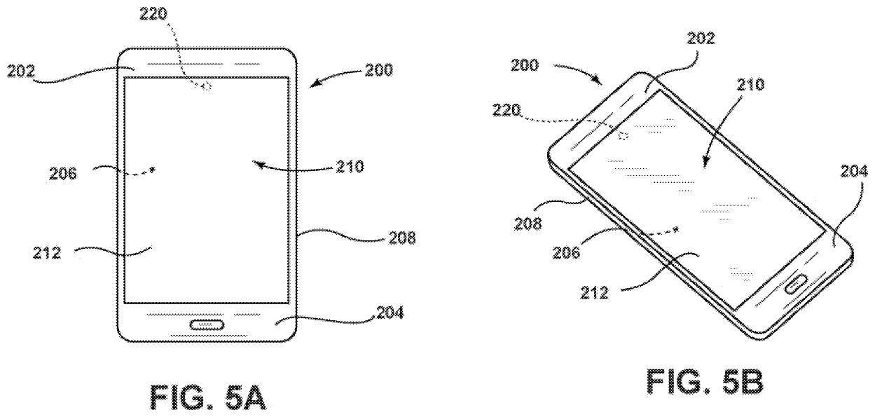

The articles disclosed herein may be incorporated into another article or device such as device with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc. for example for use as an interior display cover, a window, or windshield), appliance articles, or any article that requires some transparency, scratch-resistance, abrasion resistance or a combination thereof. In embodiments, translucent glass-ceramics may be used as enclosures for electronic devices (e.g., consumer electronics, including mobile phones, tablets, computers, navigation systems, wearable devices (e.g., watches) and the like). An exemplary article incorporating any of the strengthened glass-ceramic articles disclosed herein is shown in FIGS. 5A and 5B.

Specifically, FIGS. 5A and 5B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display 210. In some embodiments, at least one of the cover substrate 212 or a portion of the housing 202 (such as the back 206) may include any of the strengthened glass-ceramics disclosed herein.

Additionally, the glass-ceramics disclosed herein can be cerammed into other shapes (i.e., other than a plate or sheet) with minimal deformation, readily machined to precision shapes, cut, drilled, chamfered, tapped, polished to high luster with conventional ceramic machining tooling and even exhibit various degrees of translucency depending on composition and heat treatment. These properties make the glass-ceramics useful for a broad number of applications in addition to those identified herein, including, without limitation, countertops and other surfaces, appliance doors and exteriors, floor tiles, wall panels, ceiling tiles, white boards, materials storage containers (hollowware) such as beverage bottles, food sales and storage vessels, machine parts requiring light weight, good wear resistance and precise dimensions. The glass-ceramics can be formed in three-dimensional articles using various methods due to its lower viscosity.

Throughout the disclosure, “surface-modifying layer” refers to a layer that is characterized by changing a physical property or other behavior of the coated article. For example, a surface-modifying layer can modify one or more of a water contact angle, an oleic contact angle, a visibility of a fingerprint (e.g., simulated fingerprint), and/or an ability to remove a fingerprint (e.g., by wiping). In one or more embodiments, the article 100 depicted in FIG. 1 may include one or more additional top coatings 140 disposed on the outer structure 122 of the optical film structure 120. In one or more embodiments, the additional top coating 140 may include a surface modifying layer such as a fingerprint hiding coating, anti-fingerprint hiding layer or an easy-to-clean coating. Examples of a suitable anti-fingerprint hiding layer and easy-to-clean coatings are described in the following U.S. patent applications: U.S. Patent Application Publication No. 2014/0113083, published on Apr. 24, 2014, entitled “Process for Making of Glass Articles with Optical and Easy-to-Clean Coatings”; U.S. patent application Ser. No. 18/932,938, filed on Oct. 31, 2024, entitled “Coated Articles with a Planarization Layer and a Surface-Modifying Layer and Methods of Making the Same”; U.S. Non-Provisional patent application Ser. No. 18/528,916, filed on Dec. 5, 2023, entitled “Coated Articles with an Anti-Fingerprint Coating or Surface-Modifying Layer and Methods of Making the Same”, and PCT Patent Application No. PCT/US24/57255, filed on Nov. 25, 2024, entitled “Coated Articles with a Surface-Modifying Layer and Methods of Making the Same”, all of which are incorporated herein by reference in their entirety. The easy-to-clean coating can be a fluorine-containing material. Alternatively, the easy-to-clean coating (anti-fingerprint coating) can include a partial silica-like network having a ratio of Si—O—Si bonds to Si atoms in the coating from about 2 to about 3, the coating is fluorine-free, and the coating further comprises an alkyl silane at the exterior surface and bonded to Si—O groups in the anti-fingerprint coating. The easy-to-clean coating may have a thickness in the range from about 5 nm to about 50 nm and may include known materials such as fluorinated or non-fluorinated silanes. The easy-to-clean coating may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating of the top coating 140 may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm, from about 7 nm to about 10 nm, from about 1 nm to about 90 nm, from about 5 nm to about 90 nm, from about 10 nm to about 90 nm, or from about 5 nm to about 100 nm, and all ranges and sub-ranges therebetween.

In aspects, the surface-modifying layer employed as the top coating 140 can be an anti-fingerprint coating. Throughout the disclosure, a surface-modifying layer is an “anti-fingerprint” coating if the coating on a glass-based substrate can reduce the visibility of, reduce a color shift of, and/or reduce droplet formation of fingerprint oil disposed thereon relative to the glass-based substrate without the coating. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the glass-based substrate refers to a difference in measured color as √((a₁*−a₂*)²+(b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. In further aspects, the anti-fingerprint coating can exhibit an (e.g., as-formed) water contact angle from 90° to 120°, an (e.g., as-formed) oleic acid contact angle of 40° or less, and a coefficient of friction of 0.25 or less. In further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 600 to about 80°, from about 620 to about 75°, from about 650 to about 72°, or any range or subrange therebetween. In aspects, an anti-fingerprint coating can be oleophilic. In aspects, a hexadecane contact angle and/or an oleic acid contact angle of an anti-fingerprint coating (e.g., as-formed) can be about 450 or less, about 400 or less, about 300 or less, about 250 or less, about 200 or less, or the anti-fingerprint coating can wet hexadecane and/or oleic acid. In further aspects, the anti-fingerprint coating (e.g., as formed) wets hexadecane and/or oleic acid. Providing a low diiodomethane contact angle (e.g., about 600 or less) and/or a low hexadecane contact angle (e.g., about 300 or less) can reduce the visibility and/or color shift associated with fingerprints by enabling fingerprint oil to be dispersed across the anti-fingerprint coating rather than beading up into pronounced droplets.

In aspects, the surface-modifying layer employed as the top coating 140 can be an easy-to-clean coating. Throughout the disclosure, a surface-modifying layer is an “easy-to-clean” coating if the coating on a glass-based substrate can repel material and/or facilitate removal of material disposed thereon relative to the glass-based substrate without the coating. As used herein, an ability to repel material is determined based on a contact angle with higher contact angles associated with greater repulsion. As used herein, an ability to remove material is measured by wiping the material disposed on the surface (e.g., coating or glass-based substrate) with a cheesecloth and the visibility of the material is monitored. A decreased visibility (e.g., fewer wiping cycles to achieve a predetermined reduction is visibility) is associated with a coating facilitating removal of material disposed thereon. In further aspects, the easy-to-clean coating can exhibit an (e.g., as-formed) water contact angle from 90° to 120°, an (e.g., as-formed) oleic acid contact angle of 500 or more, and a coefficient of friction of 0.25 or less. In further aspects, the easy-to-clean coating can be a fluorine-containing material. Alternatively, in further aspects, the easy-to-clean coating can be substantially free and/or free of fluorine. In aspects, a diiodomethane contact angle of an anti-fingerprint coating (e.g., as-formed) can be about 60° or more, about 62° or more, about 65° or more, about 80° or less, about 75° or less, about 73° or less, or about 70° or less. In aspects, a diiodomethane contact angle of an anti-fingerprint coating (e.g., as-formed) can range from about 60° to about 80°, from about 62° to about 75°, from about 650 to about 72°, or any range or subrange therebetween. In aspects, the anti-fingerprint coating can be oleophilic. In aspects, a hexadecane contact angle of the anti-fingerprint coating (e.g., as-formed) can be about 450 or less, about 400 or less, about 300 or less, about 250 or less, about 200 or less, or the an anti-fingerprint coating can wet hexadecane. In further aspects, the anti-fingerprint coating (e.g., as formed) wets hexadecane. Providing a low diiodomethane contact angle (e.g., about 600 or less) and/or a low hexadecane contact angle (e.g., about 300 or less) can reduce the visibility and/or color shift associated with fingerprints by enabling fingerprint oil to be dispersed across the surface-modifying layer rather than beading up into pronounced droplets.

In aspects, the top coating 140 can comprise one or more surface-modifying layers. Suitable surface-modifying layers may include at least one alkyl silane layer. The at least one alkyl silane layer could be bonded directly to the capping layer 131, e.g., at the outer surface 122 of the optical film structure 120 of the article 100 (see FIG. 1). In some embodiments, a surface-modifying layer of the top coating 140 can be bonded to an underlying layer of the top coating 140. The at least one alkyl silane may include one or more bipodal alkyl silanes, such as 1,8-bis(chlorodimethylsilyl) octane, 1,6-bis(trichlorosilyl) hexane, bis(triethoxysilyl) methane, 1,2-bis(triethoxysilyl) ethane, 1,6-bis(trimethoxysilyl) hexane, 1,8-bis(triethoxysilyl) octane, 1,8-bis(trimethoxysilyl) octane, or combinations thereof in addition to one or more monopodal alkyl silanes, such as octadecyl trimethoxysilane (OTS), dodecyl trimethoxysilane, or combinations thereof. In an implementation, the surface-modifying layers may include an OTS layer, as bonded to an underlying layer of the top coating 140.

In aspects, the top coating 140 can comprise one or more planarization layers. Suitable planarization layers of the top coating 140 can comprise a silica-like structure, e.g., as derived from a functionalized octa-isobutyl polyhedral oligomeric silsesquioxane (OB-PSS), that is bonded directly to the capping layer 131, e.g., at the outer surface 122 of the optical film structure 120 of the article 100 (see FIGS. 2A and 2B) or to a layer of the top coating 140. As used herein, a polyhedral oligomeric silsesquioxane (PSS) refers to a functionalized oligomer silsesquioxane consisting of RSiO_{1.5} monomers. Exemplary aspects of functionalized PSS can comprise 6, 8, 10, or 12 RSiO_{1.5} monomers, although other aspects are possible. For example, functionalized oligomeric silsesquioxane consisting of 8 RSiO_{1.5} monomers is an octahedral functionalized POSS (e.g., polyoctahedral silsesquioxane).

In addition, the one or more planarization layers employed in the top coating 140 can serve to provide a decreased surface roughness (Rₐ) relative to what would be obtained in an article 100 without the planarization layer, which enables the transparent article including the planarization layer to benefit from the increased abrasion resistance of a surface-modifying layer (see above, e.g., OTS layer). In aspects, the planarization layer can provide a reduced surface roughness relative to a surface roughness of an underlying layer, as a ratio of the surface roughness (Rₐ) of the planarization layer to the surface roughness (Rₐ) of its underlying layer (e.g., the capping layer 131), can be 0.9 or less (e.g., from 0.1 to 0.9, from 0.2 to 0.8, or from 0.3 to 0.7). In embodiments, the planarization layer can exhibit a surface roughness (Rₐ) of from 0.1 nm to 4 nm, 0.1 nm to 3 nm, 0.1 nm to 2 nm, and all surface roughness values between the foregoing.

Referring again to the one or more planarization layers that can be employed in the top coating 140, these layer(s) can be readily distinguished from other silicon-containing oxides (e.g., a capping layer 131 comprising silica or the glass-ceramic substrate 110) by the properties discussed herein (e.g., hydroxyl content, hardness, refractive index, power spectral density of the surface, surface roughness (R), molar ratio of hydrogen to silica). For example, the planarization layer can comprise a greater hydroxyl content than a hydroxyl content of the capping layer 131; the planarization layer can exhibit a lower hardness, lower elastic modulus, and/or higher refractive index than the corresponding property of the capping layer 131; and/or a surface roughness (Rₐ) of the planarization layer can be less than a surface roughness (Rₐ) of the capping layer 131. Additionally, for example, the planarization layer can comprise a greater molar ratio of hydrogen to silica than a molar ratio of hydrogen to silica of the glass-ceramic substrate 110. In some implementations, the molar ratio of hydrogen to silica in the planarization layer is about 0.2 or more, 0.2 to 0.4, 0.22 to 0.35, or any molar ratio values in the foregoing ranges.

Throughout the disclosure, the “molar ratio” refers to a molar ratio of hydrogen to silicon (i.e., a molar amount of hydrogen divided by a molar amount of silicon) as determined by SIMS analysis of a material (e.g., planarization layer of the top coating 140). Without wishing to be bound by theory, it is believed that hydrogen is indicative of hydroxyl groups (e.g., silanol, Si—O—H). In aspects, a molar ratio (of hydrogen to silicon) can be about 0.2 or more (e.g., about 0.2 or more), about 0.21 or more, about 0.22 or more, about 0.23 or more, about 0.24 or more, about 0.25 or more, about 0.45 or less, about 0.4 or less, about 0.37 or less, about 0.35 or less, about 0.32 or less, about 0.30 or less, or about 0.28 or less. In aspects, a molar ratio (of hydrogen to silicon) can be in a range from about 0.2 to about 0.45, from about 0.20 to about 0.4 (e.g., from about 0.2 to about 0.4), from about 0.21 to about 0.37, from about 0.22 to about 0.35, from about 0.23 to about 0.32, from about 0.24 to about 0.32, from about 0.24 to about 0.30, from about 0.25 to about 0.28, or any range or subrange therebetween. In exemplary aspects, the molar ratio of hydrogen to silicon can be in a range from 0.20 to 0.4 or from about 0.22 to about 0.35. For example, the planarization layer(s) of the top coating 140 in accordance with aspects of the present disclosure exhibits a molar ratio of hydrogen to silicon of 0.20 or more, from about 0.20 to 0.4, or from about 0.22 to about 0.35. In contrast, conventional methods of silica deposition have a molar ratio of about 0.10 or less. In aspects, the molar ratio at the surface of the planarization layer(s) can be within any of the ranges recited above in this paragraph. In aspects, the molar ratio (of hydrogen to silicon) of the planarization layer of the top coating 140 can be greater than the molar ratio of a reactively sputtered silica layer by a multiple of 2 or more, 2.5 or more, 3 or more, 4 or more, 10 or less, 7 or less, 5 or less, or 4 or less. In aspects, the molar ratio (of hydrogen to silicon) of the planarization layer can be greater than the molar ratio of a reactively sputtered silica layer by a multiple in a range from about 2 to 10, from 2 to 7, from 2.5 to 5, from 2.5 to 4, from 3 to 4, or any range or subrange therebetween. In aspects, an ion intensity of carbon (as a ratio to the ion intensity of silicon) can be about 0.01 or less, about 0.005 or less, about 0.002 or less, or about 0.001 or less, for example, in a range from about 0.00001 to about 0.01, from about 0.00005 to about 0.005, from about 0.0001 to about 0.002, from about 0.0005 to about 0.001, or any range or subrange therebetween. The intensity of carbon is based on measurements that are corrected to remove background signals (as determined from the intensity of carbon measured from fused quartz).

Further, functionalized oligomeric silsesquioxanes of the one or more planarization layers can be functionalized by one or more functional groups. A functional group functionalizing the functionalized oligomeric silsesquioxane can exclude hydrogen. In aspects, the functional group functionalizing the functionalized oligomeric silsesquioxane can exclude bisphenols, fluorine-containing functional groups isocyanates, epoxies, glycidyls, oxirane, sulfur-containing functional groups (e.g., thiols), anhydrides, acrylates, methacrylates, and/or alkynes. In aspects, the functional group functionalizing the functionalized oligomeric silsesquioxane can be an alkyl group, an alkene group, an aromatic group (e.g., a phenyl group), a silane (e.g., alkyl silyl group), or combinations thereof. As used herein, an alkyl group contains a saturated hydrocarbon with carbon-carbon single bonds and hydrogen bonded to carbon atoms. In aspects, alkyl functional groups can range from 1 to 10 carbons (i.e., C₁-C₁₀ alkyl), for example, from 1 to 8 carbons (i.e., C₁-C₅ alkyl) or from 1 to 4 carbons (i.e., C₁-C₄ alkyl). Exemplary aspects of alkyl functional groups include methyl and isobutyl. An exemplary aspect of an aromatic functional group is a phenyl group. An exemplary aspect of a silane includes a dimethylsilyl group. As used herein, an alkene group contains an unsaturated hydrocarbon with one or more carbon-carbon double bonds. Alkenes can optionally include one or more carbon-carbon single bonds (e.g., alkyl chains in the alkene group). In even further aspects, the functionalized POSS can be at least partially functionalized by alkenes containing from 2 to 8 carbons (i.e., C₂-C₈ alkenes). An exemplary aspect of an alkene functionalized PSS is a vinyl PSS, for example, partially vinyl functionalized vinyl/isobutyl PSS (OL1123 available from Hybrid Plastics) or octa-vinyl PSS (OL1170 available from Hybrid Plastics). An exemplary aspect of an aromatic functionalized PSS is octaphenyl PSS (MS0840 available from Hybrid Plastics). Exemplary aspects of alkyl functionalized PSS are octamethyl PSS (MS0830 available from Hybrid Plastics) and OB-PSS (MS0825 available from Hybrid Plastics).

According to an embodiment, a top coating 140 comprising a planarization layer, e.g., a layer that comprises a silica-like structure (e.g., as derived from a functionalized octa-isobutyl polyhedral oligomeric silsesquioxane (OB-PSS) or a polyhedral oligomeric silsesquioxane (PSS)), can be subjected to an ion beam treatment. In particular, properties of the planarization layer can be controlled by the discharge current of the ion beam. For a KRI EH-400 End-Hall ion source in a Angstrom Evovac chamber operating at 100V, providing a discharge current of about 0.25 A or more can facilitate the formation of the coating, for example, producing an ion beam with sufficient energy to cause the functionalized PSS to react with other functionalized PSS and/or the first major surface 112 of the glass-ceramic substrate 110 at an appreciable rate (e.g., compared to lower discharge currents). Providing a discharge current of about 1 A or less to the ion beam source facilitates deposition of a condensed PSS material. The ion beam discharge can facilitate condensation of the functionalized PSS converting at least a portion of the cage structure of the functionalized PSS to a silica or a partial Si—O—Si—O network (e.g., of the underlying capping layer 131 comprising SiO₂). Functionalized PSS is evaporated and subjected to ion beam to create a silica or a partially condensed silica-like network at or near room temperature. Alternatively, the substrate that the thermally evaporated functionalized PSS condenses on and the ion beam impinges can be heated. Substrate temperature during PSS deposition is 250 °C or less, 200 °C or less, 100 °C or less, or preferably 50 °C or less.

According to an implementation of the article 100, the top coating 140 can include at least one surface-modifying layer, e.g., OTS, and at least one planarization layer, e.g., a layer comprising a silica-like structure derived from OB-PSS. From an optical standpoint, each of the OTS- and OB-PSS-containing layers has a refractive index that is substantially similar to that of the low RI material used in the capping layer 131, e.g., SiO₂. In embodiments, each of the OTS and OB-PSS-containing layers has a physical thickness that ranges from 1 nm to 60 nm, 1 nm to 50 nm, 5 nm to 50 nm, and all physical thickness values between the foregoing ranges. In embodiments, the OTS layer of the top coating 140 has a physical thickness that ranges from 1 nm to 10 nm or 2 nm to 10 nm, e.g., 1 nm, 1.5 nm, 2 nm, 2.5 nm, 3 nm, 4 nm, 5 nm, 6 nm, 7 nm, 8 nm, 9 nm, 10 nm, and all thickness values between the foregoing. In embodiments, the OB-PSS layer of the top coating 140 has a physical thickness that ranges from 5 nm to 60 nm, 10 nm to 60 nm, 10 nm to 50 nm or 15 nm to 50 nm, e.g., 10 nm, 12.5 nm, 15 nm, 17.5 nm, 20 nm, 25 nm, 30 nm, 35 nm, 40 nm, 45 nm, 50 nm, and all thickness values between the foregoing. In some embodiments, the physical thicknesses of the capping layer 131, as comprising SiO₂, and OB-PSS-containing layer can be balanced and adjusted to maintain desired optical properties and adjust mechanical properties of the optical film structure 120, recognizing that the OB-PSS-containing layer and capping layer 131 have the same refractive index values. For example, in an embodiment, the capping layer 131 has a physical thickness of 16 nm and the OB-PSS-containing layer has a physical thickness of 38 nm, whereas in another embodiment the capping layer 131 is thicker with a physical thickness of 34 nm and the OB-PSS-containing layer is thinner with a physical thickness of 20.0 nm.

As used herein, the term “glass” refers to solids prior to exposure to a controlled nucleation heat treatment and prior to exposure to a growth stage. The glass is amorphous (i.e., the sum of all crystalline phases in the glass may be less than 1 wt % of the glass as measured at 20 °C). The crystallinity of the glass may be determined by X-ray diffraction (XRD) using the Rietveld method.

As used herein, the term “glass-ceramic” refers to an inorganic material comprised of amorphous and crystalline phases.

As used herein, “depth of compression” or “DOC” refers to the depth of a compressive stress (CS) layer and is the depth at which the stress within a glass-ceramic article changes from compressive stress to tensile stress and has a stress value of zero. According to the convention normally used in the art, compressive stress is expressed as a negative (<0) stress and tensile stress is expressed as a positive (>0) stress. Throughout this description, however, and unless otherwise noted, CS is expressed as a positive or absolute value—that is, as recited herein, CS=|CS|.

The compressive stress (CS) and depth of compression (DOC) values are measured using a hybrid method that combines measurements made using evanescent prism coupling spectroscopy (EPCS) and light scattering polarimetry (LSP) as disclosed in U.S. Patent Application Publication No. 2020/0300615, which is incorporated herein by reference in its entirety. The maximum central tension (mCT) values are measured using a scattered light polariscope (SCALP) technique known in the art.

Young's modulus (elastic modulus) is measured by a resonant ultrasonic spectroscopy technique of the general type set forth in ASTM E2001-13 (2018).

Haze of a glass-ceramic article is measured using a haze meter, such as the BYK Gardner Haze-Gard I, following ASTM D1003-21 (2021) or ASTM D1044-19 (2019) on optically polished glass-ceramic plates with plane parallel faces.

Optical transmission (also referred to herein as “transmittance”) is measured in the 400-1000 nm range on optically polished samples with plane parallel faces using a Perkin Elmer Lambda 950 spectrophotometer with a data interval of 2 nm. The transmission may be measured on the glass-ceramic article itself without any coatings or other applications, or, alternatively, with coating disposed thereon.

X-ray diffraction (XRD) is conducted on powdered samples using a Bruker D4 Endeavor equipped with Cu radiation and a LynxEye detector. The phase assemblage of the sample is determined using the Rietveld method and using Bruker's Topas software package.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between material and the surface. The intervening material(s) may constitute a layer, as defined herein.

As used herein, the terms “low RI layer”, “medium RI layer” and “high RI layer” refer to the relative values of the refractive index (“RI”) of layers of an optical film structure 120 of a transparent article 100 according to the disclosure. Hence, the RI of the low RI layer<the RI of the medium RI layer<the RI of the high RI layer, unless otherwise expressly noted in this disclosure. Accordingly, low RI layers have refractive index values that are less than the refractive index values of medium and high RI layers.

As used herein, the term “interference layer” refers to a layer that is adjacent to one or more layers having a different refractive index, where the thickness of the layer multiplied by its refractive index is less than about 10× of an operating wavelength of interest. The interference lay may be, for example, less than about 5 microns, less than about 1 micron, or less than about 0.5 microns in physical thickness, when the operating wavelengths of interest includes the visible range from about 0.4 to 0.7 microns.

As used herein, the term “strengthened substrate” refers to a substrate employed in an article of the disclosure that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of a single optical film structure or the outer optical film structure of a transparent article of the disclosure with the diamond Berkovich indenter to form an indent to an indentation depth in the range from about 50 nm to about 1000 nm (or the entire thickness of the outer or inner optical film structure, whichever is less) and measuring the maximum hardness from this indentation along the entire indentation depth range or a segment of this indentation depth (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

As used herein, the term “transmittance” is defined as the percentage of incident optical power within a given wavelength range transmitted through a material (e.g., the article, the substrate or the optical film or portions thereof). The term “reflectance” is similarly defined as the percentage of incident optical power within a given wavelength range that is reflected from a material (e.g., the article, the substrate, or the optical film or portions thereof). Transmittance and reflectance are measured using a specific linewidth. As used herein, an “average transmittance” refers to the average amount of incident optical power transmitted through a material over a defined wavelength regime. As used herein, an “average reflectance” refers to the average amount of incident optical power reflected by the material.

As used herein, “photopic reflectance” mimics the response of the human eye by weighting the reflectance or transmittance, respectively, versus wavelength spectrum according to the human eye's sensitivity. Photopic reflectance may also be defined as the luminance, or tristimulus Y value of reflected light, according to known conventions such as CIE color space conventions. The “average photopic reflectance”, as used herein, for a wavelength range from 380 nm to 720 nm is defined in the below equation as the spectral reflectance, R(λ) multiplied by the illuminant spectrum, I(λ) and the CIE's color matching function y̅(λ), related to the eye's spectral response:

$$〈 {R}_{p} 〉 = {\int }_{380 nm}^{720 nm} R ( λ ) \times I ( λ ) \times \overline{y} ( λ ) d λ$$

In addition, “photopic average reflectance” can be determined over the visible spectrum, or over other wavelength ranges, according to measurement principles understood by those skilled in the field of the disclosure, e.g., in the infrared spectrum from 840 nm to 950 nm, etc. Unless otherwise noted, all reflectance values reported or otherwise referenced in this disclosure are associated with testing through, and detecting reflections from, both primary surfaces of the substrate and optical film structure(s) of the transparent articles of the disclosure, e.g., a “two-surface” average photopic reflectance. In cases where “one-surface” or “first-surface” reflectance is specified, the reflectance from the rear surface of the article is eliminated through optical bonding to a light absorber, allowing the reflectance of only the first surface to be measured. As used herein, two-surface reflectance refers to total reflectance, including both specular and diffuse components.

As used herein, “photopic transmittance” is defined in the below equation as the spectral transmittance, T(λ) multiplied by the illuminant spectrum, I(λ) and the CIE's color matching function y̅(λ), related to the eye's spectral response:

$$〈 {T}_{p} 〉 = {\int }_{380 nm}^{720 nm} T ( λ ) \times I ( λ ) \times \overline{y} ( λ ) d λ$$

In addition, “photopic average transmittance” can be determined over the visible spectrum or other wavelength ranges, according to measurement principles understood by those skilled in the field of the disclosure, e.g., in the infrared spectrum from 840 nm to 950 nm, etc. Unless otherwise noted, all transmittance values reported or otherwise referenced in this disclosure and claims are associated with testing through both primary surfaces of the substrate and the optical film structure (e.g., the glass-ceramic substrate 110, major surfaces 112, 114, and optical film structure 120 as shown in FIG. 1 and described below) of the transparent articles, e.g., a “two-surface” average photopic transmittance.

As used herein, “transmitted color” and “reflected color” refer to the color transmitted or reflected through the transparent articles of the disclosure with regard to color in the CIE L*, a*, b* colorimetry system under a D65 illuminant. More specifically, the “color shift” (i.e., as measured in transmission or reflectance) is given by √(a*²+b*²), as these color coordinates are measured through transmission or reflectance of a D65 illuminant through the major surfaces of the substrate of the transparent article (e.g., the glass-ceramic substrate 110, major surfaces 112, 114, and optical film structure 120 as shown in FIG. 1 and described below) over a normal incident angle range, e.g., from 0 degrees to 10 degrees.

As used herein, the term “average flexural strength” is intended to refer to the flexural strength of a glass-containing material (e.g., an article and/or a glass substrate), as tested through methods such as ring-on-ring, ball-on-ring, or ball drop testing. As used herein, a “Ring-on-Ring Test” refers to a test conducted with failure load being correlated to stress in the glass of a glass wafer being tested, and finite element analysis (FEA) is used to convert load to stress, to present a more accurate representation of Ring-on-Ring Test behavior than beam theory. An equibiaxial flexure test (ROR Test) can be conducted with a displacement rate of 1.2 mm/min at 23 °C and 50% room humidity with a load ring diameter as 25.4 mm and support ring diameter of 12.7 mm, as described in ASTM C1499-23. Failure load measured in the equibiaxial flexure test (ROR Test) correlates to stress in the substrate of the transparent article being tested. However, without being bound by theory, it is believed that the use of a numerical model such as finite element model to convert failure load to failure stress presents a more accurate representation of an equibiaxial flexure test (ROR Test) than simply assuming beam (linear) bending theory that further disregards the geometric non-linearity to evaluate stress, particularly for thin articles, e.g. with thickness less than 1.0 mm or less than 0.6 mm. ASTM C1499-23 stipulates the use of an equibiaxial flexure test (ROR Test) only up to the regime of linear bending behavior, disregarding the geometric non-linearity. Consequently, a finite element (FE) model was built using commercially available software, ABAQUS, in standard explicit mode. The FE model of the equibixial flexure test (ROR Test) was setup as axisymmetric including geometric non-linearity while neglecting material non-linearity. The shell planar elements were chosen with a solid homogeneous section. The contact between the material being tested and the rings were defined as frictionless while the normal contact was defined as hard contact. The elastic properties of the material being tested and the rings used were also defined. As the displacement is applied to the load ring to simulate the test up to a maximum value, the reaction loads on the ring along with the maximum radial stress on the tension side surface of the plate/sheet/wafer being tested is in the vicinity directly below the load ring is tabulated. These converted failure stress values align with results (stress) that may be measured through other physical experiments conducted on the samples using a strain gauge or using other optical techniques such as digital image correlation (DIC). Further, the finite element analysis and correction may be validated using strain gauge measurements (or other empirical measurements). Alternatively strain gauge measurements may directly be used for stress and strain data (e.g., failure strain) if such numerical modeling does not align with empirical results. Further details of the Ring-on-Ring test and finite element analysis methods are described in U.S. Provisional Patent Application No. 63/730,114, filed Dec. 10, 2024, the salient contents of which is hereby incorporated by reference in this disclosure in its entirety.

The term “strain-to-failure” refers to the strain at which cracks propagate in the outer or inner structures 130a, 130b of the optical film structure 120, substrate 110, or both simultaneously without application of additional load, typically leading to catastrophic failure in a given material, layer or film and perhaps even bridge to another material, layer, or film, as defined herein. That is, breakage of the optical film structure 120 (i.e., as including outer and/or inner structures 130a, 130b) without breakage of the substrate 110 constitutes failure, and breakage of the substrate 110 also constitutes failure. The term “average” when used in connection with average strain-to-failure or any other property is based on the mathematical average of measurements of such property on 5 samples. Typically, crack onset strain measurements are repeatable under normal laboratory conditions, and the standard deviation of crack onset strain measured in multiple samples may be as little as 0.01% of observed strain. Average strain-to-failure as used herein was measured using an ROR Test. However, unless stated otherwise, strain-to-failure measurements described herein refer to measurements from the ring-on-ring testing, as described in International Publication No. WO2018/125676, published on Jul. 5, 2018, entitled “Coated Articles with Optical Coatings Having Residual Compressive Stress,” and incorporated herein by reference in its entirety.

The terms “free” and “substantially free,” when used to describe the concentration and/or absence of a particular constituent component in an article, a glass-ceramic substrate, or a coating, means that the constituent component is not intentionally added to the article, glass-ceramic substrate, or coating. However, the article, glass-ceramic, or coating may contain traces of the constituent component as a contaminant or tramp in amounts of less than 0.01 wt %.

Ranges can be expressed herein as from “less than or equal to” one particular value, and/or to “less than or equal to” another particular value. When such a range is expressed, another embodiment includes from the one particular value and/or to the other particular value. Similarly, when values are expressed as approximations, by use of the antecedent “less than or equal to,” it will be understood that the particular value forms another embodiment. It will be further understood that the endpoints of each of the ranges are significant both in relation to the other endpoint, and independently of the other endpoint. Any ranges used herein include all ranges and subranges and any values there between unless explicitly stated otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

### EXAMPLES

The embodiments described herein will be further clarified by the following examples.

The examples are based upon optical models utilizing transfer matrix optical modelling. The optical models used input refractive index (n and k) values in the tables below measured from thin films fabricated using reactive or metal-mode reactive sputtering, with the optical properties of the films measured using spectroscopic ellipsometry.

The examples were modeled based upon a glass-ceramic substrate having a main crystalline phase of lithium disilicate, Li₂O·2SiO₂, an orthorhombic crystal based on corrugated sheets of [Si₂O₅]tetrahedral arrays. The crystals are typically tabular or lath-like in shape, with pronounced cleavage planes.

The glass-ceramic substrate used in Comparative Example 1 and Examples 1-6 was according to the composition of glass-ceramic GC1 disclosed in Table 1 above. GC1 was creamed to a high fracture toughness value of about 1.35 MPa m^{1/2} and had a transmission haze value of about 0.21%. The glass-ceramic substrate had a thickness of 0.60 mm. Composition, phase assemblage and properties of the glass-ceramic substrate modelled in each of the examples are provided in Table 1 above.

The glass-ceramic substrate used in Comparative Example 7 and Example 7 was according to the composition of glass-ceramic GC2 disclosed in Table 2 above. GC2 was creamed to a high fracture toughness value of about 1.16 MPa m^{1/2} and had a transmission haze value of about 0.12%. The glass-ceramic substrate had a thickness of 0.60 mm. Composition, phase assemblage and properties of the glass-ceramic substrate modelled in each of the examples are listed in Table 2 above.

The glass-ceramic substrate used in Comparative Example 8 and Example 8 was according to the composition of glass-ceramic GC3 disclosed in Table 3 above. GC3 was creamed to a high fracture toughness value of about 1.18 MPa m^{1/2} and had a transmission haze value of about 0.13%. The glass-ceramic substrate had a thickness of 0.60 mm. Composition, phase assemblage and properties of the glass-ceramic substrate modelled in each of the examples are listed in Table 2 above.

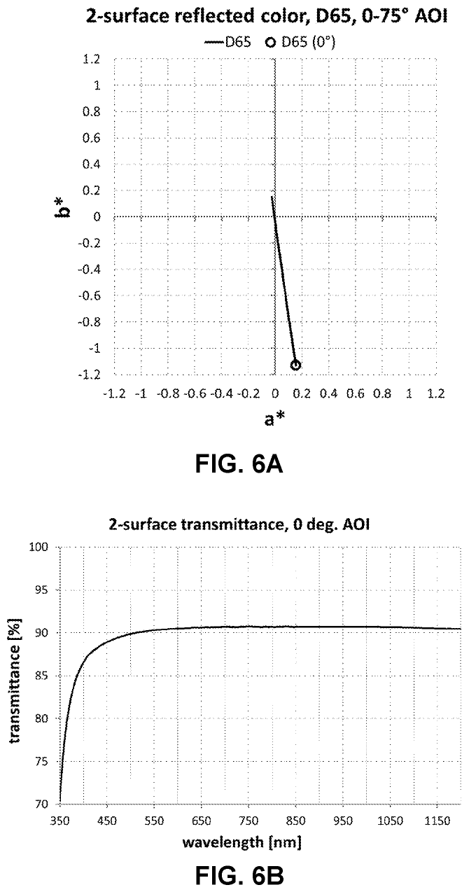

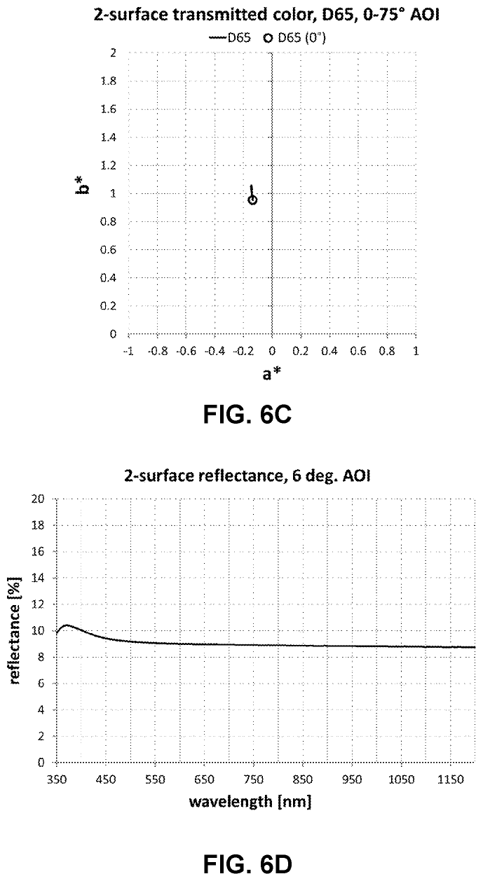

Comparative example 1: According to this comparative example, the GC1 substrate in an uncoated state had its optical properties modeled based on measurements of reflectance, transmittance, and spectroscopic ellipsometry. The modeled first-surface photopic average reflectance (Y) of the uncoated glass-ceramic substrate was 4.8% at near-normal angles of incidence (AOI=0-10 degrees). As shown in FIG. 6A, the modeled two-surface reflected color showed an undesirable scattering induced color, with b* being as low as −1.1 at near-normal incidence. The two-surface transmittance modeled at an angle of incidence of 0-degrees is provided in FIG. 6B, the two-surface transmitted color modeled at all angles of incidence from 0 to 75-degrees is provided in FIG. 6C, and the two-surface reflectance modeled at 6-degrees angle of incidence is provided in FIG. 6D.

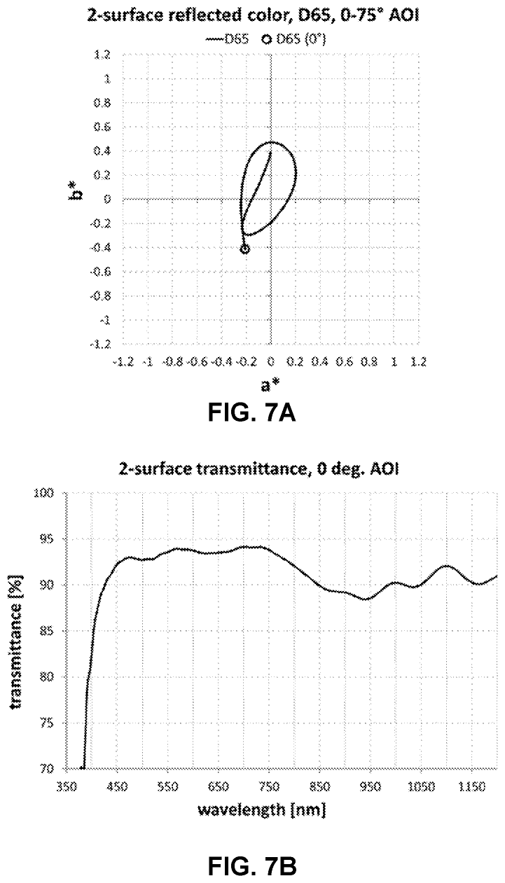

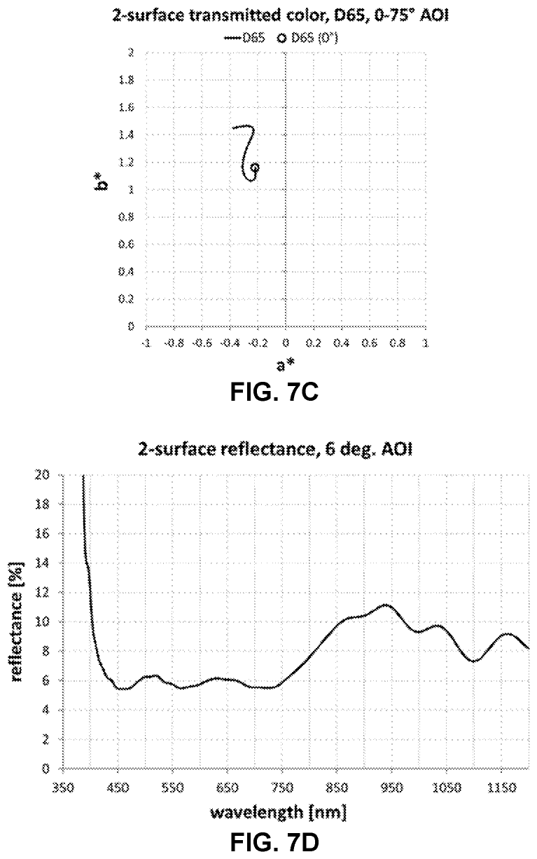

Example 1: According to this example, the GC1 substrate was coated with an anti-reflective, multilayer coating, according to the table below. This coating includes medium-index SiOₓN_{y} layers in the anti-reflective coating stack (e.g. layers 3, 5, and 7) to improve the near-surface hardness of the coated article. The thick scratch resistant layers (e.g. layers 2 and 10) impart high hardness to the article. The design allows layer 10 to have its thickness adjusted within a range of about 200 nm to 5000 nm without significantly altering the optics of the coated article. The coated article had a modeled first-surface photopic average reflectance (Y) of 1.23-1.25% at near-normal angles of incidence (AOI=0-10 degrees). As shown in FIG. 7A, the coated article had a modeled two-surface reflected color that was well controlled and near neutral, staying between −0.25<a*<0.25 and −0.5<b*<0.5 over the entire AOI range from 0-75 degrees. The two-surface transmittance modeled at an angle of incidence of 0-degrees is provided in FIG. 7B, the two-surface transmitted color modeled at all angles of incidence from 0 to 75-degrees is provided in FIG. 7C, and the two-surface reflectance modeled at 6-degrees angle of incidence is provided in FIG. 7D.

| | | | Physical |
|---|---|---|---|
| | | Refractive Index | Thickness |
| Layer | Material | @550 nm | (nm) |
| | Air | 1 | |
| 1 | SiO2 | 1.467 | 85.2 |
| 2 | SiNx | 2.058 | 169.1 |
| 3 | SiOxNy | 1.589 | 40.5 |
| 4 | SiNx | 2.058 | 30.4 |
| 5 | SiOxNy | 1.589 | 71.8 |
| 6 | SiNx | 2.058 | 8.4 |
| 7 | SiOxNy | 1.589 | 107.7 |
| 8 | SiNx | 2.058 | 16.1 |
| 9 | SiOxNy | 1.589 | 36.8 |
| 10 | SiOxNy | 1.949 | 2000.0 |
| 11 | SiO2 | 1.468 | 9.4 |
| 12 | SiOxNy | 1.996 | 45.6 |
| 13 | SiO2 | 1.468 | 28.3 |
| 14 | SiOxNy | 1.996 | 35.7 |
| 15 | SiO2 | 1.468 | 49.1 |
| 16 | SiOxNy | 1.996 | 21.8 |
| 17 | SiO2 | 1.468 | 60.2 |
| 18 | SiOxNy | 1.996 | 11.6 |
| 19 | SiO2 | 1.468 | 25.5 |
| Substrate | GC1 | 1.560 | 0.6 mm |
| | Air | 1 | |

| | |
|---|---|
| Total Coating Thickness | 2853.1 |

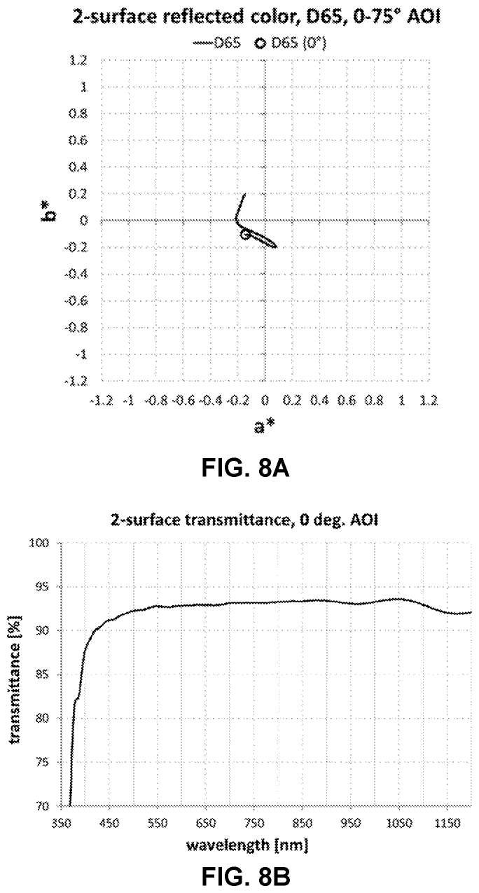

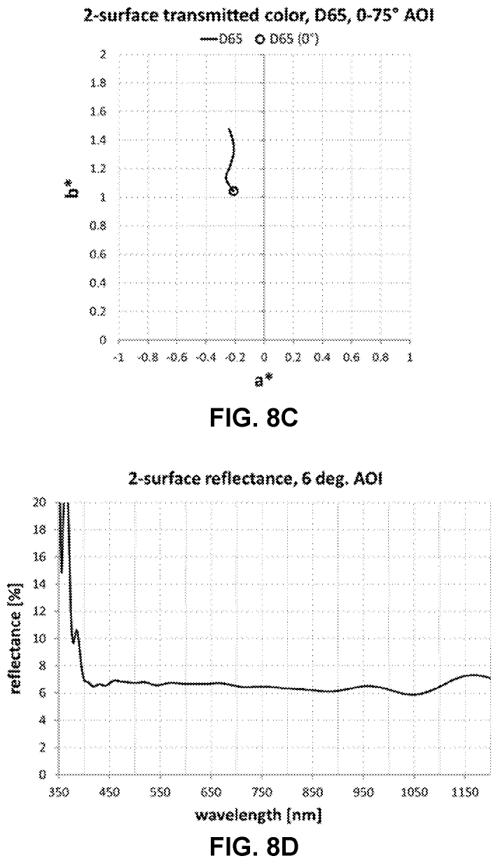

Example 2: According to this example, the GC1 substrate was coated with an anti-reflective, multilayer coating, according to the table below. This coating includes medium-index SiOₓN_{y} layers in the anti-reflective stack (e.g. layers 3, 5, and 7) to improve the near-surface hardness of the coated article. The thick scratch resistant layers (e.g. layer 8) impart high hardness to the article. The design allows layer 8 to have its thickness adjusted within a range of about 200 nm to 5000 nm without significantly altering the optics of the coated article. The coated article had a modeled first-surface photopic average reflectance (Y) of 2.2% at near-normal angles of incidence (AOI=0-10 degrees). As shown in FIG. 8A, the coated article had a modeled two-surface reflected color that was well controlled and near neutral, staying between −0.25<a*<0.25 and −0.25<b*<0.25 over the entire AOI range from 0-75 degrees. The two-surface transmittance modeled at an angle of incidence of 0-degrees is provided in FIG. 8B, the two-surface transmitted color modeled at all angles of incidence from 0 to 75-degrees is provided in FIG. 8C, and the two-surface reflectance modeled at 6-degrees angle of incidence is provided in FIG. 8D.

| | | | Physical |
|---|---|---|---|
| | | Refractive Index | Thickness |
| Layer | Material | @550 nm | (nm) |
| | Air | 1 | |
| 1 | SiO2 | 1.467 | 129.8 |
| 2 | SiNx | 2.058 | 19.4 |
| 3 | SiOxNy | 1.589 | 55.0 |
| 4 | SiNx | 2.058 | 40.7 |
| 5 | SiOxNy | 1.589 | 27.8 |
| 6 | SiNx | 2.058 | 43.6 |
| 7 | SiOxNy | 1.589 | 9.9 |
| 8 | SiOxNy | 1.949 | 1000.0 |
| 9 | SiO2 | 1.468 | 9.4 |
| 10 | SiOxNy | 1.996 | 45.6 |
| 11 | SiO2 | 1.468 | 28.3 |
| 12 | SiOxNy | 1.996 | 35.7 |
| 13 | SiO2 | 1.468 | 49.1 |
| 14 | SiOxNy | 1.996 | 21.8 |
| 15 | SiO2 | 1.468 | 60.2 |
| 16 | SiOxNy | 1.996 | 11.6 |
| 17 | SiO2 | 1.468 | 25.5 |
| Substrate | GC1 | 1.560 | 0.6 mm |
| | Air | 1 | |

| | |
|---|---|
| Total Coating Thickness | 1613.4 |

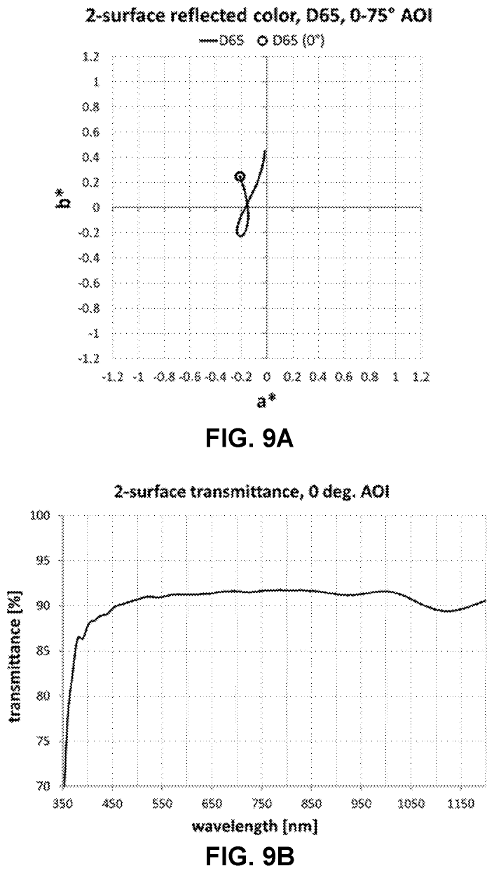

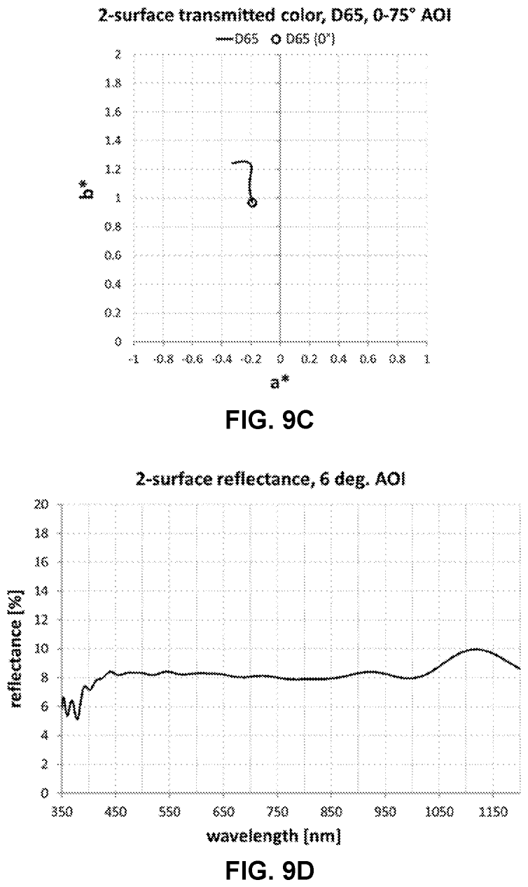

Example 3: According to this example, the GC1 substrate was coated with an anti-reflective, multilayer coating, according to the table below. This coating includes medium-index SiOₓN_{y} layers in the anti-reflective stack (e.g. layers 2, 4, and 6) to improve the near-surface hardness of the coated article. The thick scratch resistant layers (e.g. layer 8) imparts high hardness to the article. The design allows layer 8 to have its thickness adjusted within a range of e.g., 200 nm to 5000 nm without significantly altering the optics of the coated article. The coated article had a modeled first-surface photopic average reflectance (Y) of 3.9% at near-normal angles of incidence (AOI=0-10 degrees). As shown in FIG. 9A, the coated article had a modeled two-surface reflected color that was well controlled and near neutral, staying between −0.25<a*<0 and −0.25<b*<0.5 over the entire AOI range from 0-75 degrees. The two-surface transmittance modeled at an angle of incidence of 0-degrees is provided in FIG. 9B, the two-surface transmitted color modeled at all angles of incidence from 0 to 75-degrees is provided in FIG. 9C, and the two-surface reflectance modeled at 6-degrees angle of incidence is provided in FIG. 9D.

| | | | Physical |
|---|---|---|---|
| | | Refractive Index | Thickness |
| Layer | Material | @550 nm | (nm) |
| | Air | 1 | |
| 1 | SiO2 | 1.467 | 14.0 |
| 2 | SiOxNy | 1.589 | 73.7 |
| 3 | SiNx | 2.058 | 26.4 |
| 4 | SiOxNy | 1.589 | 31.8 |
| 5 | SiNx | 2.058 | 52.5 |
| 6 | SiOxNy | 1.589 | 14.5 |
| 7 | SiNx | 2.058 | 30.0 |
| 8 | SiOxNy | 1.949 | 1000.0 |
| 9 | SiO2 | 1.468 | 9.4 |
| 10 | SiOxNy | 1.996 | 45.6 |
| 11 | SiO2 | 1.468 | 28.3 |
| 12 | SiOxNy | 1.996 | 35.7 |
| 13 | SiO2 | 1.468 | 49.1 |
| 14 | SiOxNy | 1.996 | 21.8 |
| 15 | SiO2 | 1.468 | 60.2 |
| 16 | SiOxNy | 1.996 | 11.6 |
| 17 | SiO2 | 1.468 | 25.5 |
| Substrate | GC1 | 1.560 | |
| | Air | 1 | |

| | |
|---|---|
| Total Coating Thickness | 1530.1 |

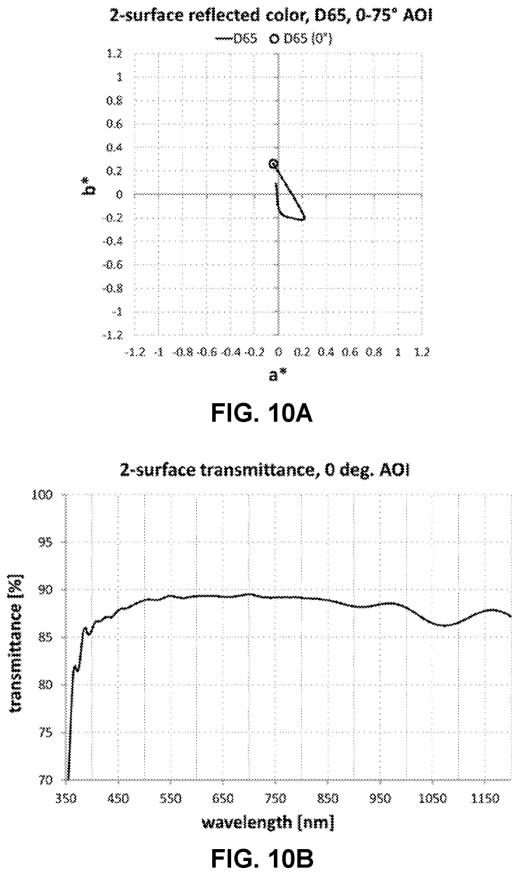

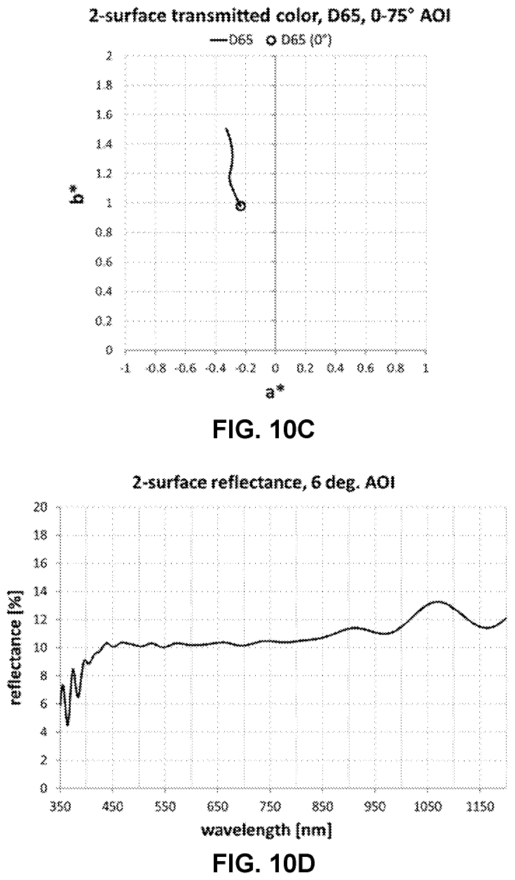

Example 4: According to this example, the GC1 substrate was coated with an anti-reflective, multilayer coating, according to the table below. This coating includes medium-index SiOₓN_{y} layers in the anti-reflective stack (e.g. layers 2, 4, and 6) to improve the near-surface hardness of the coated article. The thick scratch resistant layers (e.g. layers 5 and 8) impart high hardness to the article. The design allows layer 8 to have its thickness adjusted within a range of e.g., 200 nm to 5000 nm without significantly altering the optics of the coated article. The coated article had a modeled first-surface photopic average reflectance (Y) of 6.0% at near-normal angles of incidence (AOI=0-10 degrees). As shown in FIG. 10A, the coated article had a modeled two-surface reflected color that was well controlled and near neutral, staying between −0.1<a*<0.25 and −0.25<b*<0.25 over the entire AOI range from 0-75 degrees. The two-surface transmittance modeled at an angle of incidence of 0-degrees is provided in FIG. 10B, the two-surface transmitted color modeled at all angles of incidence from 0 to 75-degrees is provided in FIG. 10C, and the two-surface reflectance modeled at 6-degrees angle of incidence is provided in FIG. 10D.

| | | | Physical |
|---|---|---|---|
| | | Refractive Index | Thickness |
| Layer | Material | @550 nm | (nm) |
| | Air | 1 | |
| 1 | SiO2 | 1.467 | 14.0 |
| 2 | SiOxNy | 1.589 | 42.1 |
| 3 | SiNx | 2.058 | 48.5 |
| 4 | SiOxNy | 1.589 | 10.1 |
| 5 | SiNx | 2.058 | 99.2 |
| 6 | SiOxNy | 1.589 | 8.1 |
| 7 | SiNx | 2.058 | 30.0 |
| 8 | SiOxNy | 1.949 | 1000.0 |
| 9 | SiO2 | 1.468 | 9.4 |
| 10 | SiOxNy | 1.996 | 45.6 |
| 11 | SiO2 | 1.468 | 28.3 |
| 12 | SiOxNy | 1.996 | 35.7 |
| 13 | SiO2 | 1.468 | 49.1 |
| 14 | SiOxNy | 1.996 | 21.8 |
| 15 | SiO2 | 1.468 | 60.2 |
| 16 | SiOxNy | 1.996 | 11.6 |
| 17 | SiO2 | 1.468 | 25.5 |
| Substrate | GC1 | 1.560 | |
| | Air | 1 | |

| | |
|---|---|
| Total Coating Thickness | 1739.2 |

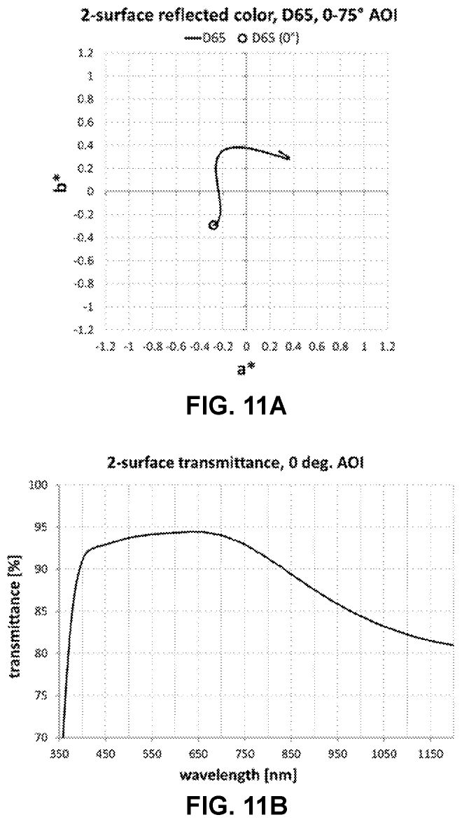

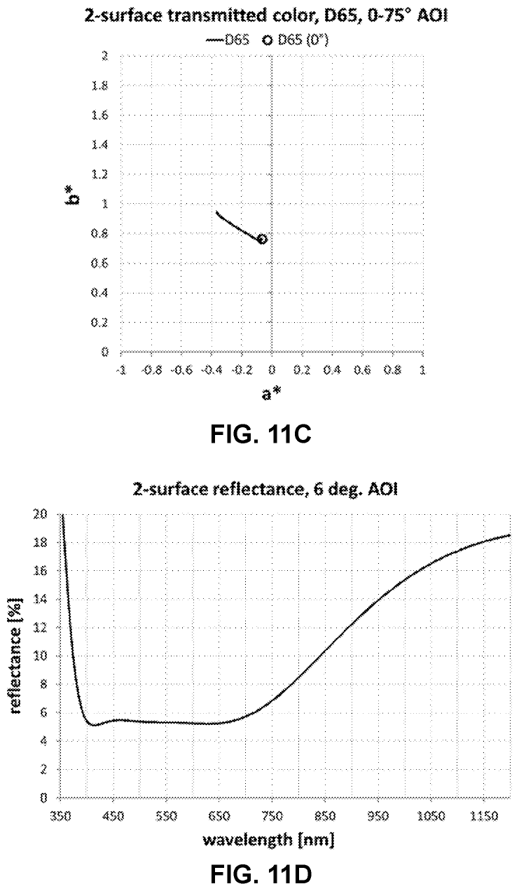

Example 5: According to this example, the GC1 substrate was coated with an anti-reflective, multilayer coating, according to the table below. The coated article had a modeled first-surface photopic average reflectance (Y) of 0.56% at near-normal angles of incidence (AOI=0-10 degrees). As shown in FIG. 11A, the coated article had a modeled two-surface reflected color that was well controlled and near neutral, staying between −0.4<a*<0.4 and −0.4<b*<0.4 over the entire AOI range from 0-75 degrees. The two-surface transmittance modeled at an angle of incidence of 0-degrees is provided in FIG. 11B, the two-surface transmitted color modeled at all angles of incidence from 0 to 75-degrees is provided in FIG. 11C, and the two-surface reflectance modeled at 6-degrees angle of incidence is provided in FIG. 11D.

| | | | Physical |
|---|---|---|---|
| | | Refractive Index | Thickness |
| Layer | Material | @550 nm | nm |
| | Air | 1 | |
| 1 | SiO2 | 1.476 | 84.2 |
| 2 | SiNx | 2.040 | 76.1 |
| 3 | SiO2 | 1.476 | 13.7 |
| 4 | SiNx | 2.040 | 37.2 |
| 5 | SiO2 | 1.476 | 67.9 |
| 6 | SiNx | 2.040 | 8.2 |
| 7 | SiO2 | 1.476 | 74.3 |
| Substrate | GC1 | 1.560 | |
| | Air | 1 | |

| | |
|---|---|
| Total Coating Thickness | 361.5 |

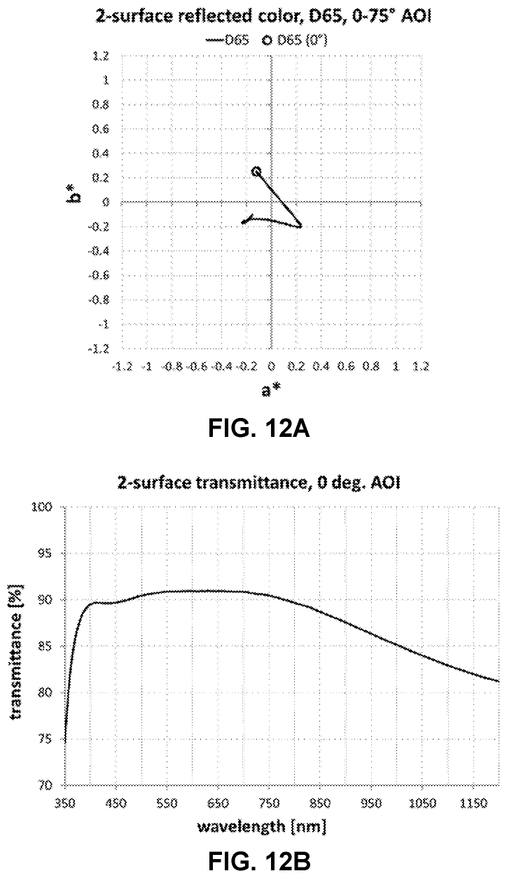

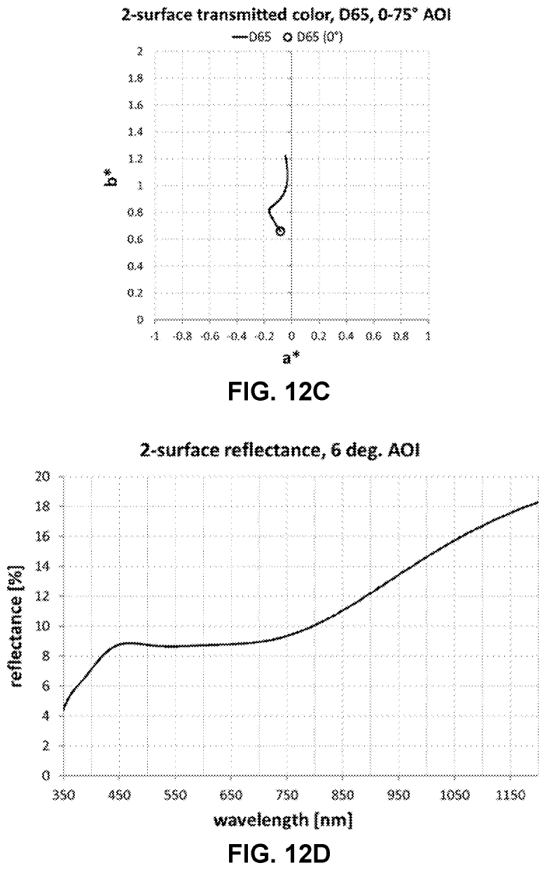

Example 6: According to this example, the GC1 substrate was coated with an anti-reflective, multilayer coating, according to the table below. The thick scratch resistant layer (e.g. layer 2) and reduced thickness of low-index material above the scratch resistance layer (e.g. layer 1 is less than 60 nm thick) both serve to impart high near-surface hardness to the article. The coated article had a modeled first-surface photopic average reflectance (Y) of 4.2% at near-normal angles of incidence (AOI=0-10 degrees). As shown in FIG. 12A, the coated article had a modeled two-surface reflected color that was well controlled and near neutral, staying between −0.25<a*<0.25 and −0.25<b*<0.25 over the entire AOI range from 0-75 degrees. The two-surface transmittance modeled at an angle of incidence of 0-degrees is provided in FIG. 12B, the two-surface transmitted color modeled at all angles of incidence from 0 to 75-degrees is provided in FIG. 12C, and the two-surface reflectance modeled at 6-degrees angle of incidence is provided in FIG. 12D.

| | | | Physical |
|---|---|---|---|
| | | Refractive Index | Thickness |
| Layer | Material | @550 nm | (nm) |
| | Air | 1 | |
| 1 | SiO2 | 1.476 | 53.8 |
| 2 | SiNx | 2.040 | 137.2 |
| 3 | SiO2 | 1.476 | 18.9 |
| 4 | SiNx | 2.040 | 22.7 |
| 5 | SiO2 | 1.476 | 40.9 |
| 6 | SiNx | 2.040 | 12.4 |
| 7 | SiO2 | 1.476 | 21.0 |
| Substrate | GC1 | 1.560 | |
| | Air | 1 | |

| | |
|---|---|
| Total Coating Thickness | 307.0 |

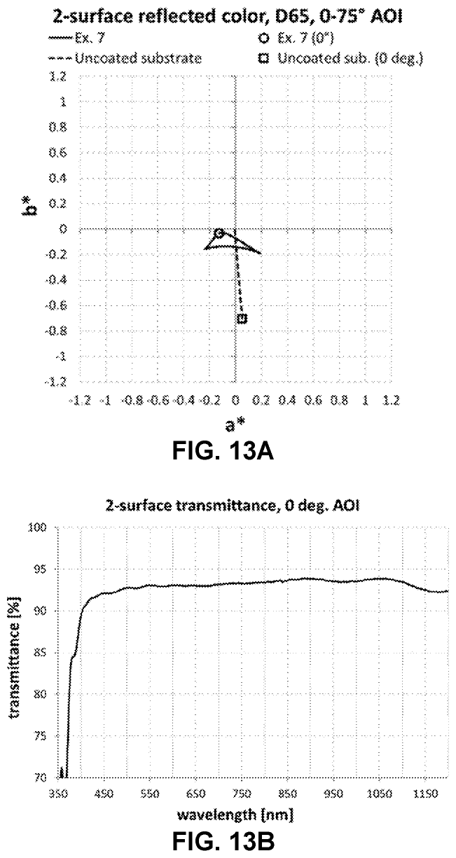

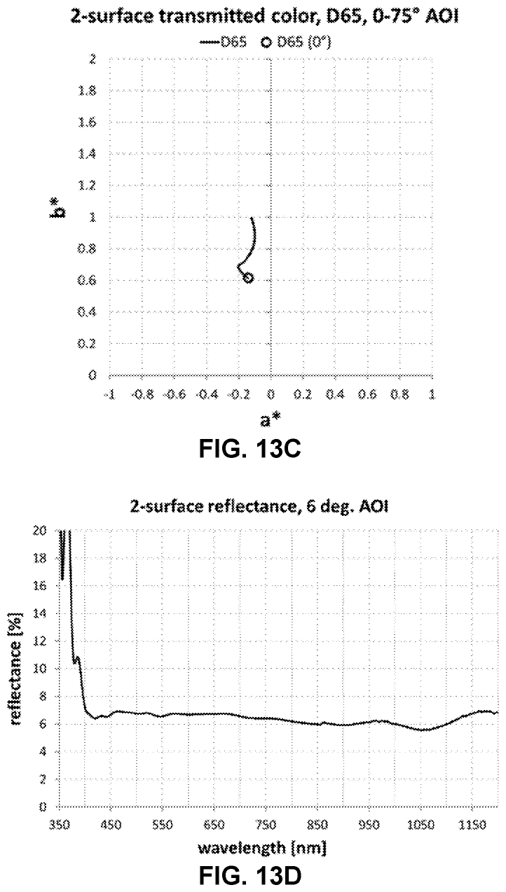

Comparative Example 7: According to this comparative example, the GC2 substrate in an uncoated state had its optical properties modeled based on measurements of reflectance, transmittance, and spectroscopic ellipsometry. The modeled first-surface photopic average reflectance (Y) of the uncoated glass-ceramic substrate was 4.6 at near-normal angles of incidence (AOI=0-10 degrees). As shown in FIG. 13A, the modeled two-surface reflected color of the uncoated substrate of Comparative Example 7 showed an undesirable scattering induced color, with b* being as low as −0.7 at near-normal incidence.

Example 7: According to this example, the GC2 substrate was coated with an anti-reflective, multilayer coating, according to the table below. This coating makes use of medium-index SiOₓN_{y} layers in the anti-reflective stack (e.g., layers 3, 5, and 7) to improve the near-surface hardness of the coated article. The thick scratch resistant layers (e.g., layer 8) impart high hardness to the article. The design allows layer 8 to have its thickness adjusted within a range of e.g., 200 nm to 5000 nm, without significantly altering the optics of the coated article. This coating has a 1st-surface photopic average reflectance (Y) of 2.3% at near-normal angles of incidence (AOI=0-10 degrees). As shown in FIG. 13A, the 2-surface reflected color is well controlled and near neutral, staying between −0.25<a*<0.25 and −0.25<b*<0 over the entire AOI range from 0-75 degrees. The two-surface transmittance modeled at an angle of incidence of 0-degrees is provided in FIG. 13B, the two-surface transmitted color modeled at all angles of incidence from 0 to 75-degrees is provided in FIG. 13C, and the two-surface reflectance modeled at 6-degrees angle of incidence is provided in FIG. 13D.

| | | | Physical |
|---|---|---|---|
| | | Refractive Index | Thickness |
| Layer | Material | @550 nm | (nm) |
| | Air | 1 | |
| 1 | SiO2 | 1.467 | 133.5 |
| 2 | SiNx | 2.058 | 18.9 |
| 3 | SiOxNy | 1.589 | 55.0 |
| 4 | SiNx | 2.058 | 42.1 |
| 5 | SiOxNy | 1.589 | 26.6 |
| 6 | SiNx | 2.058 | 45.6 |
| 7 | SiOxNy | 1.589 | 9.9 |
| 8 | SiOxNy | 1.949 | 1000.0 |
| 9 | SiO2 | 1.468 | 9.2 |
| 10 | SiOxNy | 1.996 | 46.0 |
| 11 | SiO2 | 1.468 | 28.0 |
| 12 | SiOxNy | 1.996 | 36.1 |
| 13 | SiO2 | 1.468 | 49.5 |
| 14 | SiOxNy | 1.996 | 21.8 |
| 15 | SiO2 | 1.468 | 62.2 |
| 16 | SiOxNy | 1.996 | 10.9 |
| 17 | SiO2 | 1.468 | 25.8 |
| Substrate | GC2 | 1.546 | 0.6 mm |
| | Air | 1 | |

| | |
|---|---|
| Total Coating Thickness | 1620.9 |

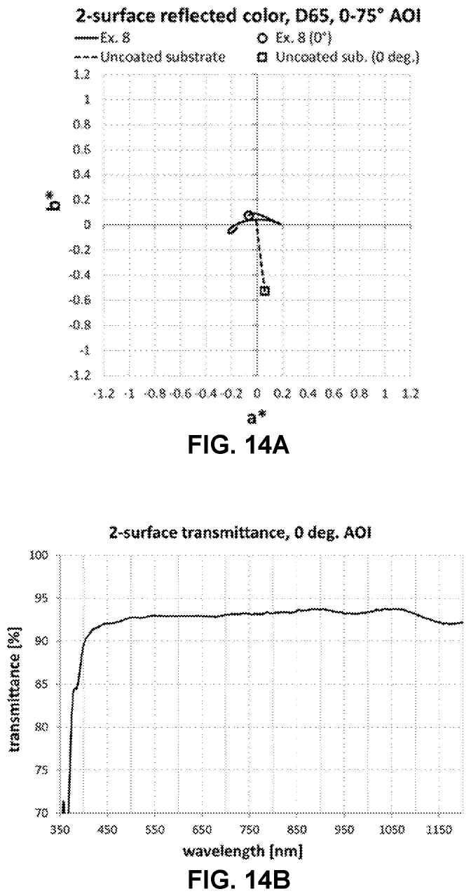

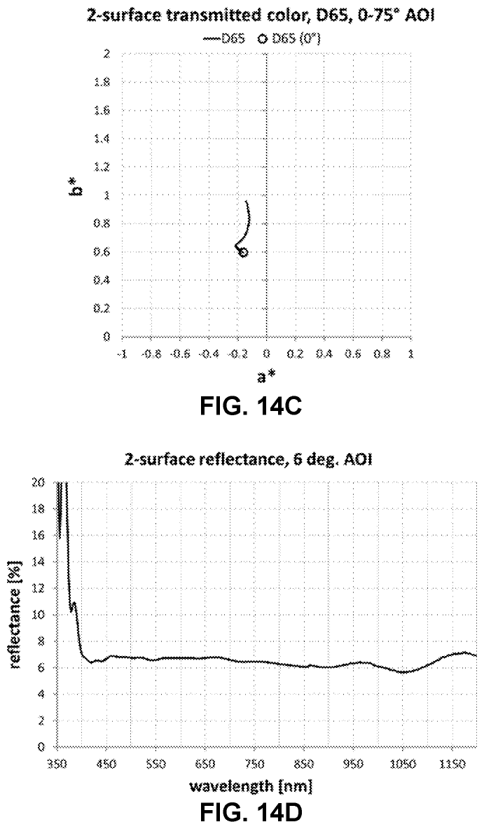

Comparative Example 8: According to this comparative example, the GC3 substrate in an uncoated state had its optical properties modeled based on measurements of reflectance, transmittance, and spectroscopic ellipsometry. The modeled first-surface photopic average reflectance (Y) of the uncoated glass-ceramic substrate was 4.7 at near-normal angles of incidence (AOI=0-10 degrees). As shown in FIG. 14A, the modeled two-surface reflected color of the uncoated substrate of Comparative Example 8 showed an undesirable scattering induced color, with b* being lower than −0.5 at near-normal incidence.

Example 8: According to this example, the GC3 substrate was coated with an anti-reflective, multilayer coating, according to the table below. This coating makes use of medium-index SiOₓN_{y} layers in the anti-reflective stack (e.g., layers 3, 5, and 7) to improve the near-surface hardness of the coated article. The thick scratch resistant layers (e.g., layer 8) impart high hardness to the article. The design allows layer 8 to have its thickness adjusted within a range of e.g., 200 nm to 5000 nm, without significantly altering the optics of the coated article. This coating has a 1st-surface photopic average reflectance (Y) of 2.3% at near-normal angles of incidence (AOI=0-10 degrees). As shown in FIG. 14A, the 2-surface reflected color is well controlled and near neutral, staying between −0.25<a*<0.25 and −0.1<b*<0.1 over the entire AOI range from 0-75 degrees. The two-surface transmittance modeled at an angle of incidence of 0-degrees is provided in FIG. 14B, the two-surface transmitted color modeled at all angles of incidence from 0 to 75-degrees is provided in FIG. 14C, and the two-surface reflectance modeled at 6-degrees angle of incidence is provided in FIG. 14D.

| | | | Physical |
|---|---|---|---|
| | | Refractive Index | Thickness |
| Layer | Material | @550 nm | (nm) |
| | Air | 1 | |
| 1 | SiO2 | 1.467 | 132.5 |
| 2 | SiNx | 2.058 | 19.1 |
| 3 | SiOxNy | 1.589 | 55.0 |
| 4 | SiNx | 2.058 | 41.8 |
| 5 | SiOxNy | 1.589 | 26.6 |
| 6 | SiNx | 2.058 | 45.1 |
| 7 | SiOxNy | 1.589 | 9.7 |
| 8 | SiOxNy | 1.949 | 1000.0 |
| 9 | SiO2 | 1.468 | 9.1 |
| 10 | SiOxNy | 1.996 | 45.7 |
| 11 | SiO2 | 1.468 | 28.3 |
| 12 | SiOxNy | 1.996 | 35.8 |
| 13 | SiO2 | 1.468 | 50.2 |
| 14 | SiOxNy | 1.996 | 21.8 |
| 15 | SiO2 | 1.468 | 63.1 |
| 16 | SiOxNy | 1.996 | 11.2 |
| 17 | SiO2 | 1.468 | 27.0 |
| Substrate | GC3 | 1.551 | 0.6 mm |
| | Air | 1 | |

| | |
|---|---|
| Total Coating Thickness | 1621.8 |

In a first aspect of the present disclosure, an article comprising a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and a multilayer coating disposed on the first major surface; wherein the glass-ceramic substrate in an uncoated state exhibits a b*_{uncoated} value of less than or equal to about −0.35 in two-surface reflectance in the CIE L*,a*,b* colorimetry system under a D65 illuminant measured at normal incidence, from 0 to 10 degrees; and wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value.

A second aspect of the present disclosure may include the first aspect, wherein the b*_{coated} value is greater than or equal to about −0.8.

A third aspect of the present disclosure may include the first or second aspect, wherein the article exhibits an a*_{coated} value in two-surface reflectance in the CIE L*,a*,b* colorimetry system under a D65 illuminant as measured at normal incidence, from 0 to 10 degrees, and wherein √((a*_{coated})²+(b*_{coated})²) is about 1 or less.

A fourth aspect of the present disclosure may include any of the first through third aspects, wherein the article exhibits an a*_{coated} value in two-surface reflectance in the CIE L*,a*,b* colorimetry system under a D65 illuminant as measured at normal incidence, from 0 to 10 degrees, and wherein −1<a*_{coated}<1 and −1<b*_{coated}<1.

A fifth aspect of the present disclosure may include any of the first through fourth aspects, wherein the multilayer coating comprises an optical film structure comprising a physical thickness from about 50 nm to less than about 800 nm and a plurality of alternating high refractive index and low refractive index layers.

A sixth aspect of the present disclosure may include the fifth aspect, wherein the optical film structure comprises a first low refractive index layer directly on the first major surface and a capping low refractive index layer, wherein each layer comprises one or more of a silicon-containing oxide, a silicon-containing nitride, and a silicon-containing oxynitride, and wherein a refractive index of the low refractive index layers is less than or equal to about 1.7, and wherein the high index layer comprises a refractive index that is greater than or equal to 1.8.

A seventh aspect of the present disclosure may include any of the fifth through sixth aspects, wherein the article exhibits a hardness of 8 GPa or greater measured at an indentation depth of 100 nm or a maximum hardness of 9 GPa or greater measured over an indentation depth range from 100 nm to 500 nm, the hardness and the maximum hardness measured by a Berkovich Indenter Hardness Test.

An eighth aspect of the present disclosure may include any of the fifth through seventh aspects, wherein the optical thickness of the high refractive index layer adjacent to the capping low refractive index layer is from 45 nm to 450 nm, and the physical thickness of the capping low refractive index layer is less than about 80 nm.

A ninth aspect of the present disclosure may include any of the fifth through eighth aspects, wherein a combined physical thickness of the high refractive index layers is 30% or greater than the physical thickness of the optical film structure.

A tenth aspect of the present disclosure may include any of the first through fourth aspects, wherein the multilayer coating comprises an optical film structure having an outer surface and a physical thickness of from about 200 nm to 5000 nm, the optical film structure disposed on the first major surface.

An eleventh aspect of the present disclosure may include the tenth aspect, wherein the optical film structure comprises a scratch-resistant layer, at least one low refractive index (RI) layer, at least one medium RI layer, and at least one high RI layer, wherein the optical film structure further comprises an outer structure and an inner structure, the scratch-resistant layer disposed between the outer and inner structures, the inner structure disposed on the first major surface, the outer structure comprising a plurality of alternating high and medium RI layers, and the inner structure comprises a plurality of alternating high RI layers and low RI layers, further wherein the at least one medium RI layer comprises a refractive index from 1.55 to 1.80, each of the high RI layers comprises a refractive index of greater than 1.80, and each of the low RI layers comprises a refractive index of less than 1.55.

A twelfth aspect of the present disclosure may include the eleventh aspect, wherein one or both of: (i) the outer structure comprises at least one medium RI layer in contact with one or both of: (a) the scratch-resistant layer and (b) one of the high RI layers; and (ii) a sum of the physical thicknesses of all of the low RI layers in the outer structure is less than about 200 nm.

A thirteenth aspect of the present disclosure may include any of the eleventh through twelfth aspects, wherein the high RI layers and the low RI layers of the plurality of alternating high and low RI layers of the inner structure are SiOₓN_{y} and SiO₂, respectively, wherein the high RI layers and medium RI layers of the plurality of alternating high RI and medium RI layers of the outer structure are SiNₓ and SiOₓN_{y}, respectively, and wherein the scratch-resistant layer is SiOₓN_{y}.

A fourteenth aspect of the present disclosure may include any of the eleventh through thirteenth aspects, wherein the physical thickness of the optical film structure is from 1250 nm to 1750 nm, the physical thickness of the scratch-resistant layer is from 500 nm to 1000 nm, and optical film structure has a total of 15 to 23 layers.

A fifteenth aspect of the present disclosure may include the tenth aspect, wherein the optical film structure comprises a scratch-resistant layer, and a plurality of alternating low refractive index (RI) layers, and high RI layers, and each of the high RI layers comprises a refractive index of greater than 1.80, and each of the low RI layers comprises a refractive index from 1.35 to 1.7.

A sixteenth aspect of the present disclosure may include the tenth aspect, wherein the optical film structure comprises a scratch-resistant layer and one of (a) a plurality of alternating high refractive (RI) and low RI layers; (b) a refractive index gradient; and (c) a compositional gradient.

A seventeenth aspect of the present disclosure may include the sixteenth aspect, wherein the one of (a) the plurality of alternating high refractive (RI) and low RI layers; (b) the refractive index gradient; and (c) the compositional gradient are disposed on the first major surface and the scratch-resistant layer is disposed on the one of (a) the plurality of alternating high refractive (RI) and low RI layers; (b) the refractive index gradient; and (c) the compositional gradient.

An eighteenth aspect of the present disclosure may include the tenth aspect, wherein the optical film structure further comprises an outer structure, an inner structure, and a scratch-resistant layer disposed between the outer and inner structures, wherein the inner structure comprises one of (a) a plurality of alternating high refractive (RI) and low RI layers; (b) a refractive index gradient; and (c) a compositional gradient.

A nineteenth aspect of the present disclosure may include any of the first through eighteenth aspects, wherein the glass-ceramic substrate comprises the following composition: 55-75 mol % SiO₂; 0.2-10 mol % Al₂O₃; 0.2-3 mol % P₂O₅; 0-5 mol % B₂O₃; 15-30 mol % Li₂O; 0-2 mol % Na₂O; 0-2 mol % K₂O; 0-2 mol % MgO; 0-2 mol % ZnO; 0.1-10 mol % ZrO₂; 0-4 mol % TiO₂; 0.01-1.0 mol % SnO₂; and 0-2 mol % Y₂O₃.

An twentieth aspect of the present disclosure may include any of the first through eighteenth aspects, wherein the glass-ceramic substrate consists essentially of the following composition: 68-72 mol % SiO₂; 3-5 mol % Al₂O₃; 0.6-1.2 mol % P₂O₅; 17-25 mol % Li₂O; 0.01-1.7 mol % Na₂O; 0-5 mol % B₂O₃; 0.01-0.5 mol % K₂O; 1.5-3 mol % ZrO₂; 0.01-0.1 mol % SnO₂; 0.01-0.1 mol % HfO₂; and 0.01-0.5 mol % Fe₂O₃.

A twenty-first aspect of the present disclosure may include the twentieth aspect, wherein the glass-ceramic substrate further comprises the following phase assemblage: 10-21 wt. % glass; 40-50 wt. % lithium disilicate (Li₂Si₂O₅); 35-45 wt. % petalite (LiAlSi₄O₁₀); and <2 wt. % of other phases.

A twenty-second aspect of the present disclosure may include any of the first through eighteenth aspects, wherein the glass-ceramic substrate comprises: greater than or equal to 55 wt % and less than or equal to 80 wt % SiO₂; greater than or equal to 7 wt % and less than or equal to 20 wt % Li₂O; greater than or equal to 1 wt % and less than or equal to 8 wt % P₂O₅; greater than or equal to 0.1 wt % and less than or equal to 5.0 wt % Na₂O; greater than 0.5 wt % to less than or equal to 20 wt % ZrO₂; greater than or equal to 1 wt % to less than 4 wt % CaO; and less than 1 wt % K₂O, wherein: a ratio of Al₂O₃ (wt %) to Li₂O (wt %) in the glass-ceramic is greater than or equal to 0 and less than 0.20.

A twenty-third aspect of the present disclosure may include any of the first through twenty-first aspects, further comprising any one or more of a surface modifying layer, planarization layer, an easy-to-clean coating, a diamond-like coating, and a scratch resistant coating, disposed on the optical film structure.

A twenty-fourth aspect of the present disclosure may include any of the first through twenty-third aspects, wherein: the multilayer coating exhibits a residual compressive stress of greater than or equal to about 600 MPa or greater, and an elastic modulus greater than or equal to about 120 GPa; and the glass-ceramic substrate comprises an elastic modulus of greater than 85 GPa and a fracture toughness of greater than 0.8 MPa·√m.

A twenty-fifth aspect of the present disclosure may include any of the first through twenty-fourth aspects, wherein the article exhibits a maximum hardness of about 10 GPa or greater measured over an indentation depth range from about 0 nm to about 1,000 nm, measured by a Berkovich Indenter Hardness Test.

A twenty-sixth aspect of the present disclosure may include any of the first through twenty-fifth aspects, wherein the article has one or both of an average flexural strength of about 600 MPa or greater, and an average strain-to-failure of greater than about 0.5%.

A twenty-seventh aspect of the present disclosure may include any of the first through twenty-sixth aspects, wherein the glass-ceramic substrate has an average transmittance of greater than about 90% over an optical wavelength regime from 450 nm to 800 nm at normal incidence, from 0 to 10 degrees.

A twenty-eighth aspect of the present disclosure may include any of the first through twenty-seventh aspects, wherein the glass-ceramic substrate exhibits a first-surface photopic average reflectance of less than about 12%, over a normal angle of incidence range from 0 to 10 degrees.

In a twenty-ninth aspect of the present disclosure, an article comprising a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and a multilayer coating disposed on the first major surface; wherein the glass-ceramic substrate in an uncoated state exhibits a b*_{uncoated} value of less than or equal to about −1 in two-surface reflectance in the CIE L*,a*,b* colorimetry system under a D65 illuminant measured at normal incidence, from 0 to 10 degrees; and wherein the article exhibits a b*_{coated} value of greater than or equal to about −0.8 in two-surface reflectance in the CIE L*,a*,b* colorimetry system under a D65 illuminant as measured at normal incidence, from 0 to 10 degrees.

In a thirtieth aspect of the disclosure, an article comprising a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and a multilayer coating disposed on the first major surface; wherein the glass-ceramic substrate in an uncoated state exhibits a b*_{uncoated} value of less than or equal to about −0.5 in two-surface reflectance in the CIE L*,a*,b* colorimetry system under a D65 illuminant measured at normal incidence, from 0 to 10 degrees; wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value; wherein the glass-ceramic substrate comprises: greater than or equal to 55 wt % and less than or equal to 80 wt % SiO₂; greater than or equal to 7 wt % and less than or equal to 20 wt % Li₂O; greater than or equal to 1 wt % and less than or equal to 8 wt % P₂O₅; greater than or equal to 0.1 wt % and less than or equal to 5.0 wt % Na₂O; greater than 0.5 wt % to less than or equal to 20 wt % ZrO₂; greater than or equal to 1 wt % to less than 4 wt % CaO; and less than 1 wt % K₂O, wherein: a ratio of Al₂O₃ (wt %) to Li₂O (wt %) in the glass-ceramic is greater than or equal to 0 and less than 0.20; and the multilayer coating comprises an optical film structure comprising a physical thickness from about 50 nm to less than 800 nm, and a plurality of alternating high refractive index and low refractive index layers wherein the optical film structure comprises a first low refractive index layer directly on the first major surface and a capping low refractive index layer, wherein each layer comprises one or more of a silicon-containing oxide, a silicon-containing nitride, and a silicon-containing oxynitride.

In a thirty-first aspect of the disclosure, an article comprising a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and a multilayer coating disposed on the first major surface; wherein the glass-ceramic substrate in an uncoated state exhibits a b*_{uncoated} value of less than or equal to about −0.35 in two-surface reflectance in the CIE L*,a*,b* colorimetry system under a D65 illuminant measured at normal incidence, from 0 to 10 degrees; wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value; wherein the glass-ceramic substrate comprises: greater than or equal to 55 wt % and less than or equal to 80 wt % SiO₂; greater than or equal to 7 wt % and less than or equal to 20 wt % Li₂O; greater than or equal to 1 wt % and less than or equal to 8 wt % P₂O₅; greater than or equal to 0.1 wt % and less than or equal to 5.0 wt % Na₂O; greater than 0.5 wt % to less than or equal to 20 wt % ZrO₂; greater than or equal to 1 wt % to less than 4 wt % CaO; and less than 1 wt % K₂O, wherein: a ratio of Al₂O₃ (wt %) to Li₂O (wt %) in the glass-ceramic is greater than or equal to 0 and less than 0.20; and wherein the multilayer coating comprises an optical film structure having an outer surface and a physical thickness of from about 200 nm to 5000 nm, the optical film structure disposed on the first major surface, wherein the optical film structure comprises a scratch-resistant layer, at least one low refractive index (RI) layer, at least one medium RI layer, and at least one high RI layer, wherein the optical film structure further comprises an outer structure and an inner structure, the scratch-resistant layer disposed between the outer and inner structures, the inner structure disposed on the first major surface, the outer structure comprising a plurality of alternating high and medium RI layers, and the inner structure comprises a plurality of alternating high RI layers and low RI layers, further wherein the at least one medium RI layer comprises a refractive index from 1.55 to 1.80, each of the high RI layers comprises a refractive index of greater than 1.80, and each of the low RI layers comprises a refractive index of less than 1.55.

In a thirty-second aspect of the present disclosure, a consumer electronic product, comprising a housing comprising a front surface, a back surface and side surfaces; electrical components at least partially within the housing, the electrical components comprising a controller, a memory, and a display, the display at or adjacent the front surface of the housing; and a cover substrate disposed over the display, wherein at least one of a portion of the housing or the cover substrate comprises the article of any one of the preceding aspects one to thirty-first.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An article comprising:
a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and
a multilayer coating disposed on the first major surface;
wherein the glass-ceramic substrate in an uncoated state exhibits a b*_{uncoated} value of less than or equal to about −0.35 in two-surface reflectance in the CIE L*,a*,b* colorimetry system under a D65 illuminant measured at normal incidence, from 0 to 10 degrees; and
wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value.

2. The article of claim 1, wherein the b*_{coated} value is greater than or equal to about −0.8.

3. The article of claim 1, wherein the article exhibits an a*_{coated} value in two-surface reflectance in the CIE L*,a*,b* colorimetry system under a D65 illuminant as measured at normal incidence, from 0 to 10 degrees, and wherein √((a*_{coated})²+(b*_{coated})²) is about 1 or less.

4. The article of claim 1, wherein the article exhibits an a*_{coated} value in two-surface reflectance in the CIE L*,a*,b* colorimetry system under a D65 illuminant as measured at normal incidence, from 0 to 10 degrees, and wherein −1<a*_{coated}<1 and −1<b*_{coated}<1.

5. The article of claim 1, wherein:
the multilayer coating comprises an optical film structure comprising a physical thickness from about 50 nm to less than about 800 nm and a plurality of alternating high refractive index and low refractive index layers;
the optical film structure comprises a first low refractive index layer directly on the first major surface and a capping low refractive index layer, wherein each layer comprises one or more of a silicon-containing oxide, a silicon-containing nitride, and a silicon-containing oxynitride, and wherein a refractive index of the low refractive index layers is less than or equal to about 1.7, and wherein the high index layer comprises a refractive index that is greater than or equal to 1.8; and,
the article exhibits a hardness of 8 GPa or greater measured at an indentation depth of 100 nm or a maximum hardness of 9 GPa or greater measured over an indentation depth range from 100 nm to 500 nm, the hardness and the maximum hardness measured by a Berkovich Indenter Hardness Test.

6. The article of claim 5, wherein the optical thickness of the high refractive index layer adjacent to the capping low refractive index layer is from 45 nm to 450 nm, and the physical thickness of the capping low refractive index layer is less than about 80 nm.

7. The article of claim 5, wherein a combined physical thickness of the high refractive index layers is 30% or greater than the physical thickness of the optical film structure.

8. The article of claim 1, wherein:
the multilayer coating comprises an optical film structure having an outer surface and a physical thickness of from about 200 nm to 5000 nm, the optical film structure disposed on the first major surface;
wherein the optical film structure comprises a scratch-resistant layer, at least one low refractive index (RI) layer, at least one medium RI layer, and at least one high RI layer,
wherein the optical film structure further comprises an outer structure and an inner structure, the scratch-resistant layer disposed between the outer and inner structures, the inner structure disposed on the first major surface, the outer structure comprising a plurality of alternating high and medium RI layers, and the inner structure comprises a plurality of alternating high RI layers and low RI layers,
further wherein the at least one medium RI layer comprises a refractive index from 1.55 to 1.80, each of the high RI layers comprises a refractive index of greater than 1.80, and each of the low RI layers comprises a refractive index of less than 1.55.

9. The article of claim 8, wherein one or both of:
(i) the outer structure comprises at least one medium RI layer in contact with one or both of: (a) the scratch-resistant layer and (b) one of the high RI layers; and
(ii) a sum of the physical thicknesses of all of the low RI layers in the outer structure is less than about 200 nm.

10. The article of claim 8, wherein the high RI layers and the low RI layers of the plurality of alternating high and low RI layers of the inner structure are SiOₓN_{y} and SiO₂, respectively, wherein the high RI layers and medium RI layers of the plurality of alternating high RI and medium RI layers of the outer structure are SiNₓ and SiOₓN_{y}, respectively, and wherein the scratch-resistant layer is SiOₓN_{y}.

11. The article of claim 8, wherein the physical thickness of the optical film structure is from 1250 nm to 1750 nm, the physical thickness of the scratch-resistant layer is from 500 nm to 1000 nm, and optical film structure has a total of 15 to 23 layers.

12. The article of claim 1, wherein:
the multilayer coating comprises an optical film structure having an outer surface and a physical thickness of from about 200 nm to 5000 nm, the optical film structure disposed on the first major surface;
wherein the optical film structure comprises a scratch-resistant layer, and a plurality of alternating low refractive index (RI) layers, and high RI layers, and
each of the high RI layers comprises a refractive index of greater than 1.80, and each of the low RI layers comprises a refractive index from 1.35 to 1.7.

13. The article of claim 1, wherein:
the multilayer coating comprises an optical film structure having an outer surface and a physical thickness of from about 200 nm to 5000 nm, the optical film structure disposed on the first major surface;
the optical film structure comprises a scratch-resistant layer and one of (a) a plurality of alternating high refractive (RI) and low RI layers; (b) a refractive index gradient; and (c) a compositional gradient.

14. The article of claim 1, wherein:
the multilayer coating comprises an optical film structure having an outer surface and a physical thickness of from about 200 nm to 5000 nm, the optical film structure disposed on the first major surface;
the optical film structure further comprises an outer structure, an inner structure, and a scratch-resistant layer disposed between the outer and inner structures,
wherein the inner structure comprises one of (a) a plurality of alternating high refractive (RI) and low RI layers; (b) a refractive index gradient; and (c) a compositional gradient.

15. The article of claim 1, wherein the glass-ceramic substrate comprises the following composition:
55-75 mol % SiO₂;
0.2-10 mol % Al₂O₃;
0.2-3 mol % P₂O₅;
0-5 mol % B₂O₃;
15-30 mol % Li₂O;
0-2 mol % Na₂O;
0-2 mol % K₂O;
0-2 mol % MgO;
0-2 mol % ZnO;
0.1-10 mol % ZrO₂;
0-4 mol % TiO₂;
0.01-1.0 mol % SnO₂; and
0-2 mol % Y₂O₃.

16. The article of claim 1, wherein the glass-ceramic substrate consists essentially of the following composition:
68-72 mol % SiO₂;
3-5 mol % Al₂O₃;
0.6-1.2 mol % P₂O₅;
17-25 mol % Li₂O;
0.01-1.7 mol % Na₂O;
0-5 mol % B₂O₃;
0.01-0.5 mol % K₂O;
1.5-3 mol % ZrO₂;
0.01-0.1 mol % SnO₂;
0.01-0.1 mol % HfO₂;
0.01-0.5 mol % Fe₂O₃; and
wherein the glass-ceramic substrate further comprises the following phase assemblage:
10-21 wt. % glass;
40-50 wt. % lithium disilicate (Li₂Si₂O₅);
35-45 wt. % petalite (LiAlSi₄O₁₀); and
<2 wt. % of other phases.

17. The article of claim 1, wherein the glass-ceramic substrate comprises:
greater than or equal to 55 wt % and less than or equal to 80 wt % SiO₂;
greater than or equal to 7 wt % and less than or equal to 20 wt % Li₂O;
greater than or equal to 1 wt % and less than or equal to 8 wt % P₂O₅;
greater than or equal to 0.1 wt % and less than or equal to 5.0 wt % Na₂O;
greater than 0.5 wt % to less than or equal to 20 wt % ZrO₂;
greater than or equal to 1 wt % to less than 4 wt % CaO; and
less than 1 wt % K₂O, wherein:
a ratio of Al₂O₃ (wt %) to Li₂O (wt %) in the glass-ceramic is greater than or equal to 0 and less than 0.20.

18. The article of claim 1, wherein:
the glass-ceramic substrate has an average transmittance of greater than about 90% over an optical wavelength regime from 450 nm to 800 nm at normal incidence, from 0 to 10 degrees; and
the glass-ceramic substrate exhibits a first-surface photopic average reflectance of less than about 12%, over a normal angle of incidence range from 0 to 10 degrees.

19. An article comprising:
a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and
a multilayer coating disposed on the first major surface;
wherein the glass-ceramic substrate in an uncoated state exhibits a b*_{uncoated} value of less than or equal to about −0.75 in two-surface reflectance in the CIE L*,a*,b* colorimetry system under a D65 illuminant measured at normal incidence, from 0 to 10 degrees; and
wherein the article exhibits a b*_{coated} value of greater than or equal to about −0.6 in two-surface reflectance in the CIE L*,a*,b* colorimetry system under a D65 illuminant as measured at normal incidence, from 0 to 10 degrees.

20. An article comprising:
a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and
a multilayer coating disposed on the first major surface;
wherein the glass-ceramic substrate in an uncoated state exhibits a b*_{uncoated} value of less than or equal to about −0.35 in two-surface reflectance in the CIE L*,a*,b* colorimetry system under a D65 illuminant measured at normal incidence, from 0 to 10 degrees;
wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value;
wherein the glass-ceramic substrate comprises:
greater than or equal to 55 wt % and less than or equal to 80 wt % SiO₂;
greater than or equal to 7 wt % and less than or equal to 20 wt % Li₂O;
greater than or equal to 1 wt % and less than or equal to 8 wt % P₂O₅;
greater than or equal to 0.1 wt % and less than or equal to 5.0 wt % Na₂O;
greater than 0.5 wt % to less than or equal to 20 wt % ZrO₂;
greater than or equal to 1 wt % to less than 4 wt % CaO; and
less than 1 wt % K₂O, wherein:
a ratio of Al₂O₃ (wt %) to Li₂O (wt %) in the glass-ceramic is greater than or equal to 0 and less than 0.20; and
the multilayer coating comprises an optical film structure comprising a physical thickness from about 50 nm to less than 800 nm, and a plurality of alternating high refractive index and low refractive index layers wherein the optical film structure comprises a first low refractive index layer directly on the first major surface and a capping low refractive index layer, wherein each layer comprises one or more of a silicon-containing oxide, a silicon-containing nitride, and a silicon-containing oxynitride.

21. An article comprising:
a glass-ceramic substrate comprising a first major surface and a second major surface opposite the first major surface, wherein the glass-ceramic substrate has an average transmittance of at least about 85% over an optical wavelength regime from 450 nm to 800 nm at normal incidence, from 0 to 10 degrees; and
a multilayer coating disposed on the first major surface;
wherein the glass-ceramic substrate in an uncoated state exhibits a b*_{uncoated} value of less than or equal to about −0.35 in two-surface reflectance in the CIE L*,a*,b* colorimetry system under a D65 illuminant measured at normal incidence, from 0 to 10 degrees;
wherein the article exhibits a b*_{coated} value in two-surface reflectance in the CIE L*,a*,b* colorimetry system under a D65 illuminant as measured at normal incidence, from 0 to 10 degrees, and the b*_{coated} value is greater than or equal to about 50% of the b*_{uncoated} value;
wherein the glass-ceramic substrate comprises:
greater than or equal to 55 wt % and less than or equal to 80 wt % SiO₂;
greater than or equal to 7 wt % and less than or equal to 20 wt % Li₂O;
greater than or equal to 1 wt % and less than or equal to 8 wt % P₂O₅;
greater than or equal to 0.1 wt % and less than or equal to 5.0 wt % Na₂O;
greater than 0.5 wt % to less than or equal to 20 wt % ZrO₂;
greater than or equal to 1 wt % to less than 4 wt % CaO; and
less than 1 wt % K₂O, wherein:
a ratio of Al₂O₃ (wt %) to Li₂O (wt %) in the glass-ceramic is greater than or equal to 0 and less than 0.20; and
wherein the multilayer coating comprises an optical film structure having an outer surface and a physical thickness of from about 200 nm to 5000 nm, the optical film structure disposed on the first major surface, wherein the optical film structure comprises a scratch-resistant layer, at least one low refractive index (RI) layer, at least one medium RI layer, and at least one high RI layer,
wherein the optical film structure further comprises an outer structure and an inner structure, the scratch-resistant layer disposed between the outer and inner structures, the inner structure disposed on the first major surface, the outer structure comprising a plurality of alternating high and medium RI layers, and the inner structure comprises a plurality of alternating high RI layers and low RI layers,
further wherein the at least one medium RI layer comprises a refractive index from 1.55 to 1.80, each of the high RI layers comprises a refractive index of greater than 1.80, and each of the low RI layers comprises a refractive index of less than 1.55.
